(19) United States
(12) Patent Application Publication
(10) Pub. No.: US 2006/0292465 A1
(43) Pub. Date: Dec. 28, 2006

(54) Curable resin composition, electrophotographic photoreceptor, process cartridge and image forming apparatus

(75) Inventors: Wataru Yamada, Kanagawa (JP); Katsumi Nukada, Kanagawa (JP); Masahiro Iwasaki, Kanagawa (JP); Kazuhiro Koseki, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/302,213

(22) Filed: Dec. 14, 2005

(30) Foreign Application Priority Data
Jun. 23, 2005 (JP) 2005-184008

(51) Int. Cl. G03G 5/147

(52) U.S. Cl. 430/56; 430/66; 430/58.2; 430/58.75; 430/58.65

(57) ABSTRACT

A curable resin composition for use as a constituent material of an electrophotographic photoreceptor, the curable resin composition comprising: a phenolic resin having an (MwH/MwL) value of approximately 1.90 or less in a molecular weight distribution measured by gel permeation chromatography, wherein MwH is a peak area for a weight average molecular weight of approximately 200 or more; and MwL is a peak area for a weight average molecular weight of less than approximately 200.

### BACKGROUND OF THE INVENTION

1. Field of the Invention

The present invention relates to a curable resin composition, an electrophotographic photoreceptor, a process cartridge, and an image forming apparatus.

2. Description of the Related Art

In recent years, so-called xerographic image forming apparatuses, which include a charging means, an exposing means, a developing means, and a transfer means, have speed and life which are getting more and more increased with the technical progress of each component and a system. Along with this, there is an increasing demand for high speed and high reliability of each subsystem. In particular, electrophotographic photoreceptors used for image writing (abbreviated as “photoreceptors” in some instances below) and cleaning members for cleaning the photoreceptors are seeing a higher demand for high speed and high reliability. The photoreceptor and the cleaning member undergo much stress due to reciprocal sliding movement. Therefore, the photoreceptor is prone to damage, abrasion, chipping, or the like, resulting in an image defect.

In order to extend the life of the electrophotographic photoreceptor, it is considerably important to increase the mechanical strength of a photosensitive layer included in the photoreceptor. Therefore, for example, Japanese Patent Unexamined Publication No. 2002-6527, Japanese Patent Unexamined Publication No. 2002-82466, Japanese Patent Unexamined Publication No. 2002-82469, Japanese Patent Unexamined Publication No. 2003-186215 and Japanese Patent Unexamined Publication No. 2003-186234 propose a method for enhancing the mechanical strength of the photosensitive layer by providing the electrophotographic photoreceptor with a protection layer employing a phenolic resin.

### SUMMARY OF THE INVENTION

However, a functional layer, such as a protection layer included in an electrophotographic photoreceptor, is typically a thin film having a thickness of several tens of micrometers or less, and the present inventors have found that in the case of forming such a thin-film layer using a phenolic resin, the film formation ability is insufficient, so that projections, pinholes, or the like are likely to occur on the surface of the functional layer. In the case where projections or the like occur on the surface of the functional layer, if the electrophotographic photoreceptor is used for image formation, an image defect is likely to occur. Conventionally, some studies have been conducted on physical properties, such as the mechanical strength of a functional layer containing a phenolic resin and the like, as described in the above-described Japanese Patent Unexamined Publication No. 2002-6527, Japanese Patent Unexamined Publication No. 2002-82466, Japanese Patent Unexamined Publication No. 2002-82469, Japanese Patent Unexamined Publication No. 2003-186215 and Japanese Patent Unexamined Publication No. 2003-186234. In fact, the film formation ability of a phenolic resin-containing functional layer in the photoreceptor has not been sufficiently studied, concerning practical use thereof.

The present invention has been made in view of the above-described problem of the related art, and the present invention provides a curable resin composition which can achieve a high level of mechanical strength and film formation ability when used so as to form a phenolic resin-containing functional layer constituting an electrophotographic photoreceptor, an electrophotographic photoreceptor using the same, a process cartridge, and an image forming apparatus.

The present invention provides a curable resin composition for use as a constituent material of an electrophotographic photoreceptor, the composition containing a phenolic resin having an (MwH/MwL) value of 1.90 or less in a molecular weight distribution measured by gel permeation chromatography, where MwH is a peak area for a weight average molecular weight of 200 or more, and MwL is a peak area for a weight average molecular weight of less than 200.

The curable resin composition contains a phenolic resin having an (MwH/MwL) value of 1.90 or less, and therefore, in the case of forming a functional layer for the electrophotographic photoreceptor, it is possible to achieve both high-level film formation ability and high-level mechanical strength. Although the reason why satisfactory film formation ability is achieved while using the phenolic resin is not completely clear, the present inventors give the following conjecture. Specifically, the present inventors consider that when a phenolic resin having a high weight average molecular weight is locally insolubilized due to crosslinking, the phenolic resin becomes resistant to be leveled, so that a problem, such as a projection or the like, is likely to arise, whereas a phenolic resin having a molecular weight within the range of the present invention can be leveled.

Also, when a functional layer, such as a protection layer of an electrophotographic photoreceptor or the like, is formed using a conventional phenolic resin, the functional layer can have a high level of mechanical strength, but if image formation is repeatedly carried out using the photoreceptor, the functional layer is likely to peel off. Particularly when the functional layer is an outermost layer of the photoreceptor, the peel-off problem easily occurs due to, for example, sliding movement with a cleaning means, and the occurrence of the peel-off may cause an image defect.

On the other hand, in the case where the functional layer of the photoreceptor is formed using the curable resin composition of the present invention, even if the functional layer is an outermost layer, it is possible to sufficiently suppress the occurrence of the peel-off over a long period of time. Although the reason why the occurrence of the peel-off is suppressed is not completely clear, the present inventors gives a conjecture that because the formed functional layer has an excellent level of mechanical strength and film formation ability as described above and a phenolic resin having the (MwH/MwL) value within a specific range is used, an undercoating (underlayer) is partially fused or swollen, so that adhesion ability between the functional layer and the underlayer thereof becomes extremely satisfactory.

The present invention also provides an electrophotographic photoreceptor comprising a conductive support and a photosensitive layer provided on the conductive support, wherein the photosensitive layer has a functional layer composed of a cured substance of the curable resin composition of the present invention.

Since the functional layer of the electrophotographic photoreceptor is a layer composed of a cured substance obtained by curing the curable resin composition of the present invention, it is possible to simultaneously achieve superior mechanical strength and superior film formation ability. Thus, when used in an image forming apparatus, the electrophotographic photoreceptor of the present invention can form an image having satisfactory quality over a long period of time.

The present invention also provides a process cartridge comprising the electrophotographic photoreceptor of the present invention; and at least one selected from the group consisting of charging means for charging the electrophotographic photoreceptor, developing means for developing an electrostatic latent image, which is formed on the electrophotographic photoreceptor, with toner to form a toner image, and cleaning means for removing toner remaining on a surface of the electrographic photoreceptor.

Further, the present invention provides an image forming apparatus comprising the electrophotographic photoreceptor of the present invention, charging means for charging the electrophotographic photoreceptor, exposing means for forming an electrostatic latent image on the electrophotographic photoreceptor; developing means for developing the electrostatic latent image with toner to form a toner image, and transfer means for transferring the toner image from the electrophotographic photoreceptor onto a transfer medium.

Since the process cartridge and the image forming apparatus include the electrophotographic photoreceptor of the present invention, it is possible to form an image having satisfactory quality over a long period of time.

### BRIEF DESCRIPTION OF THE DRAWINGS

Preferred embodiments of the present invention will be described in detail based on the following figures, wherein:

FIG. 1 is a schematic cross-sectional view illustrating one of the preferred embodiments of an electrophotographic photoreceptor according to the present invention;

FIG. 2 is a schematic cross-sectional view illustrating another preferred embodiment of the electrophotographic photoreceptor according to the present invention;

FIG. 3 is a schematic cross-sectional view illustrating another preferred embodiment of the electrophotographic photoreceptor according to the present invention;

FIG. 4 is a schematic cross-sectional view illustrating another preferred embodiment of the electrophotographic photoreceptor according to the present invention;

FIG. 5 is a schematic cross-sectional view illustrating another preferred embodiment of the electrophotographic photoreceptor according to the present invention;

FIG. 6 is a schematic view illustrating one of the preferred embodiments of an image forming apparatus according to the present invention;

FIG. 7 is a schematic view illustrating another preferred embodiment of the image forming apparatus of the present invention;

FIG. 8 is a schematic view illustrating another preferred embodiment of the image forming apparatus of the present invention;

FIG. 9 is a schematic view illustrating another preferred embodiment of the image forming apparatus of the present invention;

FIG. 10 is a schematic view illustrating a configuration of an exemplary exposing device (light scanning device) including a surface emitting laser array as an exposure light source; and

FIG. 11 is a graph illustrating a molecular weight distribution of an exemplary phenolic resin according to the present invention.

### DETAILED DESCRIPTION OF THE INVENTION

Hereinafter, preferred embodiments of the present invention will be described in detail with reference to the accompanying drawings. Note that, in the following description, the same or similar elements are denoted by the same reference numerals, and will not be explained.

(Electrophotographic Photoreceptor and Curable Resin Composition)

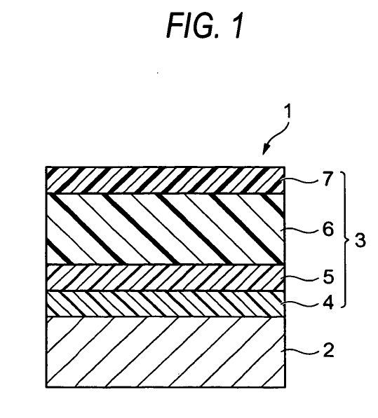

FIG. 1 is a schematic cross-sectional view illustrating a preferred embodiment of an electrophotographic photoreceptor of the present invention. An electrophotographic photoreceptor 1 of FIG. 1 includes a conductive support 2 and a photosensitive layer 3. The photosensitive layer 3 is structured such that an undercoat layer 4, a charge generation layer 5, a charge transport layer 6, and a protection layer 7 are laminated on the conductive support 2 in this order. In the electrophotographic photoreceptor 1 of FIG. 1, the protection layer 7, which is an outermost layer, is a functional layer composed of a cured substance of a curable resin composition containing a phenolic resin having an (MwH/MwL) value of 1.90 or less in a molecular weight distribution measured by gel permeation chromatography, where MwH is a peak area for a weight average molecular weight of 200 or more, and MwL is a peak area for a weight average molecular weight of less than 200.

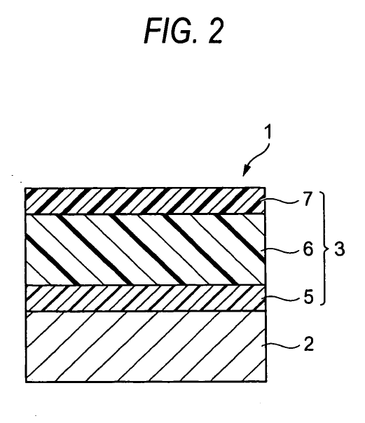

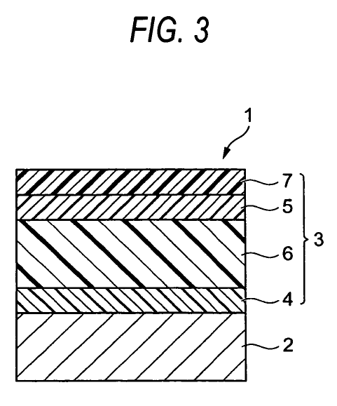

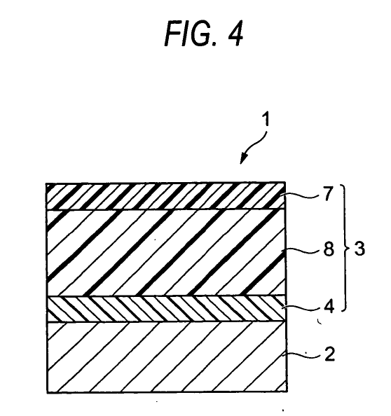

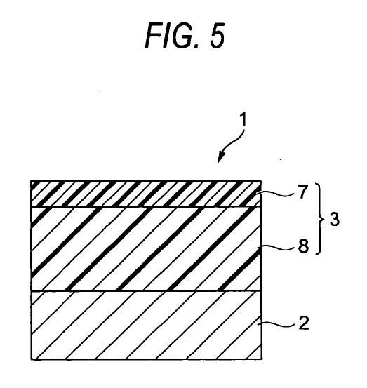

FIGS. 2 to 5 are schematic cross-sectional views illustrating other preferred embodiments of the electrophotographic photoreceptor of the present invention. The electrophotographic photoreceptors of FIGS. 2 and 3 include the photosensitive layer 3 whose function is separated into a charge generation layer 5 and a charge transport layer 6 as in the electrophotographic photoreceptor of FIG. 1. Also, in FIGS. 4 to 5, a charge generation material and a charge transport material are contained in a single layer (single-layer photosensitive layer 8).

The electrophotographic photoreceptor 1 of FIG. 2 is structured such that the charge generation layer 5, the charge transport layer 6, and a protection layer 7 are sequentially laminated on a conductive support 2. Also, the electrophotographic photoreceptor 1 of FIG. 3 is structured such that an undercoat layer 4, the charge transport layer 6, the charge generation layer 5, and a protection layer 7 are sequentially laminated on a conductive support 2. In the electrophotographic photoreceptors 1 of FIGS. 2 and 3, the protection layer 7 is a functional layer composed of a cured substance of the above-described curable resin composition.

Also, the electrophotographic photoreceptor 1 of FIG. 4 is structured such that an undercoat layer 4, the single-layer photosensitive layer 8, and a protection layer 7 are sequentially laminated on a conductive support 2. Also, the electrophotographic photoreceptor 1 of FIG. 5 is structured such that the single-layer photosensitive layer 8 and a protection layer 7 are sequentially laminated on a conductive support 2. In the electrophotographic photoreceptors 1 of FIGS. 4 and 5, the protection layer 7 is a functional layer composed of a cured substance of the above-described curable resin composition.

As described above, the photosensitive layer provided in the electrophotographic photoreceptor of the present invention may be either a single-layer photosensitive layer containing a charge generation material and a charge transport material in a single layer or a functionally separated photosensitive layer in which a layer containing a charge generation material (charge generation layer) and a layer containing a charge transport material (charge transport layer) are separately provided. In the case of the functionally separated photosensitive layer, either the charge generation layer or the charge transport layer may be laminated on the other layer. Note that in the case of the functionally separated photosensitive layer, functional separation can be achieved by layers each fulfilling only its own function, and therefore, higher functions can be implemented.

Hereinafter, each element will be described by taking as a representative example the electrophotographic photoreceptor 1 of FIG. 1.

Examples of the conductive support 2 include a metal plate, a metal drum, a metal belt, and the like, which are composed of a metal, such as aluminum, copper, zinc, stainless steel, chromium, nickel, molybdenum, vanadium, indium, gold, platinum, or the like, or an alloy thereof. Also, as the conductive support 2, it is possible to use paper, plastic film, belt, and the like, on which a conductive compound, such as a conductive polymer, indium oxide, or the like, or a metal, such as aluminum, palladium, gold, or the like, or an alloy thereof, is applied, deposited, or laminated.

In order to prevent an interference pattern from being generated at the time of laser beam irradiation, the conductive support 2 preferably has a rough surface having a centerline average roughness Ra of 0.04 μm to 0.5 μm. When Ra of the surface of the conductive support 2 is less than 0.04 μm, the surface is specular, and therefore, the effect of preventing the interference tends to be insufficient. On the other hand, when Ra exceeds 0.5 μm, image quality tends to be insufficient even if a coating is formed. When incoherent light is used as a light source, it is possible to prevent occurrence of a defect due to surface roughness of the conductive support 2 without particular need of rough surfacing for preventing the interference pattern. Therefore, incoherent light is more suitable for life extension.

Preferred examples of the rough-surfacing method include wet honing performed by spraying a polishing agent suspended in water onto the support, centerless grinding for successively performing a grinding treatment while pressing the support in contact with a rotating grinding stone, an anodic oxidation treatment, and the like.

Another preferred rough-surfacing method is to carry out rough-surfacing by dispersing conductive or semiconductive powder in a resin to form a layer on the support surface so that a fine particle in the layer causes the surface to be rough, without rough-surfacing the surface of the conductive support 2.

The anodic oxidation treatment uses aluminum as an anode and subjects it to anodic oxidation in an electrolytic solution, thereby forming an oxide film on the surface of aluminum. Examples of the electrolytic solution include sulfuric acid solution, oxalate solution, and the like. However, an unprocessed porous anodic oxide film is chemically active and prone to contamination, and the resistance thereof considerably varies depending on the environment. Therefore, a sealing process is carried out by blocking micropores of the anodic oxide film by cubical expansion due to a hydration reaction in steam under pressure or boiling water (to which metal salt, such as nickel or the like, may be added) for transformation into a more stable hydrous oxide.

The anodic oxide film is preferably 0.3 to 15 μm in thickness. When the film thickness is less than 0.35 μm, a barrier property against injection is likely to be unsatisfactory and have an insufficient effect. On the other hand, when the film thickness exceeds 15 μm, residual potential tends to increase due to repetitive use.

Also, the conductive support 2 may be subjected-to a treatment with an acid aqueous solution or a boehmite treatment. A treatment with acid treatment liquid containing phosphoric acid, chromic acid, and fluorinated acid is carried out in the following manner. First, acid treatment liquid is prepared. The mixing ratio of phosphoric acid, chromic acid, and fluorinated acid in the acid treatment liquid is such that phosphoric acid is in the range from 10 to 11% by weight, chromic acid is in the range from 3 to 5% by weight, and fluorinated acid is in the range from 0.5 to 2% by weight, and the total density of these acids is preferably in the range from 13.5 to 18% by weight. Treatment temperature is preferably 42 to 48° C., and if it is kept high, it is possible to form a thicker coating at higher speed. The coating is preferably 0.3 to 15 μm in thickness. When the thickness is less than 0.3 μm, a barrier property against injection is likely to be unsatisfactory and have an insufficient effect. On the other hand, when the thickness exceeds 15 μm, residual potential tends to increase due to repetitive use.

The boehmite treatment can be carried out by dipping in pure water at 90 to 100° C. for 5 to 60 minutes or by contacting steam heated at 90 to 120° C. for 5 to 60 minutes. The coating is preferably 0.1 to 5 μm in thickness. The coating may be further subjected to an anodic oxidation treatment with an electrolytic solution, such as adipic acid, boric acid, borate, phosphate, phthalate, maleate, benzoate, tartrate, citrate, or the like, which is poor in dissolving the coating.

The undercoat layer 4 is formed on the conductive support 2. The undercoat layer 4 contains, for example, an organic metal compound and/or a binding resin.

Examples of the organic metal compound include: organic zirconium compounds, such as a zirconium chelate compound, a zirconium alkoxide compound, a zirconium coupling agent, and the like; organic titanium compounds, such as a titanium chelate compound, a titanium alkoxide compound, a titanate coupling agent, and the like; and organic aluminum compounds, such as an aluminum chelate compound, an aluminum coupling agent, and the like; and in addition, an antimony alkoxide compound, a germanium alkoxide compound, an indium alkoxide compound, an indium chelate compound, a manganese alkoxide compound, a manganese chelate compound, a tin alkoxide compound, a tin chelate compound, an aluminum silicon alkoxide compound, an aluminum titanium alkoxide compound, an aluminum zirconium alkoxide compound, and the like.

As the organic metal compound, an organic zirconium compound, an organic titanyl compound, and an organic aluminum compound are particularly preferred because residual potential is low and satisfactory electrophotographic characteristics are exhibited.

Examples of the binding resin include known resins, such as polyvinyl alcohol, polyvinyl methyl ether, poly-N-vinylimidazole, polyethylene oxide, ethyl cellulose, methyl cellulose, ethylene-acrylic acid copolymer, polyamide, polyimide, casein, gelatin, polyethylene, polyester, phenolic resin, vinyl chloride-vinyl acetate copolymer, epoxy resin, polyvinylpyrrolidone, polyvinylpyridine, polyurethane, polyglutamic acid, polyacrylic acid, and the like. In the case of using them in combination of two or more, the mixing ratio thereof can be set as necessary and as appropriate.

Also, the undercoat layer 4 may contain a silane coupling agent, such as vinyltrichlorosilane, vinyltrimethoxysilane, vinyltriethoxysilane, vinyltris(2-methoxyethoxy)silane, vinyltriacetoxysilane, γ-glycidoxypropyltrimethoxysilane, γ-methacryloxypropyltrimethoxysilane, γ-aminopropyltriethoxysilane, γ-chloropropyltrimethoxysilane, γ-2-aminoethylaminopropyltrimethoxysilane, γ-mercapropropyltrimethoxysilane, γ-ureidepropyltriethoxysilane, β-3,4-epoxycyclohexyltrimethoxysilane, and the like.

Also, from the viewpoint of a reduction in residual potential or environmental stability, an electron transporting pigment may be mixed/dispersed in the undercoat layer 4. Examples of the electron transporting pigment include organic pigments, such as a perylene pigment, a bisbenzimidazoleperylene pigment, a polycyclic quinone pigment, an indigo pigment, a quinacridone pigment, and the like, which are described in Japanese Patent Unexamined Publication No. 47-30330, and also include: organic pigments, such as a bisazo pigment and a phthalocyanine pigment, which include an electron withdrawing substituent group, such as a cyano group, a nitro group, a nitroso group, a halogen atom, or the like; inorganic pigments, such as zinc oxide, titanium oxide, and the like; and the like.

Among these pigments, a perylene pigment, a bisbenzimidazoleperylene pigment, a polycyclic quinone pigment, zinc oxide, or titanium oxide is preferably used because of their a high level of electron mobility.

Also, these pigments may be surface-treated with a coupling agent, a binding resin, or the like described above for the purpose of controlling dispersibility and charge transporting ability.

If the amount of the electron transporting pigment is excessively large, the strength of the undercoat layer 4 is reduced, causing a coating film defect. Therefore, the pigment is used preferably in an amount of 95% by weight or less, more preferably in an amount of 90% by weight or less, with reference to the total solid content of the undercoat layer 4.

Also, the undercoat layer 4 is preferably added with fine powder of various organic or inorganic compounds for the purpose of enhancing electrical characteristics or light scattering ability. For example, particularly effective are: white pigments, such as titanium oxide, zinc oxide, zinc flower, zinc sulfide, white lead, lithopone, and the like; inorganic pigments as extender pigments, such as alumina, calcium carbonate, barium sulfate, and the like; a polytetrafluoroethylene resin particle; a benzoguanamine resin particle; a styrene resin particle; and the like.

The volume average particle diameter of the fine powder which is to be added is preferably 0.01 to 2 μm. The fine powder is added as the necessity arises, and the added amount thereof is preferably 10 to 90% by weight, more preferably 30 to 80% by weight, with reference to the total solid content of the undercoat layer 4.

The undercoat layer 4 is formed using coating liquid for forming an undercoat layer, which contains each of the above-described constituent materials. Any organic solvent may be used as the coating liquid for forming an undercoat layer so long as it dissolves the organic metal compound and the binding resin and is not gelled or coagulated when the electron transporting pigment is mixed therewith/dispersed therein.

Examples of the organic solvent include ordinary solvents, such as methanol, ethanol, n-propanol, n-butanol, benzyl alcohol, methylcellosolve, ethylcellosolve, acetone, methyl ethyl ketone, cyclohexanone, methyl acetate, n-butyl acetate, dioxane, tetrahydrofuran, methylene chloride, chloroform, chlorobenzene, toluene, and the like. These can be used singly or in combination of two or more.

Applicable as the method for mixing and/or dispersing the constituent materials are conventional methods using a ball mill, a roll mill, a sand mill, an attritor, a vibratory ball mill, a colloid mill, paint shaker supersonic wave, and the like. Mixing and/or dispersing are carried out in the organic solvent.

Examples of the coating method which is used so as to form the undercoat layer 4 include conventional methods, such as a blade coating method, a wire bar coating method, a spray coating method, a dip coating method, a bead coating method, an air knife coating method, a curtain coating method, and the like.

Drying is ordinarily carried out at a temperature which allows evaporation of the solvent and film formation. In particular, the conductive support 2 which has been subjected to an acid solution treatment or a boehmite treatment is likely to be insufficient in covering defects of a substrate, and therefore, it is preferable to form the undercoat layer 4.

The thickness of the undercoat layer 4 is preferably 0.01 to 30 μm, more preferably 0.05 to 25 μm.

The charge generation layer 5 contains a charge generation material, and further a binding resin as necessary.

Examples of the charge generation material include known materials including: organic pigments, such as azo pigments (e.g., bisazo, trisazo, etc.), condensed ring aromatic pigments (e.g., dibromo anthanthrone, etc.), a perylene pigment, a pyrrolopyrrole pigment, a phthalocyanine pigment, and the like; inorganic pigments, such as trigonal selenium, zinc oxide, and the like; and the like. Particularly, in the case of using a light source having an exposure wavelength of 380 to 500 nm, the charge generation material is preferably a metal or metal-free phthalocyanine pigment, triagonal selenium, dibromo anthanthrone, or the like. Among them, hydroxy gallium phthalocyanines disclosed in Japanese Patent Unexamined Publications Nos. H05-263007 and H05-279591, chloro gallium phthalocyanines disclosed in Japanese Patent Unexamined Publication No. H05-98181, dichlorotin phthalocyanines disclosed in Japanese Patent Unexamined Publications Nos. H05-140472 and H05-140473, and titanyl phthalocyanines disclosed in Japanese Patent Unexamined Publications Nos. H04-189873 and H05 -43813 are particularly preferable.

Also, among the above-described hydroxy gallium phthalocyanines, those having an absorption maximum value from 810 to 839 nm in an optical absorption spectrum, a primary particle diameter of 0.10 μm or less, and a specific surface area value of 45 m²/g or more measured by the BET method, are preferable.

The binding resin can be selected from a wide range of insulating resins, and it can be also selected from organic photoconducting polymers, such as poly-N-vinylcarbazole, polyvinylanthracene, polyvinylpyrene, polysilane, and the like. Preferable examples of the binding resin include, but are not limited to, insulating resins, such as polyvinyl butyral resin, polyarylate resin (e.g., a polycondensate of bisphenol A and phthalic acid, etc.), polycarbonate resin, polyester resin, phenoxy resin, a vinyl chloride-vinyl acetate copolymer, polyamide resin, acrylic resin, polyacrylamide resin, polyvinylpyridine resin, cellulose resin, urethane resin, epoxy resin, casein, polyvinyl alcohol resin, polyvinylpyrrolidone resin, and the like. These binding resins can be used singly or in combination of two or more.

The charge generation layer 5 is formed by depositing the charge generation material or by using coating liquid for forming a charge generation layer, which contains the charge generation material and the binding resin. In the case of forming the charge generation layer 5 using the coating liquid for forming a charge generation layer, the mixing ratio (weight ratio) of the charge generation material to the binding resin is preferably in the range from 10:1 to 1:10.

Examples of a method for dispersing each of the above-described constituent materials in the coating liquid for forming a charge generation layer include ordinary methods, such as a ball mill dispersion method, an attritor dispersion method, a sand mill dispersion method, and the like. In this case, conditions under which the crystal form of a pigment is not changed by dispersion, are required. Further, for the dispersion, it is effective to use a particle having a size of preferably 0.5 μm or less, more preferably 0.3 μm or less, and even more preferably 0.15 μm or less.

Examples of the solvent used for dispersion include ordinary organic solvents, such as methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorbenzene, toluene, and the like. These can be used singly or in combination of two or more.

Examples of a coating method which is used when forming the charge generation layer 5 using the coating liquid for forming a charge generation layer include ordinary methods, such as a blade coating method, a wire bar coating method, a spray coating method, a dip coating method, a bead coating method, an air knife coating method, a curtain coating method, and the like.

The thickness of the charge generation layer 5 is preferably 0.1 to 5 μm, more preferably 0.2 to 2.0 μm.

The charge transport layer 6 contains a charge transport material and a binding resin, or contains a macromolecular charge transport material.

Examples of the charge transport material include, but are not limited to: electron transporting compounds, such as quinone compounds (e.g., p-benzoquinone, chloranil, bromanil, anthraquinone, etc.), tetracyanoquinodimethane compounds, fluorenone compounds (e.g., 2,4,7-trinitrofluorenone, etc.), xanthone compounds, benzophenone compounds, cyanovinyl compounds, ethylene compounds, and the like; and hole transporting compounds, such as triarylamine compounds, benzidine compounds, arylalkane compounds, aryl-substituted ethylene compounds, stilbene compounds, anthracene compounds, hydrazone compounds, and the like. These charge transport materials can be used singly or in combination of two or more.

Also, from the viewpoint of mobility, the charge transport material is preferably a compound represented by the following general formula (a-1), (a-2) or (a-3).

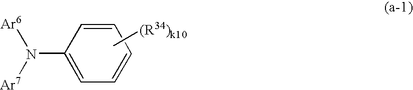

In the above-described formula (a-1), R³⁴ denotes a hydrogen atom or a methyl group, and k10 denotes 1 or 2. Also, Ar⁶ and Ar⁷ denote a substituted or unsubstituted aryl group, —C₆H₄—C(R³⁸)═C(R³⁹)(R⁴⁰) or —C₆H₄—CH═CH—CH═C(Ar)₂, and examples of the substituent group include a halogen atom, an alkyl group having one to five carbon atoms, an alkoxy group having one to five carbon atoms, or substituted amino groups substituted with an alkyl group having one to three carbon atoms. Also, R³⁸, R³⁹ and R⁴⁰ denote a hydrogen atom, a substituted or unsubstituted alkyl group, or a substituted or unsubstituted aryl group, and Ar denotes a substituted or unsubstituted aryl group.

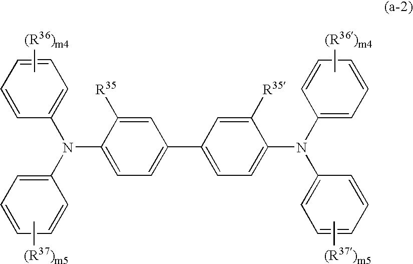

In the above-described formula (a-2), R³⁵ and R^{35′} each individually denotes a hydrogen atom, a halogen atom, an alkyl group having one to five carbon atoms, or an alkoxy group having one to five carbon atoms, R³⁶, R³⁶, R³⁷ and R^{37′} each individually denotes a halogen atom, an alkyl group having one to five carbon atoms, an alkoxy group having one to five carbon atoms, an amino group substituted with an alkyl group having one to two carbon atoms, a substituted or unsubstituted aryl group, —C(R³⁸)═C(R³⁹)(R⁴⁰), or —CH═CH—CH═C(Ar)₂, R³⁸, R³⁹ and R⁴⁰ each individually denotes a hydrogen atom, a substituted or unsubstituted alkyl group, or a substituted or unsubstituted aryl group, and Ar denotes a substituted or unsubstituted aryl group. Also, m4 and m5 each individually denotes an integer from 0 to 2.

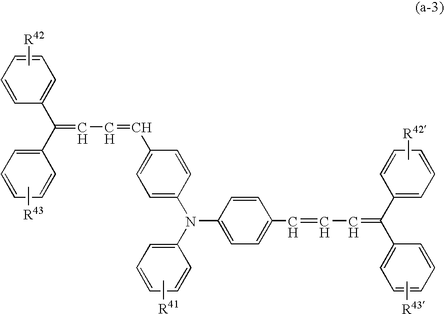

Here, in the above-described formula (a-3), R⁴¹ denotes a hydrogen atom, an alkyl group having one to five carbon atoms, an alkoxy group having one to five carbon atoms, a substituted or unsubstituted aryl group, or —CH═CH—CH═C(Ar)₂. Ar denotes a substituted or unsubstituted aryl group. R⁴², R^{42′}, R⁴³ and R^{43′} each individually denotes a hydrogen atom, a halogen atom, an alkyl group having one to five carbon atoms, an alkoxy group having one to five carbon atoms, an amino group substituted with an alkyl group having one to two carbon atoms, or a substituted or unsubstituted aryl group.

Exanples of the binding resin used for the charge transport layer 6 include polycarbonate resin, polyester resin, methacrylic resin, acrylic resin, polyvinyl chloride resin, polyvinylidene. chloride resin, polystyrene resin, polyvinyl acetate resin, styrene-butadiene copolymer, vinylidene chloride-acrylonitrile copolymer, vinyl chloride-vinyl acetate copolymer, vinyl chloride-vinyl acetate-maleic anhydride copolymer, silicone resin, silicone-alkyd resin, phenol-formaldehyde resin, styrene-alkyd resin, and the like. These binding resins can be used singly or in combination of two or more. The mixing ratio (weight ratio) between the charge transport material and the binding resin is preferably 10:1 to 1:5.

Also, as a macromolecular charge transport material, a known charge transporting material, such as poly-N-vinylcarbazole, polysilane, or the like, can be used. For example, polyester-based macromolecular charge transport materials disclosed in Japanese Patent Unexamined Publications Nos. H08-176293 and H08-208820 are particularly preferable because of their high charge transporting ability.

The macromolecular charge transport material can be singly used as a constituent material of the charge transport layer 6, but can be combined with the above-described binding resin for film formation.

The charge transport layer 6 is formed using coating liquid for forming a charge transport layer, which contains the above-described constituent material.

Examples of a solvent for the coating liquid for forming a charge transport layer include ordinary organic solvents, such as aromatic hydrocarbons (e.g., benzene, toluene, xylene, chlorbenzene, etc.), ketones (e.g., acetone, 2-butanone, etc.), halogenated aliphatic hydrocarbons (e.g., methylene chloride, chloroform, ethylene chloride, etc.), cyclic or straight-chained ethers (e.g., tetrahydrofuran, ethyl ether, etc.). These can be used singly or in combination of two or more.

Examples of a coating method which is used for the coating liquid for forming a charge transport layer include conventional methods, such as a blade coating method, a wire bar coating method, a spray coating method, a dip coating method, a bead coating method, an air knife coating method, a curtain coating method, and the like.

The thickness of the charge transport layer 6 is preferably 5 to 50 μm, more preferably 10 to 30 μm.

The photosensitive layer 3 may be added with an additive, such as an antioxidant, a light stabilizer, a thermal stabilizer, or the like, for the purpose of preventing the photoreceptor from being deteriorated due to ozone or oxidized gas generated in the image forming apparatus or due to light or heat.

Examples of the antioxidant include hindered phenol, hindered amine, paraphenylendiamine, arylalkane, hydroquinone, spirochroman, spiroindanone, derivatives thereof, organic sulfur compounds, organic phosphorus compounds, and the like. Examples of the light stabilizer include derivatives of benzophenone, benzotriazole, dithiocarbamate, tetramethylpiperidine, and the like.

Also, the photosensitive layer 3 can contain at least one electron accepting substance for the purpose of achieving an improvement in sensitivity, a reduction in residual potential, a reduction in fatigue during repetitive use, and the like.

Examples of the electron accepting substance include succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, phthalic acid, and the like. Among these, fluorenones, quinines, and benzene derivatives having an electron withdrawing substituent group, such as Cl, CN, NO₂, or the like, are particularly preferable.

In the electrophotographic photoreceptor of the present embodiment, the protection layer 7 is an outermost layer composed of a cured substance of a curable resin composition containing a phenolic resin having an (MwH/MwL) value of 1.90 or less in a molecular weight distribution measured by gel permeation chromatography, where MwH is a peak area for a weight average molecular weight of 200 or more, and MwL is a peak area for a weight average molecular weight of less than 200.

The phenolic resin contained in the curable resin composition of the present invention is required to have an (MwH/MwL) value of 1.90 or less in a molecular weight distribution measured by gel permeation chromatography, where MwH is a peak area for a weight average molecular weight of 200, and MwL is a peak area for a weight average molecular weight of less than 200. Here, the upper limit of the (MwH/MwL) value is preferably 1.50, more preferably 1.20. On the other hand, the lower limit of the (MwH/MwL) value is preferably 0.20, more preferably 0.3. When the (MwH/MwL) value exceeds 1.90, a larger number of molecules having a high weight average molecular weight are present and these molecules are insolubilized due to local crosslinking, so that the molecules are unlikely to be leveled. Therefore, in this case, a defect, such as a projection or the like, is likely to occur, resulting in insufficient film formation ability of the protection layer 7. On the other hand, when the (MwH/MwL) value is less than 0.20, the mechanical strength of the protection layer 7 is likely to be insufficient.

The phenolic resin according to the present invention can be obtained by reacting a compound having a phenolic structure with formaldehyde or a compound which generates formaldehyde. As the phenolic resin, monomers of monomethylol phenols, dimethylol phenols and trimethylol phenols, mixtures thereof, or oligomers thereof, and mixtures of the monomers and oligomers, can be used.

Examples of the compound having a phenolic structure include: substituted phenols containing one hydroxyl group, such as resorcin, bisphenol, phenol, cresol, xylenol, paraalkyl phenol, paraphenyl phenol, and the like; substituted phenols containing two hydroxyl groups, such as catechol, resorcinol, hydroquinone, and the like; bisphenols, such as bisphenol A, bisphenol Z, and the like; biphenols; and the like.

Examples of formaldehyde or the compound which generates formaldehyde include, in addition to formaldehyde and as compounds which generate formaldehyde, aldehyde derivatives (e.g., paraformaldehyde, hexamethylenetetramine, etc.), aliphatic aldehydes (e.g., acetaldehyde, propionaldehyde, etc.), aromatic aldehydes typified by benzaldehyde, heterocyclic aldehydes (e.g., furfural, etc.), and the like. These can be used singly or in combination of two or more. Among these, formaldehyde and paraformaldehyde are preferable.

Also, the compound having a phenolic structure and formaldehyde or a compound which generates formaldehyde are preferably reacted with each other in the presence of a catalyst, such as acid or alkali.

Examples of the acid catalyst used here are sulfuric acid, toluenesulfonic acid, phenolsulfonic acid and phosphoric acid.

Examples of the alkali catalyst include hydroxides and oxides of alkali metals and alkaline earth metals (e.g., NaOH, KOH, Ca(OH)₂, Mg(OH)₂, Ba(OH)₂, CaO, MgO, etc.), amine catalysts, acetates (e.g., zinc acetate, sodium acetate, etc.), and the like. Here, examples of the amine catalysts include, but are not limited to, ammonia, hexamethylenetetramine, trimethylanune, triethylamine, triethanolamine, and the like.

Note that there are some catalysts such that a significant number of carriers are trapped by residues of the catalyst, leading to a degradation in electrophotographic characteristics. In such a case, the catalyst is preferably distilled off under reduced pressure, neutralized, or inactivated or removed by contact with an absorbent (e.g., silica gel, etc.), ion exchange resin, or the like. Also, a curing catalyst can be used to cure the above-described phenolic resin for forming the protection layer 7. The curing catalyst is not particularly limited so long as electrical characteristics and the like are not affected.

The molecular weight distribution of the phenolic resin thus obtained can be controlled by appropriately adjusting the type and amount of the catalyst, a reaction time, reaction temperature, and the like when reacting a compound having a phenolic structure with formaldehyde or a compound which generates formaldehyde.

In the present invention, the molecular weight distribution of the phenolic resin can be measured under the following conditions:
Measuring instrument: HLC-8120GPC (manufactured by TOSOH Corp.);
Detector: UV 8020 (manufactured by TOSOH Corp.), wavelength: 254 nm;
Columns: TSK guard column Super H-L, TSK Super H3000, TSK Super H2500, and TSK Super H2000 (all of these are manufactured by TOSOH Corp.), which are coupled in series in this order;
Flow rate: 0.4 mi/min;
Solvent: THF (tetrahydrofuran);
Column temperature: 40° C.;
Molecular weight reference substance: standard polystyrene (manufactured by TOSOH Corp.).

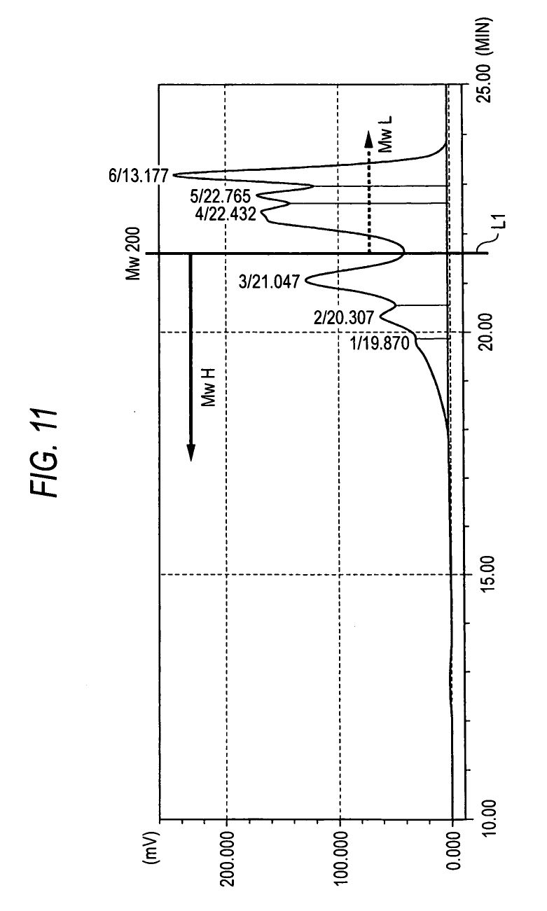

Specifically, in the present invention, the (MwH/MwL) value of the phenolic resin can be obtained as follows. FIG. 11 is a graph illustrating an exemplary molecular weight distribution of the phenolic resin of the present invention, and a vertical line L1 in FIG. 11 indicates a position corresponding to polystyrene of Mw200. The sum of peak areas for those having a retention time shorter than that at the line L1 (with a higher Mw value) is MwH, and the sum of peak areas for those having a retention time longer than that at the line L1 (with a lower Mw value) is MwL. In this example, MwH is 8,347,665, MwL is 14,810,441, and the (MwH/MwL) value is 0.563.

Also, from the viewpoint of further enhancing the film formation ability and mechanical strength of the protection layer 7, the phenolic resin of the present invention preferably has a narrow molecular weight distribution as illustrated in the graph of FIG. 11.

Also, from the viewpoint of enhancing the film formation ability of the protection layer 7 and the adhesion ability between the protection layer 7 and the charge transport layer 6, the curable resin composition may be mixed with a known resin in addition to the phenolic resin.

Also, the curable resin composition preferably contains organic sulfonic acid and/or a derivative thereof as an acid catalyst for accelerating curing of the phenolic resin.

Examples of the organic sulfonic acid and/or a derivative thereof include paratoluene sulfonic acid, dinonylnaphthalene sulfonic acid (DNNSA), dinonylnaphthalene disulfonic acid (DNNDSA), dodecylbenzene sulfonic acid, phenol sulfonic acid, and the like. Among these, paratoluenesulfonic acid and dodecylbenzene sulfonic acid are preferable from the viewpoint of catalytic activity and film formation ability. Also, organic sulfonate can be used if it can be dissociated to some extent in the curable resin composition.

Here, the amount of the phenolic resin contained in the curable resin composition is preferably 20 to 90% by weight, particularly preferably 30 to 70% by weight, with reference to the total solid content of the curable resin composition. When the amount is less than 20% by weight, the protection layer 7 tends to have insufficient mechanical strength, and when the amount exceeds 90% by weight, charge transfer in the protection layer 7 is unlikely to be smooth, resulting in insufficient electrical characteristics.

Also, the amount of organic sulfonic acid and/or derivatives thereof contained in the curable resin composition is preferably 0.01 to 5% by weight, more preferably 0.05 to 3% by weight, and particularly preferably 0.1 to 1% by weight, with reference to the total solid content of the curable resin composition. When the amount is less than 0.01% by weight, a sufficient catalytic effect cannot be obtained, so that the protection layer 7 tends to have insufficient mechanical strength, and when the amount exceeds 5% by weight, the ability as a dopant is likely to be excessively high, leading to an increase in dark current.

Also, in order to form the protection layer 7 which has satisfactory electrical characteristics, the curable resin composition preferably contains a charge transport material or a derivative thereof.

Preferably, the charge transport material has a reactive functional group, and is compatible with the phenolic resin that is used. More preferably, the substance forms a chemical bond with the phenolic resin that is used.

As the charge transport material having a reactive functional group, compounds represented by general formula (I), (II), (III), (IV) or (V) below are preferable because they are superior in terms of film formation ability, mechanical strength, and stability.
F[—D—Si(R¹)₍₃₋ₐ₎Qₐ]_{b} (I)
(In formula (I), F denotes an organic group derived from a compound with hole transporting ability, D denotes a bivalent group with flexibility, R¹ denotes a hydrogen atom, a substituted or unsubstituted alkyl group, or a substituted or unsubstituted aryl group, Q denotes a hydrolyzable group, a denotes an integer from 1 to 3, and b denotes an integer from 1 to 4.)
F[—(X¹)ₙ₁R²—Z¹H]ₘ₁ (II)
(In formula (II), F denotes an organic group derived from a compound with hole transporting ability, R² denotes an alkylene group, Z¹ denotes an oxygen atom, a sulfur atom, NH or COO, X¹ denotes an oxygen atom or a sulfur atom, m1 denotes an integer from 1 to 4, and n1 denotes 0 or 1.)
F[—(X²)ₙ₂—(R³)ₙ₃—(Z²)ₙ₄G]ₙ₅ (III)
(In formula (III), F denotes an organic group derived from a compound with hole transporting ability, X² denotes an oxygen atom or a sulfur atom, R³ denotes an alkylene group, Z² denotes an oxygen atom, a sulfur atom, NH or COO, G denotes an epoxy group, n2, n3 and n4 each individually denotes 0 or 1, and n5 denotes an integer from 1 to 4.) 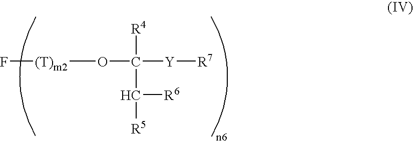
(In formula (IV), F denotes an organic group derived from a compound with hole transporting ability, T denotes a bivalent group, Y denotes an oxygen atom or a sulfur atom, R⁴, R⁵ and R⁶ each individually denotes a hydrogen atom or a monovalent organic group, R⁷ denotes a monovalent organic group, m2 denotes 0 or 1, and n6 denotes an integer from 1 to 4; note that R⁶ and R⁷ may be bonded together to form a heterocyclic ring having Y as a hetero atom.) 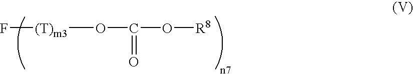
(In formula (V), F denotes an organic group derived from a compound with hole transporting ability, T denotes a bivalent group, R⁸ denotes a monovalent organic group, m3 denotes 0 or 1, and n7 denotes an integer from 1 to 4.)

Also, the above-described F in the compounds represented by the above-described general formulas (I) to (V) is preferably a group represented by the following general formula (VI). 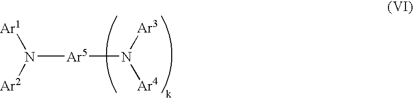
(In formula (VI), Ar¹, Ar², Ar³ and Ar⁴ each individually denotes a substituted or unsubstituted aryl group, Ar⁶ denotes a substituted or unsubstituted aryl or arylene group, and one to four of the groups Ar¹ to Ar⁵ is bonded to a site represented by general formula (VII) below of the compound represented by general formula (I), a site represented by general formula (VIII) below of the compound represented by general formula (II), a site represented by general formula (IX) below of the compound represented by general formula (III), a site represented by general formula (X) below of the compound represented by general formula (IV), or a site represented by general formula (XI) below of the compound represented by general formula (V).)
—D—Si(R¹)₍₃₋ₐ₎Qₐ (VII)
—(X¹)ₙ₁R¹—Z¹H (VIII)
—(X²)ₙ₂—(R²)ₙ₃—(Z²)ₙ₄G (IX)

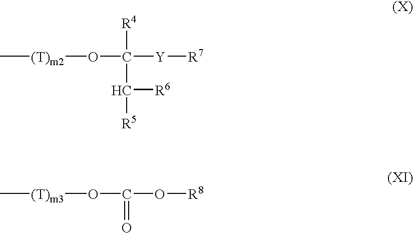

Specifically, the substituted or unsubstituted aryl groups denoted by Ar¹ to Ar⁴ in the above-described general formula (VI) are preferably those represented by the following general formulas (1) to (7).

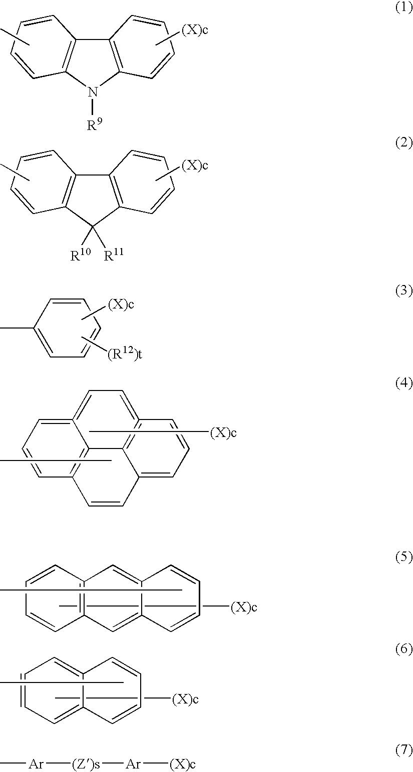

In the above-described formulas (1) to (7), R⁹ denotes a hydrogen atom, an alkyl group having one to four carbon atoms, an alkyl group having one to four carbon atoms, an alkoxy group having one to four carbon atoms, a phenyl group substituted therewith or an unsubstituted phenyl group, or an aralkyl group having seven to ten carbon atoms, R¹⁰ to R¹² each denotes a hydrogen atom, an alkyl group having one to four carbon atoms, an alkoxy group having one to four carbon atoms, an alkoxy group having one to four carbon atoms, a phenyl group substituted therewith or an unsubstituted phenyl group, an aralkyl group having seven to ten carbon atoms, or a halogen atom, Ar denotes a substituted or unsubstituted arylene group, X denotes a structure represented by any of the above-described general formulas (VII) to (XI), c and s each denotes 0 or 1, and t denotes an integer from 1 to 3.

Also, Ar in the aryl group represented by the above-described formula (7) is preferably an arylene group represented by the following formula (8) or (9).

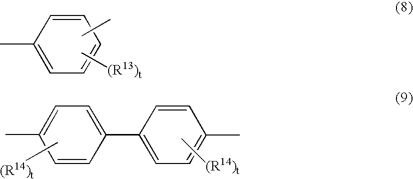

In the above-described formulas (8) and (9), R¹³ and R¹⁴ each denotes a hydrogen atom, an alkyl group having one to four carbon atoms, an alkoxy group having one to four carbon atoms, a phenyl group substituted with an alkoxy group having one to four carbon atoms or an unsubstituted phenyl group, an aralkyl group having seven to ten carbon atoms, or a halogen atom, and t denotes an integer from 1 to 3.

Also, Z′ in the aryl group represented by the above-described formula (7) is preferably a bivalent group represented by any of the following formulas (10) to (17).

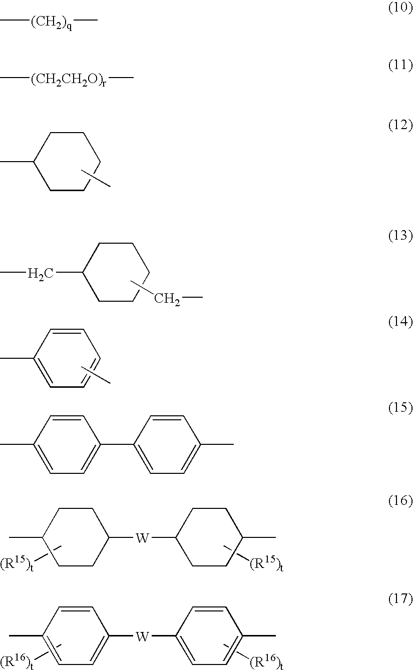

In formulas (10) to (17), R¹⁵ and R¹⁶ each denote a hydrogen atom, an alkyl group having one to four carbon atoms, an alkoxy group having one to four carbon atoms, a phenyl group substituted with an alkoxy group having one to four carbon atoms or an unsubstituted phenyl group, an aralkyl group having seven to ten carbon atoms, or a halogen atom, W denotes a bivalent group, q and r each denote an integer from 1 to 10, and t denotes an integer from 1 to 3.

Also, in the above-described formulas (16) and (17), W denotes a bivalent group represented by any of the following formulas (18) to (26). Note that in formula (25), u denotes an integer from 0 to 3.

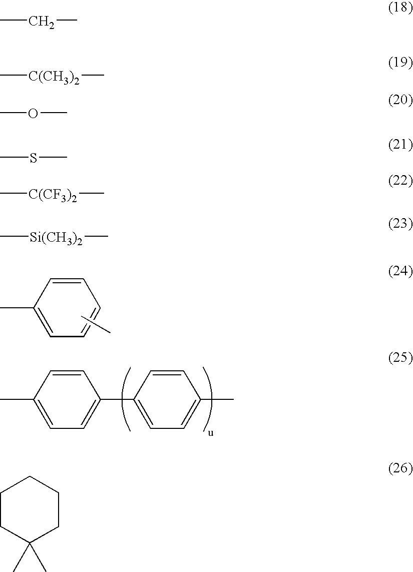

A specific structure of Ar⁵ in the above-described general formula (VI) is a specific structure of Ar¹ to Ar⁴ having c=1 structure when k=0 or a specific structure of Ar¹ to Ar⁴ having c=0 structure when k=1.

More specifically, examples of the compound represented by the above-described general formula (I) include compounds (I-1) to (I-61) below. Note that in the following compounds (I-1) to (I-61), Ar¹ to Ar⁵ and k in the compound represented by the general formula (VI) are combined as illustrated in a table below, and the alkoxysilyl group (s) is specified as illustrated in the table below.

| No. | Ar¹ | Ar² | Ar³ |
|---|---|---|---|
| I-1 | 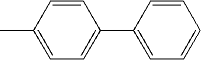 | 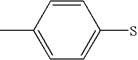 | — |
| I-2 | 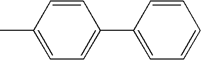 | 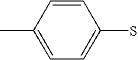 | — |
| I-3 | 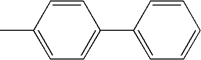 | 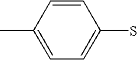 | — |
| I-4 | 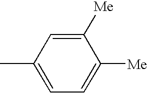 | 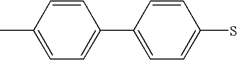 | — |
| I-5 | 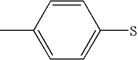 | 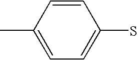 | — |
| I-6 | 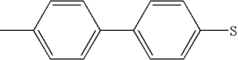 | 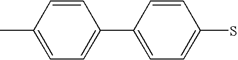 | — |
| I-7 | 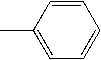 | 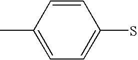 | 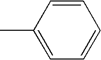 |
| I-8 | 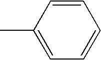 | 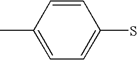 | 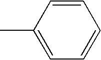 |
| I-9 | 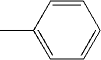 | 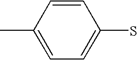 | 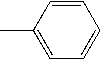 |
| I-10 | 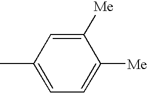 | 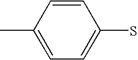 | 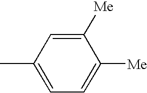 |
| I-11 | 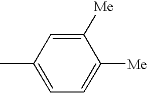 | 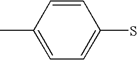 | 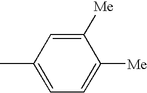 |
| I-12 | 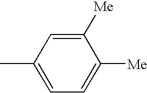 | 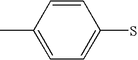 | 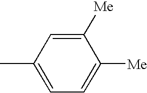 |
| I-13 | 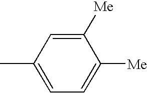 | 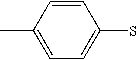 | 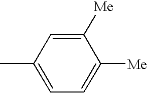 |
| I-14 | 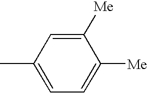 | 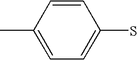 | 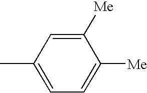 |
| I-15 | 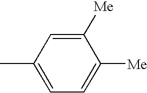 | 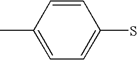 | 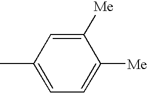 |
| I-16 | 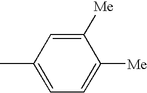 | 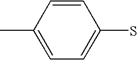 | 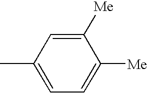 |
| I-17 | 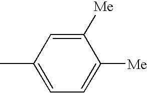 | 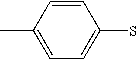 | 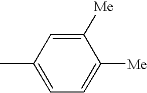 |
| I-18 | 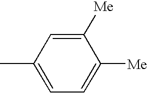 | 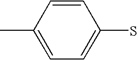 | 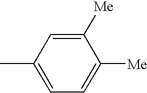 |
| I-19 | 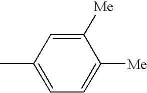 | 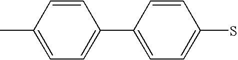 | 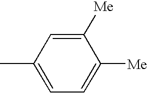 |
| I-20 | 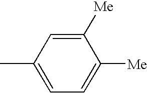 | 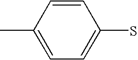 | 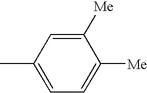 |
| I-21 | 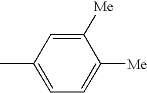 | 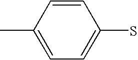 | 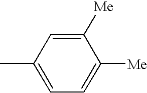 |
| I-22 | 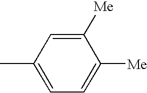 | 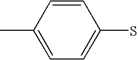 | 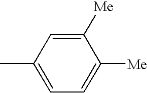 |
| I-23 | 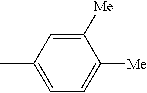 | 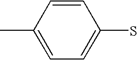 | 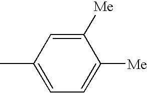 |
| I-24 | 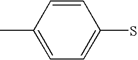 | 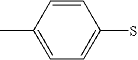 | 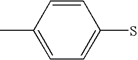 |
| I-25 | 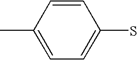 | 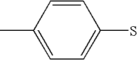 | 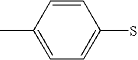 |
| I-26 | 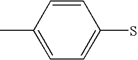 | 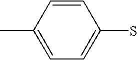 | 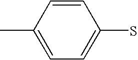 |
| I-27 | 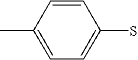 | 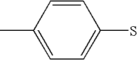 | 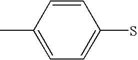 |
| I-28 | 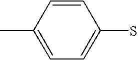 | 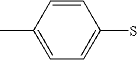 | 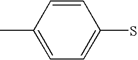 |
| I-29 | 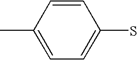 | 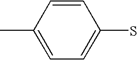 | 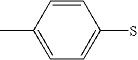 |
| I-30 | 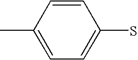 | 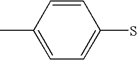 | 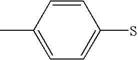 |
| I-31 | 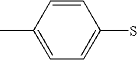 | 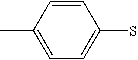 | 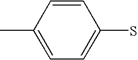 |
| I-32 | 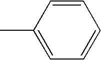 | 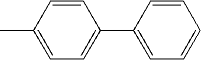 | — |
| I-33 | 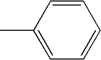 | 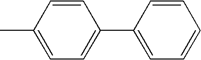 | — |
| I-34 | 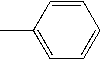 | 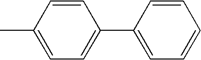 | — |
| I-35 | 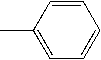 | 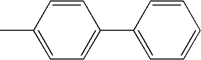 | — |
| I-36 | 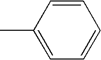 | 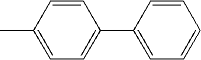 | — |
| I-37 | 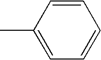 | 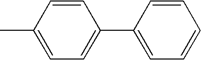 | — |
| I-38 | 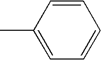 | 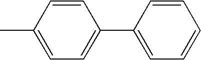 | — |
| I-39 | 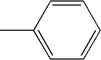 | 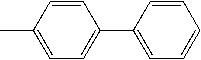 | — |
| I-40 | 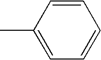 | 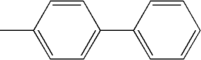 | — |
| I-41 | 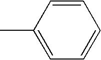 | 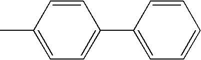 | — |
| I-42 | 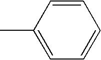 | 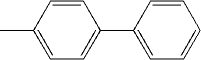 | — |
| I-43 | 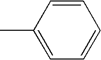 | 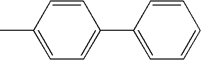 | — |
| I-44 | 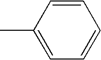 | 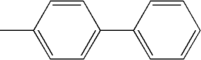 | — |
| I-45 | 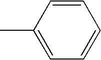 | 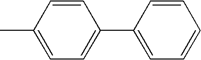 | — |
| I-46 | 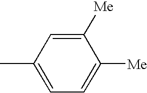 | 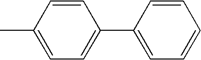 | — |
| I-47 | 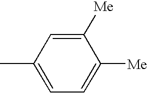 | 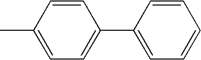 | — |
| I-48 | 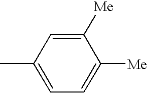 | 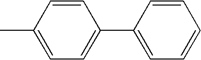 | — |
| I-49 | 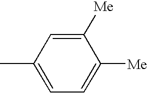 | 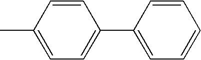 | — |
| I-50 | 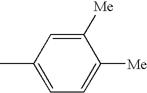 | 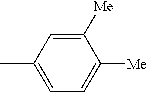 | — |
| I-51 | 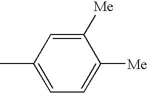 | 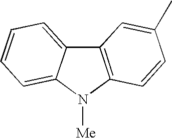 | — |
| I-52 | 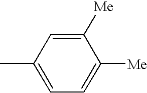 | 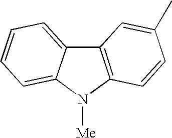 | — |
| I-53 | 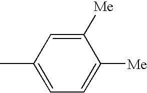 | 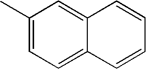 | — |
| I-54 | 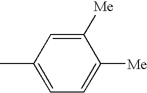 | 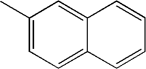 | — |
| I-55 | 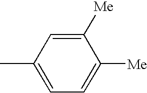 | 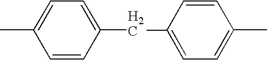 | — |
| I-56 | 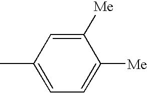 | 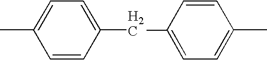 | — |
| I-57 | 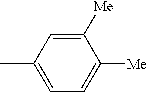 | 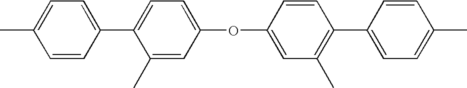 | — |
| I-58 | 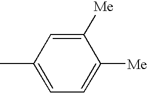 | 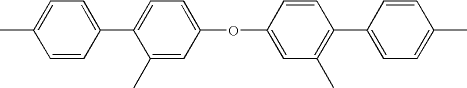 | — |
| I-59 | 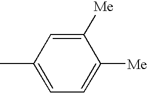 | 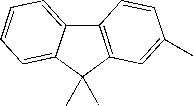 | — |
| I-60 | 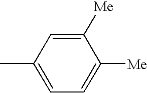 | 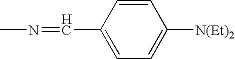 | — |
| I-61 | 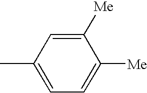 | 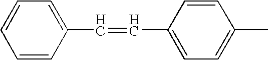 | — |

| No. | Ar⁴ | Ar⁵ | k | S |
|---|---|---|---|---|
| I-1 | — | 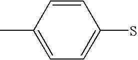 | 0 | —(CH₂)₂—COO—(CH₂)₃—Si(OiPr)₃ |
| I-2 | — | 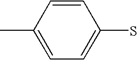 | 0 | —(CH₂)₂—COO—(CH₂)₃—Si(OiPr)₂Me |
| I-3 | — | 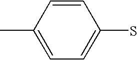 | 0 | —(CH₂)₂—COO—(CH₂)₃—Si(OiPr)Me₂ |
| I-4 | — | 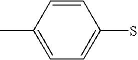 | 0 | —COO—(CH₂)₃—Si(OiPr)₃ |
| I-5 | — | 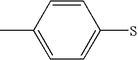 | 0 | —(CH₂)₂—COO—(CH₂)₃—Si(OiPr)₃ |
| I-6 | — | 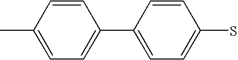 | 0 | —COO—(CH₂)₃—Si(OiPr)₃ |
| I-7 | — | 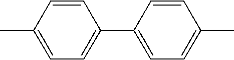 | 1 | —(CH₂)₄—Si(OEt)₃ |
| I-8 | — | 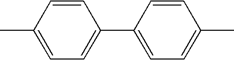 | 1 | —(CH₂)₄—Si(OIPr)₃ |
| I-9 | — | 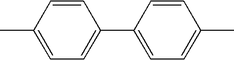 | 1 | —CH═CH—(CH₂)₂—Si(OiPr)₃ |
| I-10 | — | 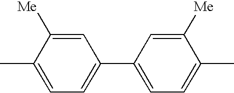 | 1 | —(CH₂)₄—Si(OMe)₃ |
| I-11 | 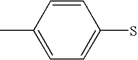 | 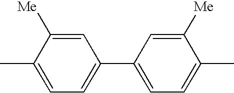 | 1 | —(CH₂)₄—Si(OiPr)₃ |
| I-12 | 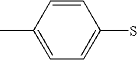 | 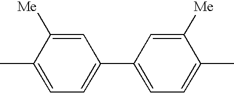 | 1 | —CH═CH—(CH₂)₂—Si(OiPr)₃ |
| I-13 | 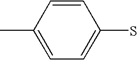 | 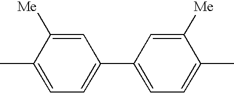 | 1 | —CH═N—(CH₂)₃—Si(OiPr)₃ |
| I-14 | 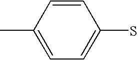 | 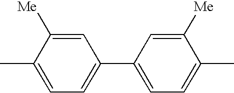 | 1 | —O—(CH₂)₃—Si(OiPr)₃ |
| I-15 | 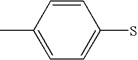 | 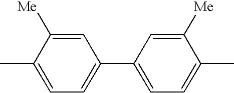 | 1 | —COO—(CH₂)₃—Si(OIPr)₃ |
| I-16 | 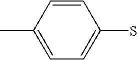 | 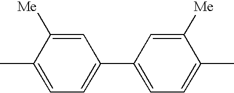 | 1 | —(CH₂)₂—COO—(CH₂)₃—Si(OiPr)₃ |
| I-17 | 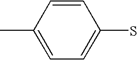 | 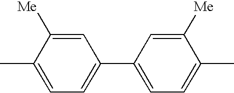 | 1 | —(CH₂)₂—COO—(CH₂)₃—Si(OiPr)₂Me |
| I-18 | 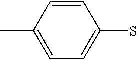 | 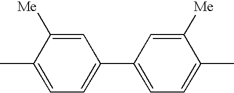 | 1 | —(CH₂)₂—COO—(CH₂)₃—Si(OiPr)Me₂ |
| I-19 | 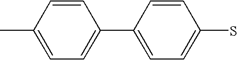 | 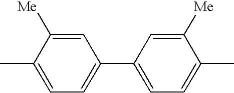 | 1 | —COO—(CH₂)₃—Si(OiPr)₃ |
| I-20 | 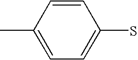 | 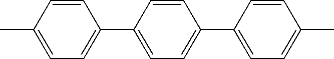 | 1 | —(CH₂)₄—Si(OiPr)₃ |
| I-21 | 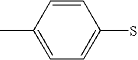 | 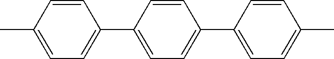 | 1 | —CH═CH—(CH₂)₂—Si(OiPr)₃ |
| I-22 | 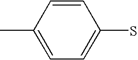 | 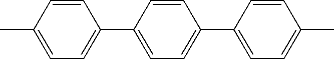 | 1 | —(CH₂)₂—COO—(CH₂)₃—Si(OiPr)₃ |
| I-23 | 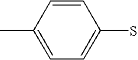 | 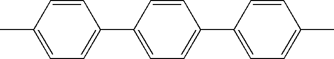 | 1 | —(CH₂)₂—COO—(CH₂)₃—Si(OiPr)₂Me |
| I-24 | 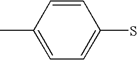 | 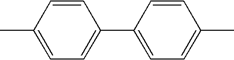 | 1 | —COO—(CH₂)₃—Si(OiPr)₃ |
| I-25 | 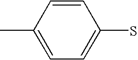 | 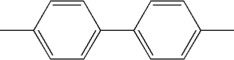 | 1 | —(CH₂)₂—COO—(CH₂)₃—Si(OiPr)₃ |
| I-26 | 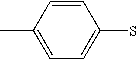 | 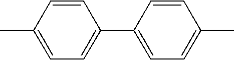 | 1 | —(CH₂)₂—COO—(CH₂)₃—Si(OiPr)₂Me |
| I-27 | 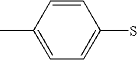 | 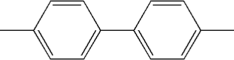 | 1 | —(CH₂)₂—COO—(CH₂)₃—Si(OiPr)Me₂ |
| I-28 | 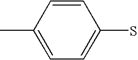 | 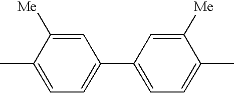 | 1 | —COO—(CH₂)₃—Si(OiPr)₃ |
| I-29 | 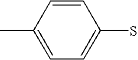 | 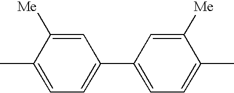 | 1 | —(CH₂)₂—COO—(CH₂)₃—Si(OiPr)₃ |
| I-30 | 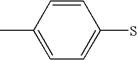 | 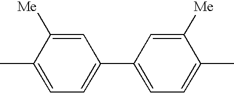 | 1 | —(CH₂)₂—COO—(CH₂)₃—Si(OiPr)₂Me |
| I-31 | 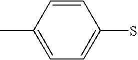 | 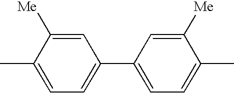 | 1 | —(CH₂)₂—COO—(CH₂)₃—Si(OiPr)Me₂ |
| I-32 | — | 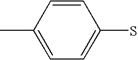 | 0 | —(CH₂)₄—Si(OiPr)₃ |
| I-33 | — | 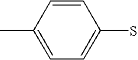 | 0 | —(CH₂)₄—Si(OEt)₃ |
| I-34 | — | 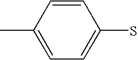 | 0 | —(CH₂)₄—Si(OMe)₃ |
| I-35 | — | 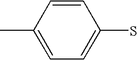 | 0 | —(0H₂)₄—SiMe(OMe)₂ |
| I-36 | — | 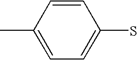 | 0 | —(CH₂)₄—SiMe(OiPr)₂ |
| I-37 | — | 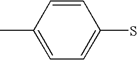 | 0 | —CH═CH—(CH₂)₂—Si(OiPr)₃ |
| I-38 | — | 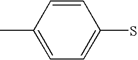 | 0 | —CH═CH—(CH₂)₂—Si(OMe)₃ |
| I-39 | — | 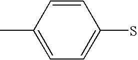 | 0 | —CH═N—(CH₂)₃—Si(OiMe)₃ |
| I-40 | — | 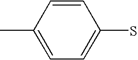 | 0 | —CH═N—(CH₂)₃—Si(OiPr)₃ |
| I-41 | — | 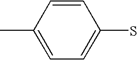 | 0 | —O—(CH₂)₃—Si(OiPr)₃ |
| I-42 | — | 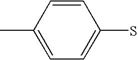 | 0 | —COO—(CH₂)₃—Si(OiPr)₃ |
| I-43 | — | 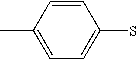 | 0 | —(CH₂)₂—COO—(CH₂)₃—Si(OiPr)₃ |
| I-44 | — | 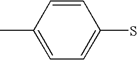 | 0 | —(CH₂)₂—COO—(CH₂)₃—Si(OiPr)₂Me |
| I-45 | — | 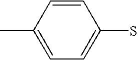 | 0 | —(CH₂)₂—COO—(CH₂)₃—Si(OiPr)Me₂ |
| I-46 | — | 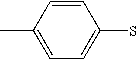 | 0 | —(CH₂)₄—Si(OMe)₃ |
| I-47 | — | 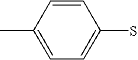 | 0 | —(CH₂)₂—COO—(CH₂)₃—Si(OiPr)₃ |
| I-48 | — | 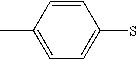 | 0 | —(CH₂)₂—COO—(CH₂)₃—SiMe(OiPr)₂ |
| I-49 | — | 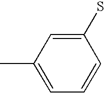 | 0 | —O—(CH₂)₃—Si(OiPr)₃ |
| I-50 | — | 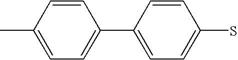 | 0 | —COO—(CH₂)₃—Si(OiPr)₃ |
| I-51 | — | 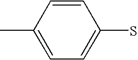 | 0 | —(CH₂)₄—Si(OiPr)₃ |
| I-52 | — | 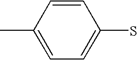 | 0 | —(CH₂)₂—COO—(CH₂)₃—Si(OiPr)₃ |
| I-53 | — | 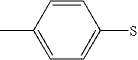 | 0 | —(CH₂)₄—Si(OiPr)₃ |
| I-54 | — | 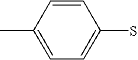 | 0 | —(CH₂)₂—COO—(CH₂)₃—Si(OiPr)₃ |
| I-55 | — | 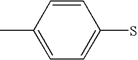 | 0 | —(CH₂)₄—Si(OiPr)₃ |
| I-56 | — | 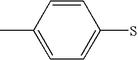 | 0 | —(CH₂)₂—COO—(CH₂)₃—Si(OiPr)₃ |
| I-57 | — | 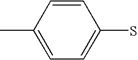 | 0 | —(CH₂)₄—Si(OiPr)₃ |
| I-58 | — | 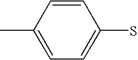 | 0 | —(CH₂)₂—COO—(CH₂)₃—Si(OiPr)₃ |
| I-59 | — | 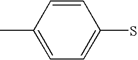 | 0 | —(CH₂)₂—COO—(CH₂)₃—Si(OiPr)₃ |
| I-60 | — | 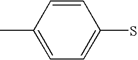 | 0 | —(CH₂)₂—COO—(CH₂)₃—Si(OiPr)₃ |
| I-61 | — | 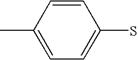 | 0 | —(CH₂)₂—COO—(CH₂)₃—Si(OiPr)₃ |

More specifically, examples of the compound represented by the above-described general formula (II) include compounds (II-1) to (II-37) below. Note that in the following tables, a terminal in which any substituted groups are not described has a methyl group.

| | |
|---|---|
| II-1 | 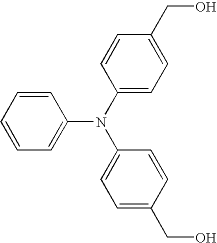 |
| II-2 | 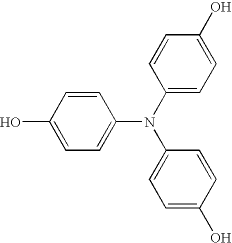 |
| II-3 | 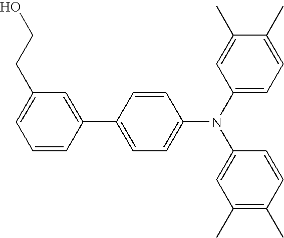 |
| II-4 | 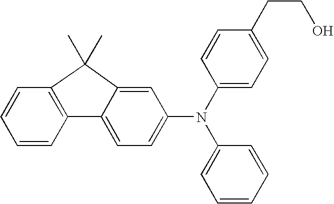 |
| II-5 | 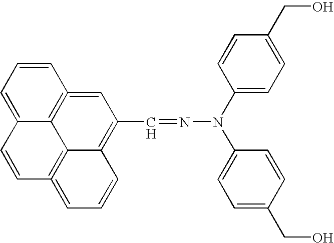 |
| II-6 | 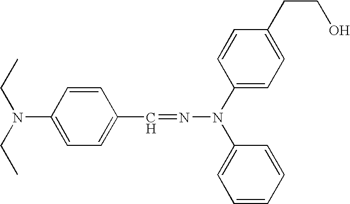 |
| II-7 | 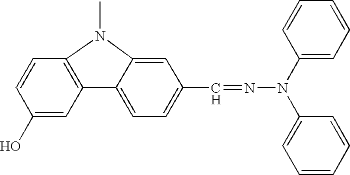 |
| II-8 | 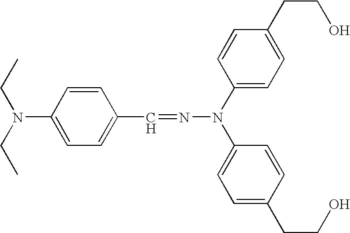 |
| II-9 | 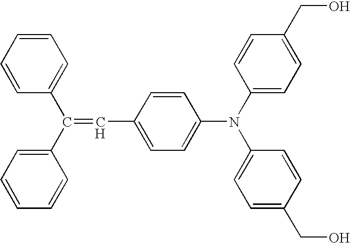 |
| II-10 | 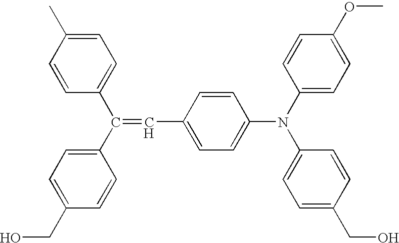 |
| II-11 | 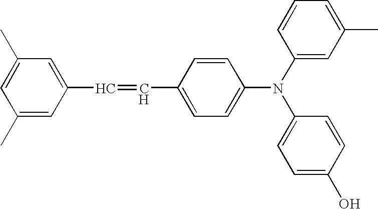 |
| II-12 | 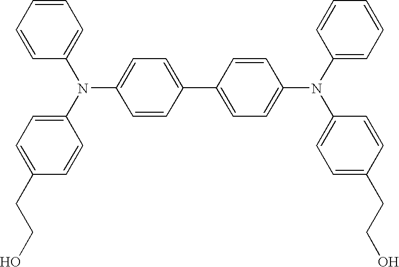 |
| II-13 | 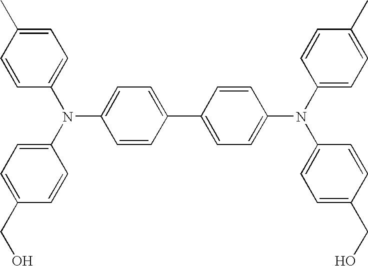 |
| II-14 | 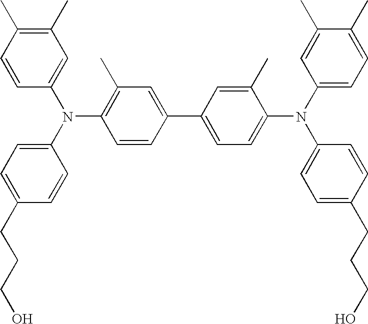 |
| II-15 | 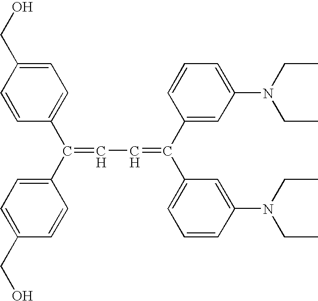 |
| II-16 | 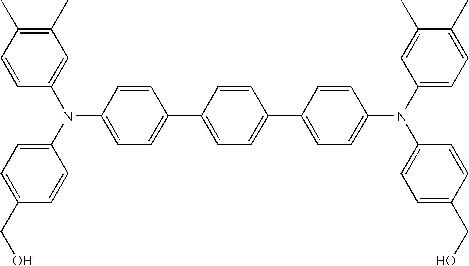 |
| II-17 | 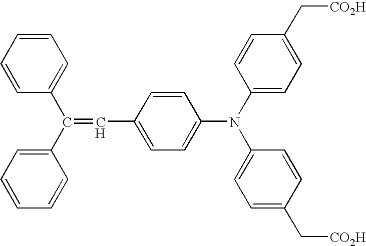 |
| II-18 | 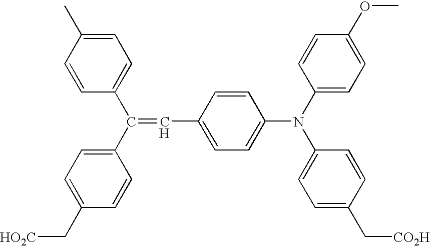 |
| II-19 | 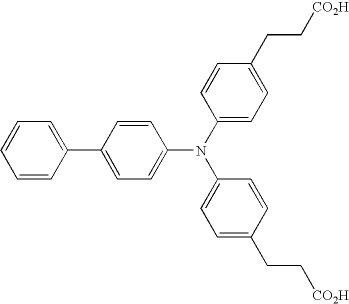 |
| II-20 | 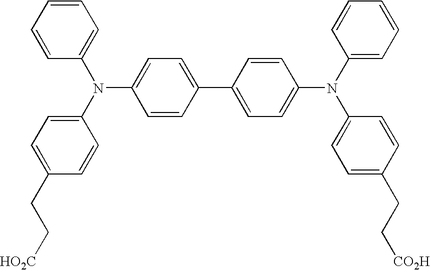 |
| II-21 | 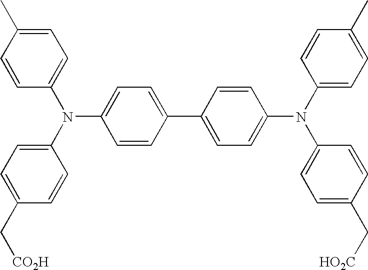 |
| II-22 | 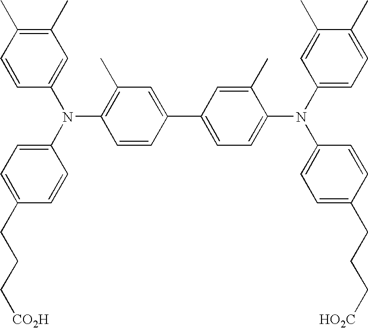 |
| II-23 | 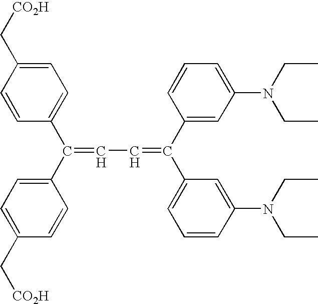 |
| II-24 | 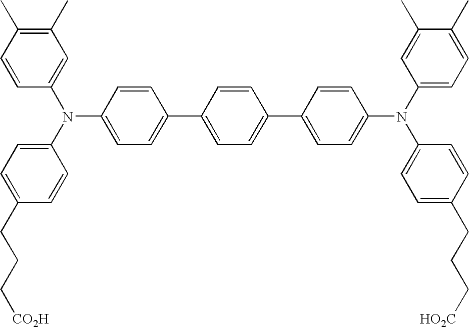 |
| II-25 | 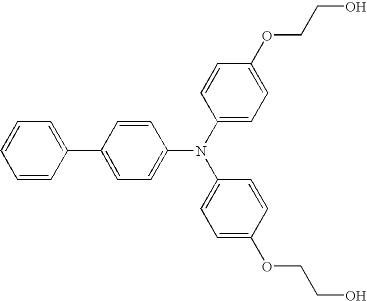 |
| II-26 | 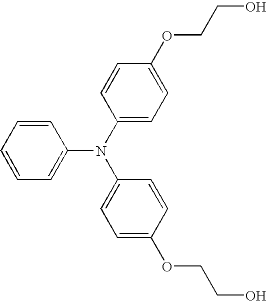 |
| II-27 | 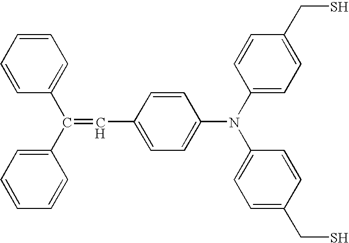 |
| II-28 | 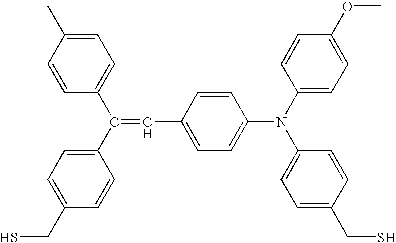 |
| II-29 | 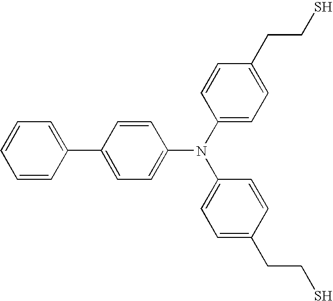 |
| II-30 | 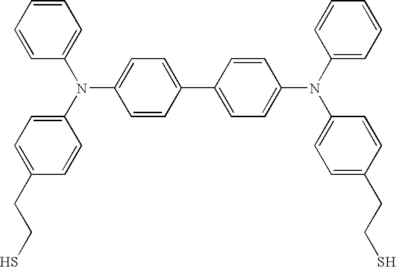 |
| II-31 | 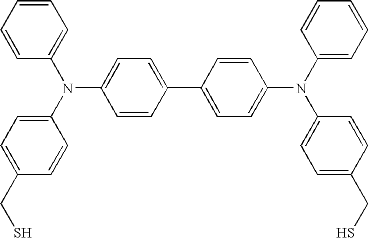 |
| II-32 | 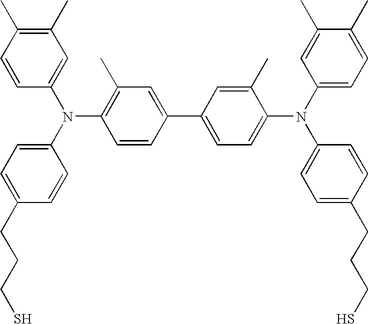 |
| II-33 | 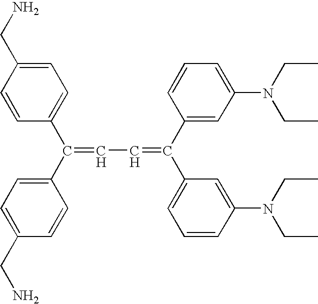 |
| II-34 | 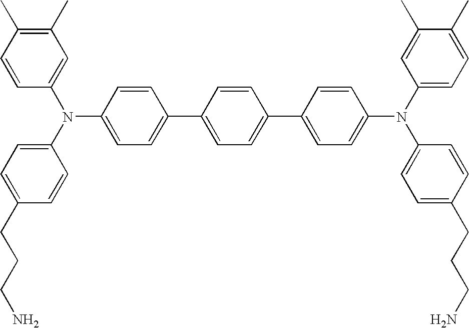 |
| II-35 | 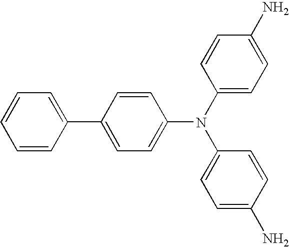 |
| II-36 | 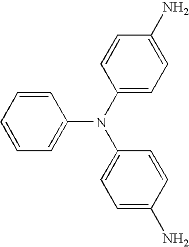 |
| II-37 | 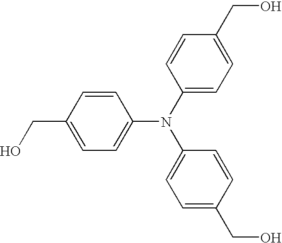 |

More specifically, examples of the compound represented by the above-described general formula (III) include compounds (III-1) to (III-47) below. Note that in the following tables, Me represents a methyl group, Et represents an ethyl group, and a terminal in which any substituted groups are not described has a methyl group.

| | |
|---|---|
| III-1 | 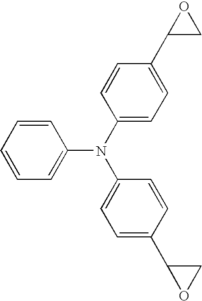 |
| III-2 | 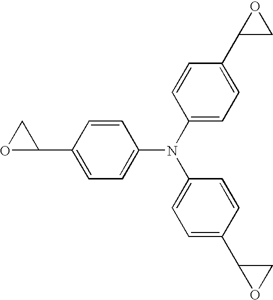 |
| III-3 | 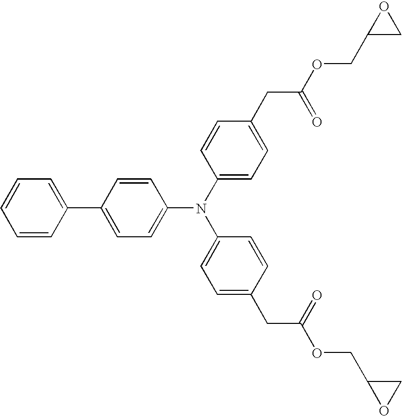 |
| III-4 | 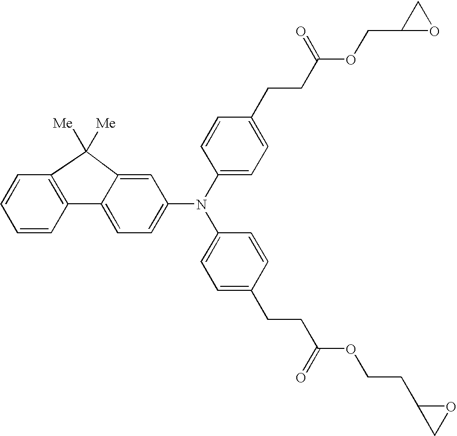 |
| III-5 | 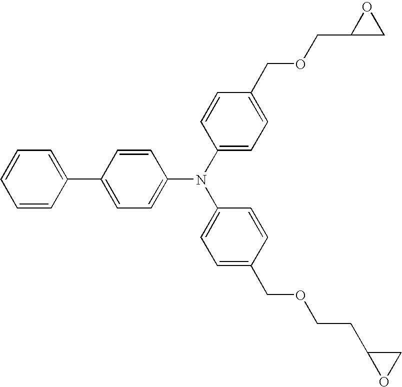 |
| III-6 | 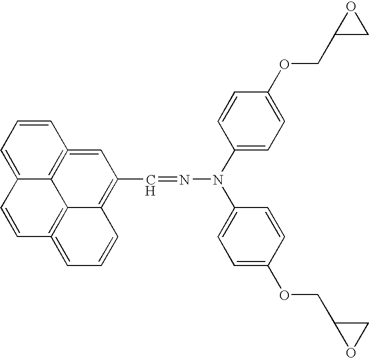 |
| III-7 | 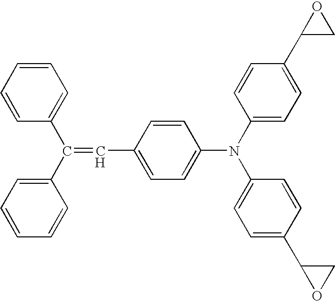 |
| III-8 | 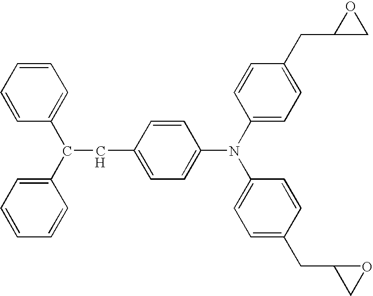 |
| III-9 | 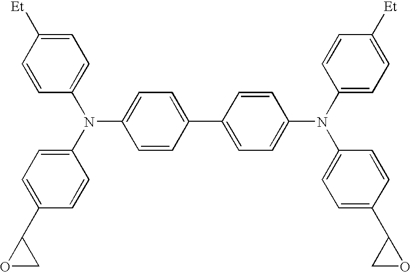 |
| III-10 | 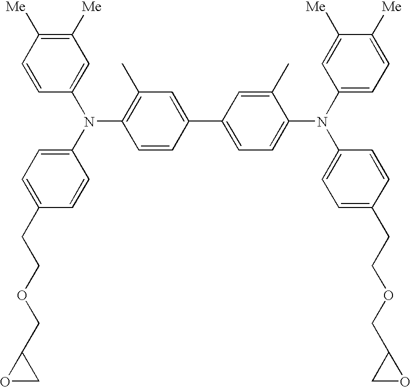 |
| III-11 | 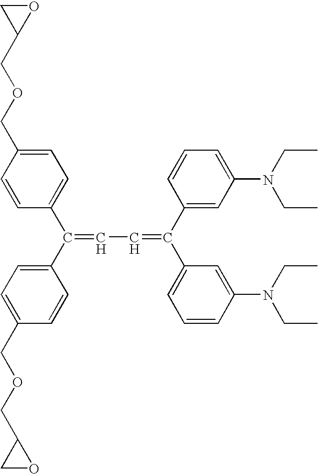 |
| III-12 | 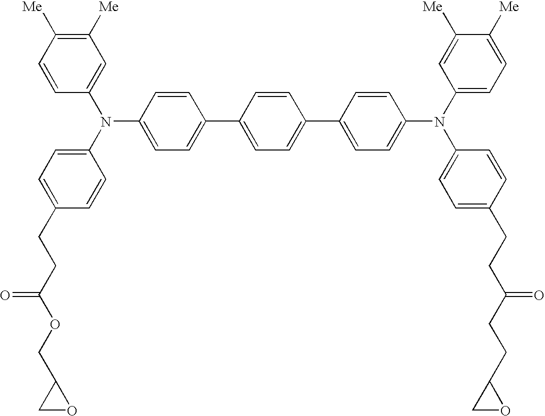 |
| III-13 | 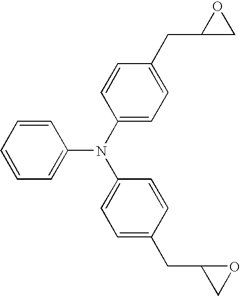 |
| III-14 | 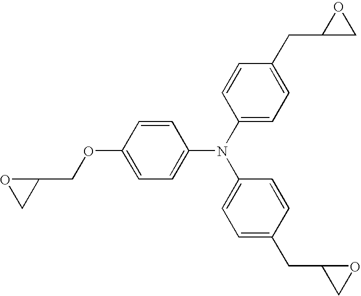 |
| III-15 | 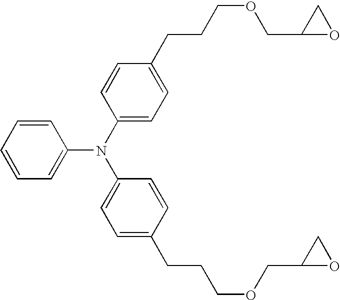 |
| III-16 | 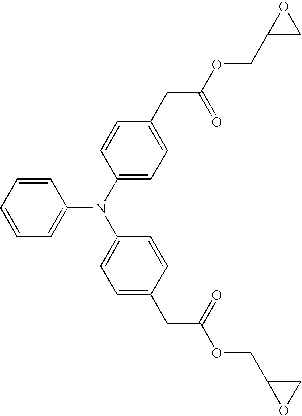 |
| III-17 | 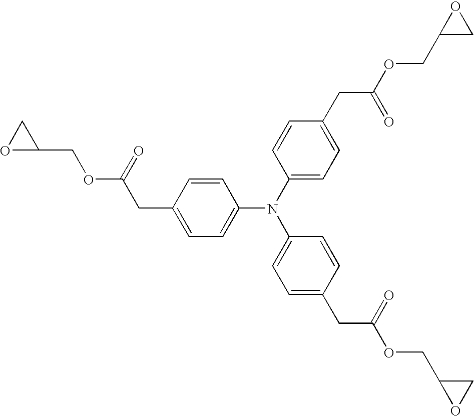 |
| III-18 | 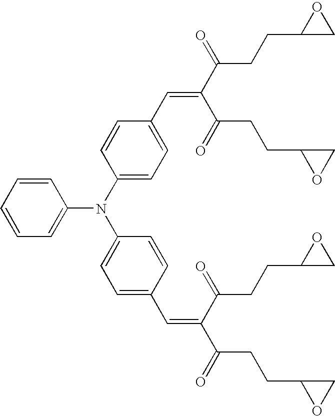 |
| III-19 | 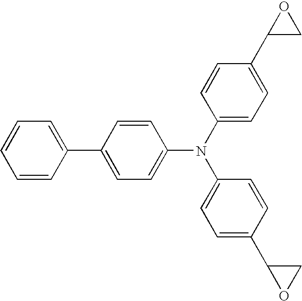 |
| III-20 | 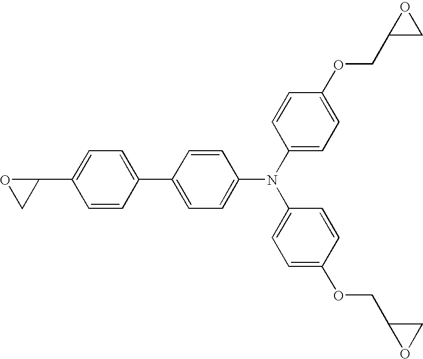 |
| III-21 | 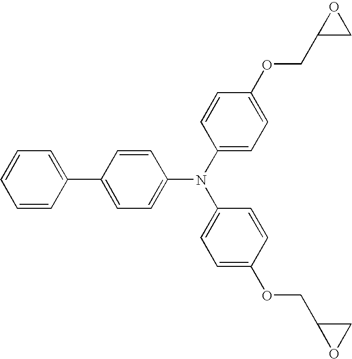 |
| III-22 | 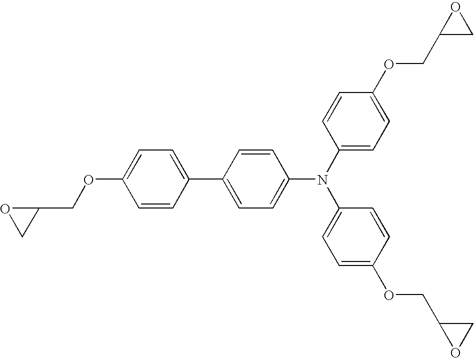 |
| III-23 | 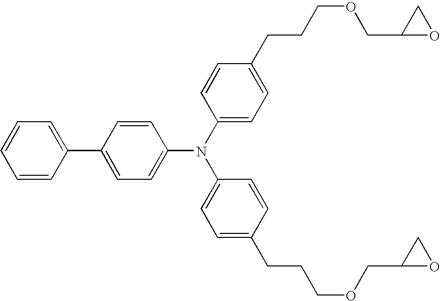 |
| III-24 | 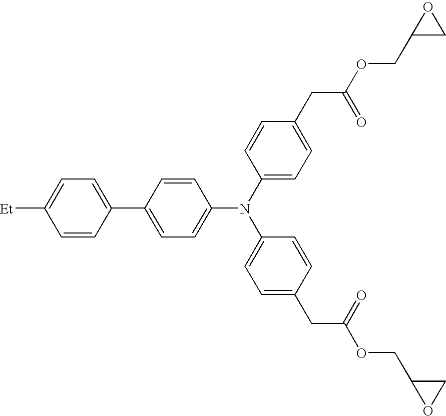 |
| III-25 | 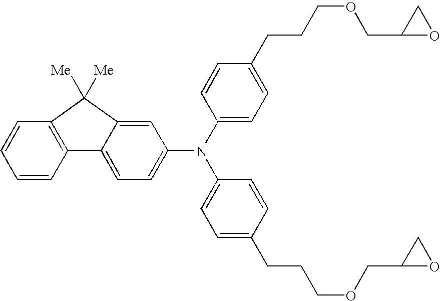 |
| III-26 | 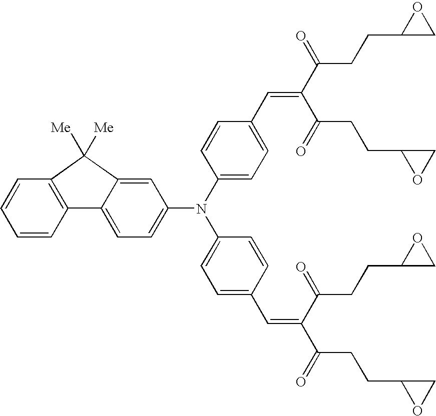 |
| III-27 | 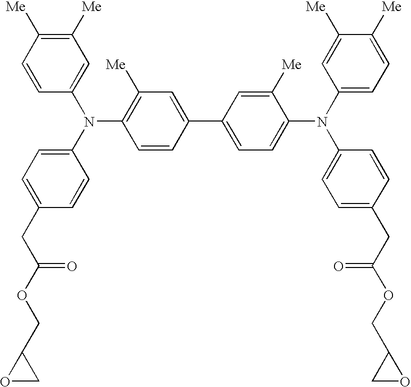 |
| III-28 | 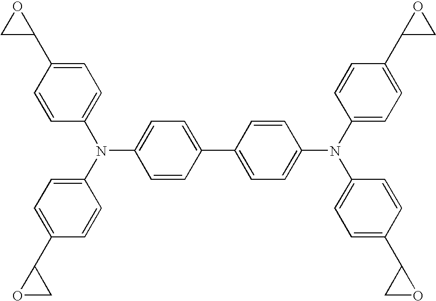 |
| III-29 | 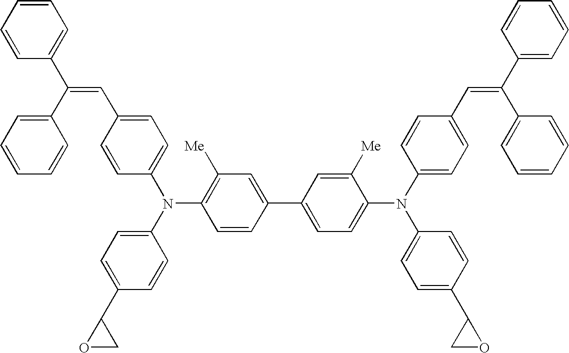 |
| III-30 | 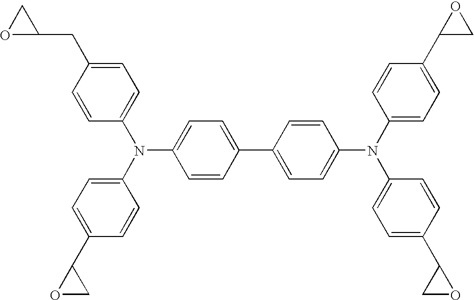 |
| III-31 | 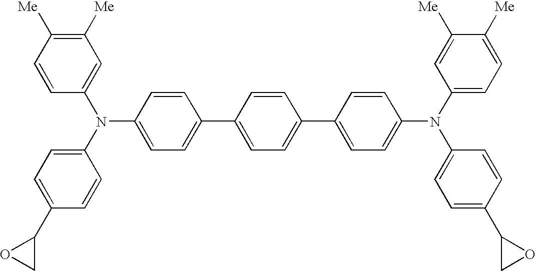 |
| III-32 | 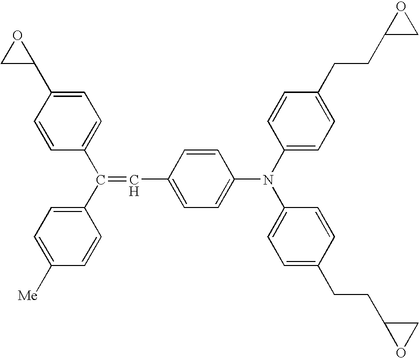 |
| III-33 | 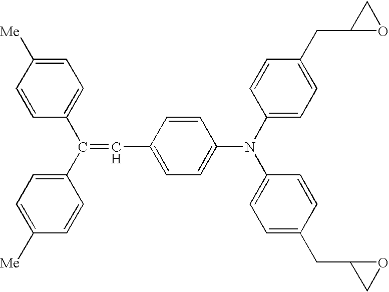 |
| III-34 | 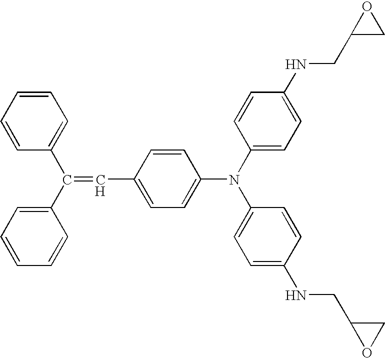 |
| III-35 | 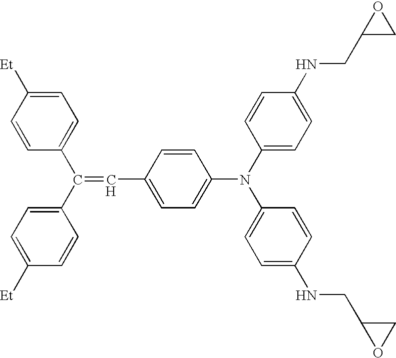 |
| III-36 | 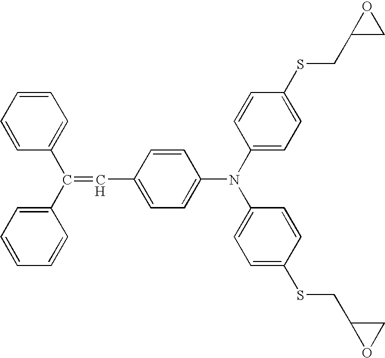 |
| III-37 | 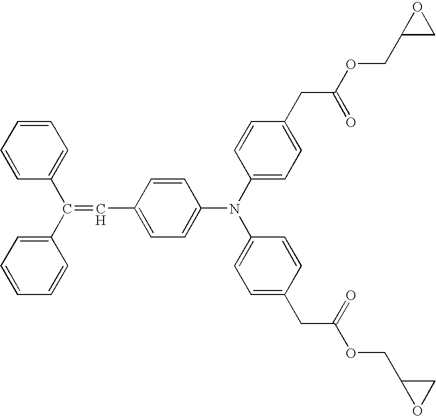 |
| III-38 | 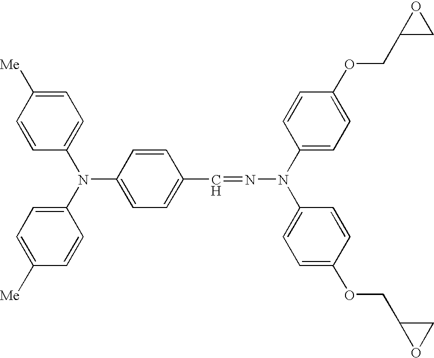 |
| III-39 | 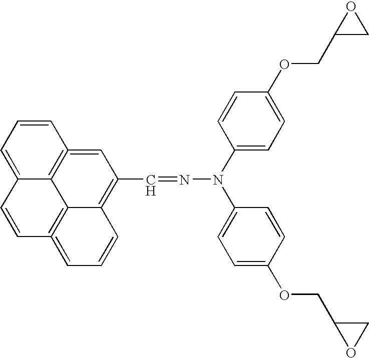 |
| III-40 | 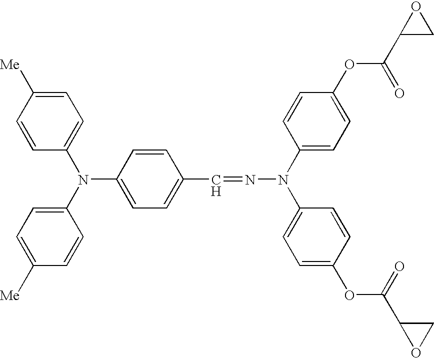 |
| III-41 | 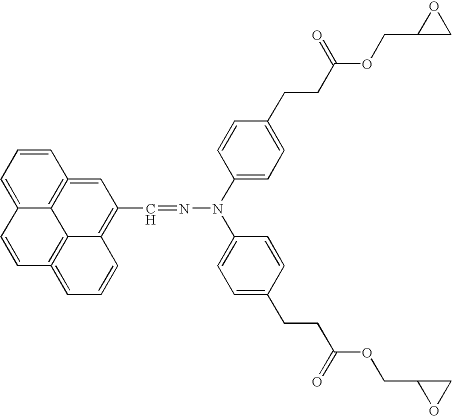 |
| III-42 | 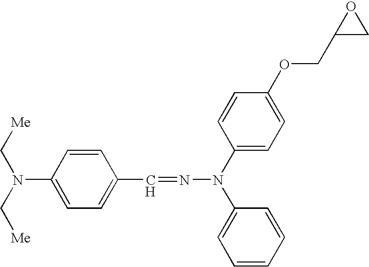 |
| III-43 | 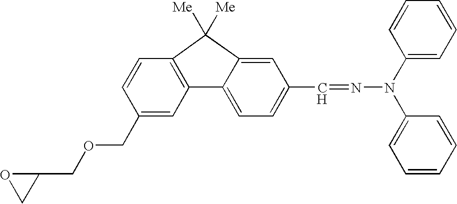 |
| III-44 | 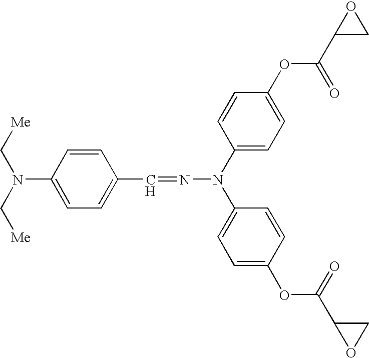 |
| III-45 | 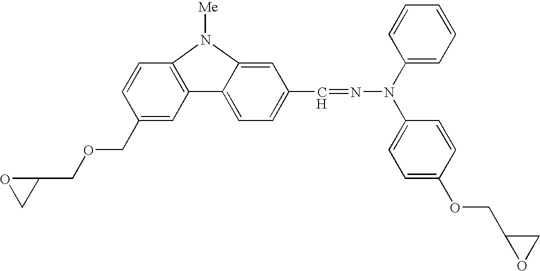 |
| III-46 | 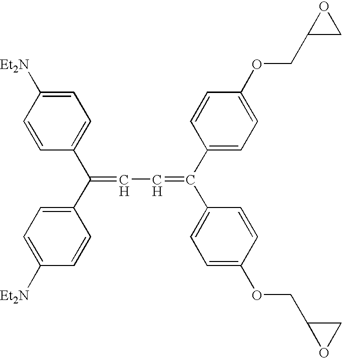 |
| III-47 | 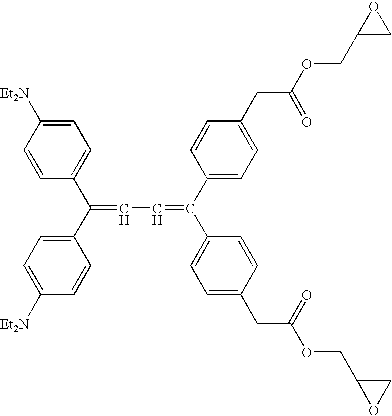 |

More specifically, examples of the compound represented by the above-described general formula (IV) include compounds (IV-1) to (IV40) below. Note that in the following tables, Me represents a methyl group, Et represents an ethyl group, and a terminal in which any substituted groups are not described has a methyl group.

| | | | |
|---|---|---|---|
| | IV-1 | | IV-2 |
| 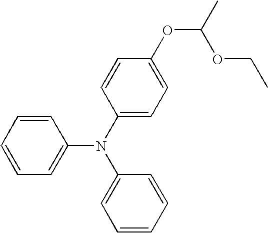 | | 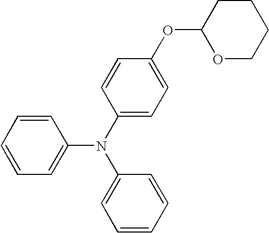 | |

| | |
|---|---|
| | IV-3 |
| 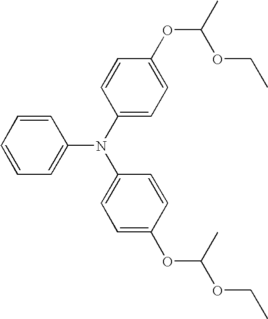 | |
| 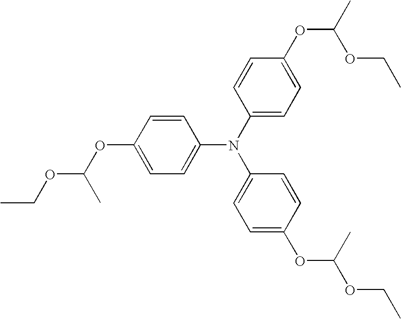 | IV-4 |
| 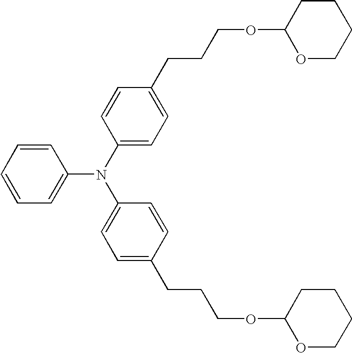 | IV-5 |

| | | | |
|---|---|---|---|
| | IV-6 | | IV-7 |
| 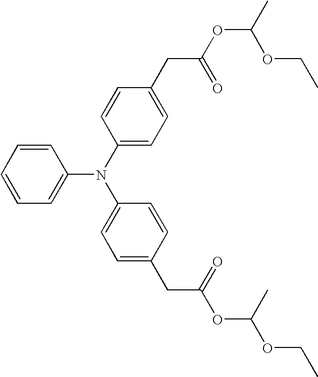 | | 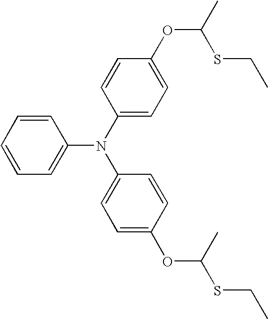 | |

| | |
|---|---|
| | IV-8 |
| 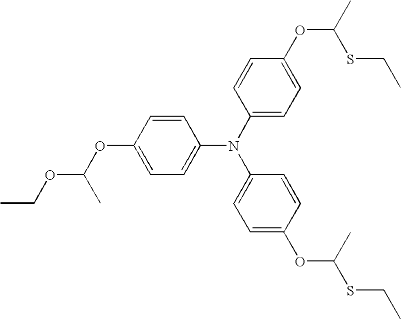 | |
| 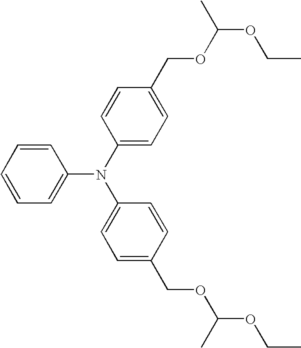 | IV-9 |
| 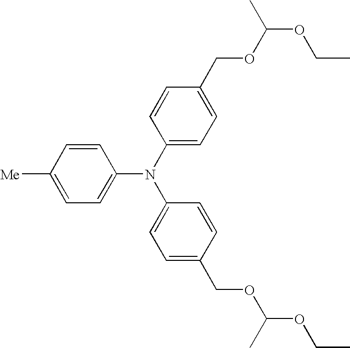 | IV-10 |
| 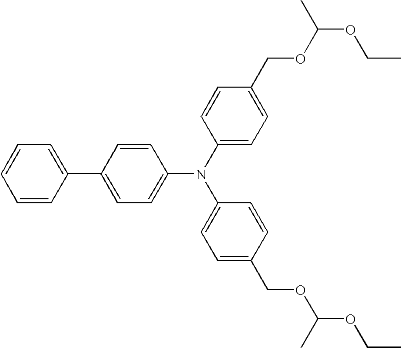 | IV-11 |
| 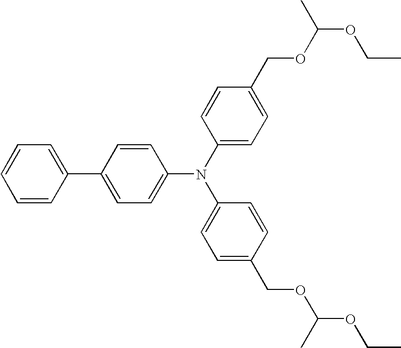 | IV-12 |
| 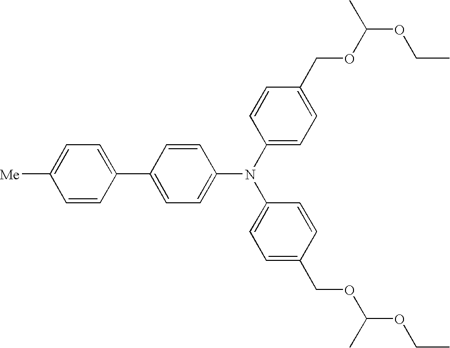 | IV-13 |
| 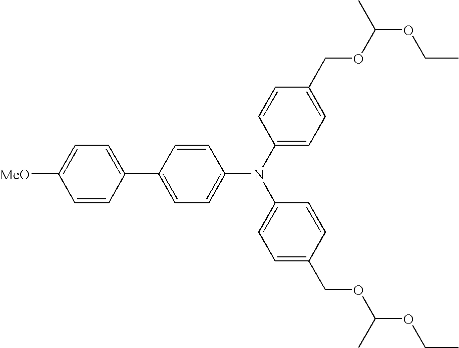 | IV-14 |
| 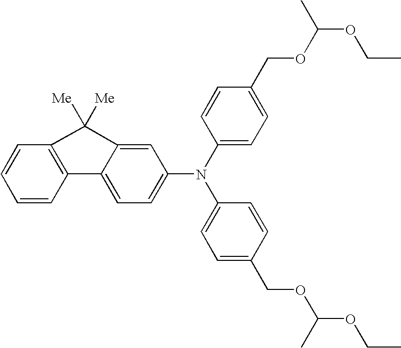 | IV-15 |
| 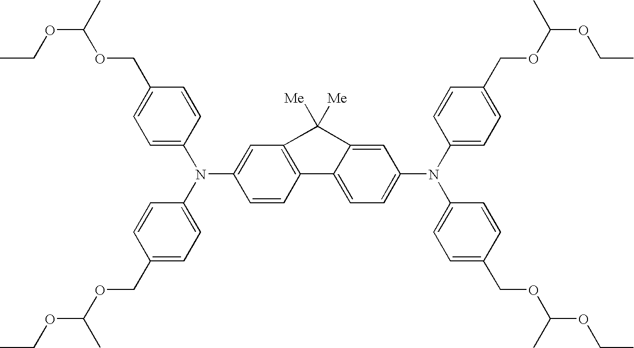 | IV-16 |
| 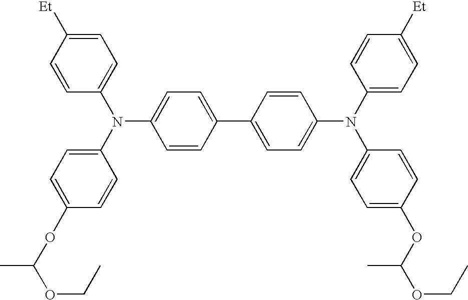 | IV-17 |
| 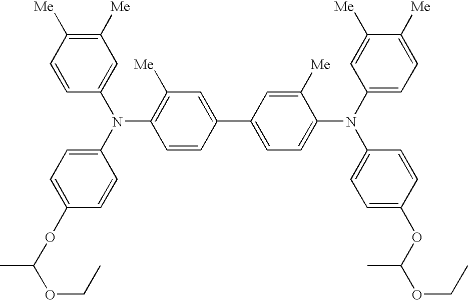 | IV-18 |
| 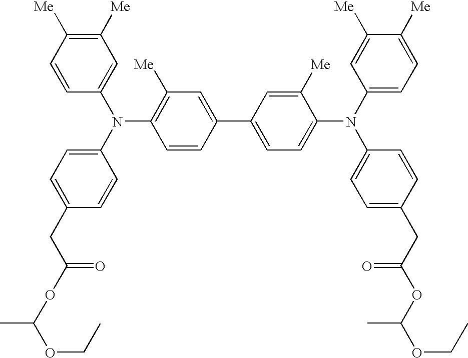 | IV-19 |
| 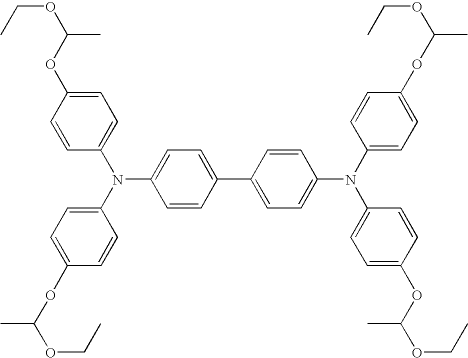 | IV-20 |
| 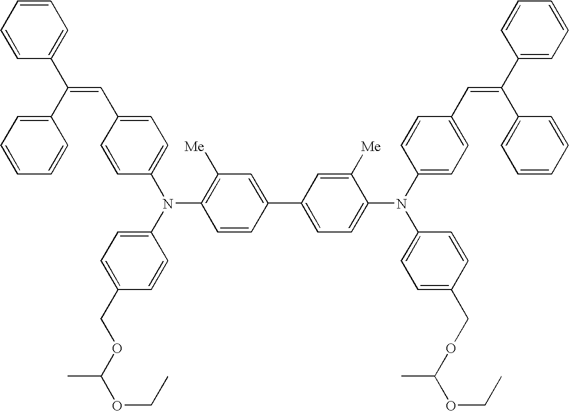 | IV-21 |
| 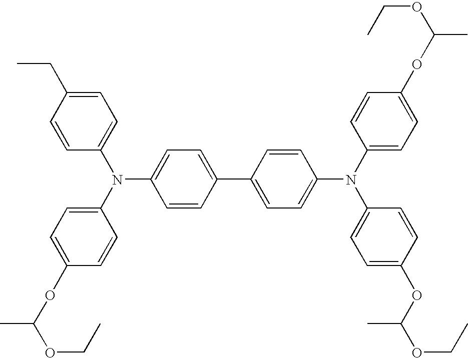 | IV-22 |
| 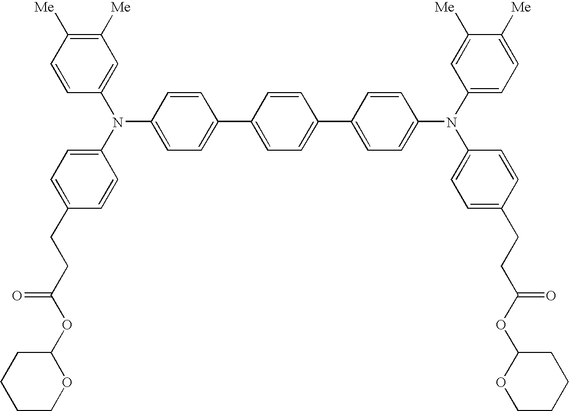 | IV-23 |
| 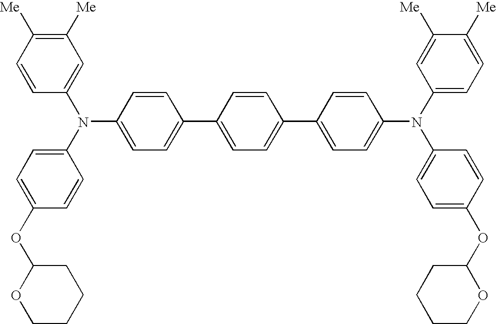 | IV-24 |
| 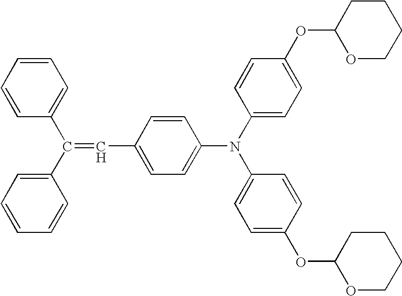 | IV-25 |
| 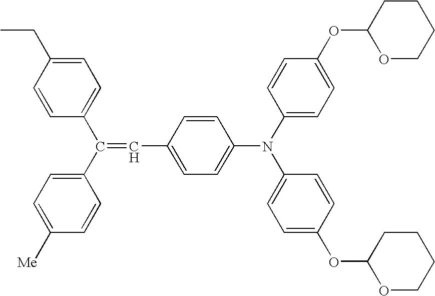 | IV-26 |
| 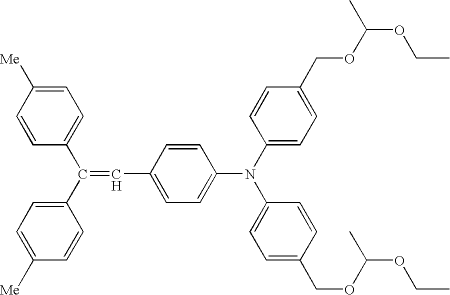 | IV-27 |
| 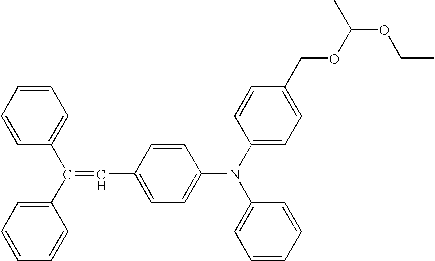 | IV-28 |
| 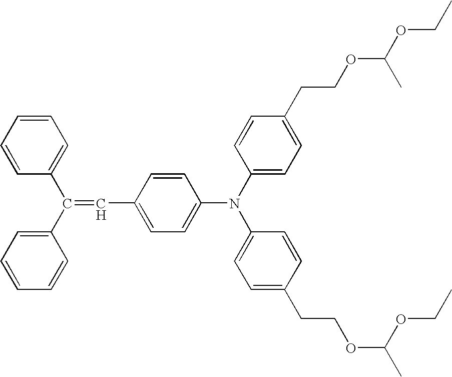 | IV-29 |
| 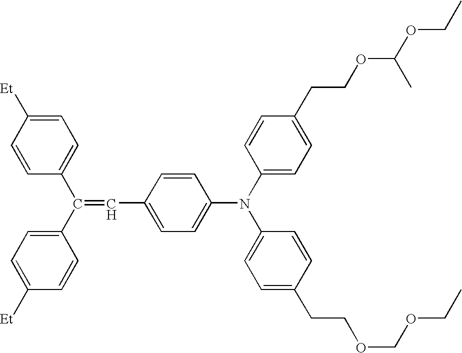 | IV-30 |
| 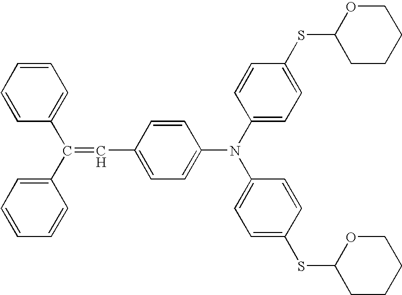 | IV-31 |
| 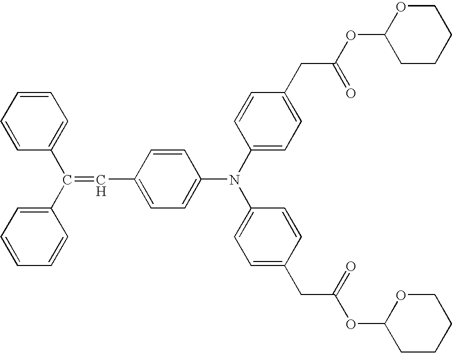 | IV-32 |
| 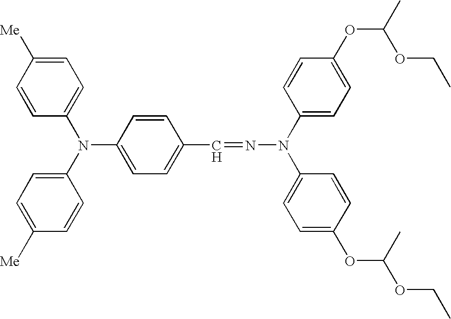 | IV-33 |
| 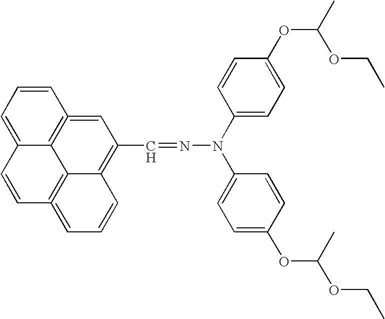 | IV-34 |
| 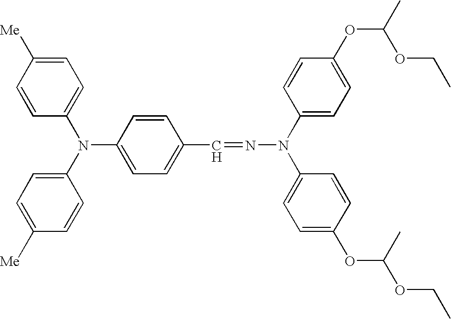 | IV-35 |
| 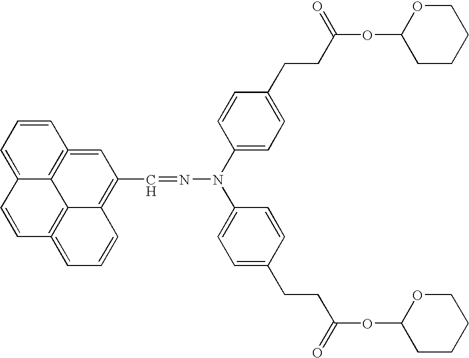 | IV-36 |
| 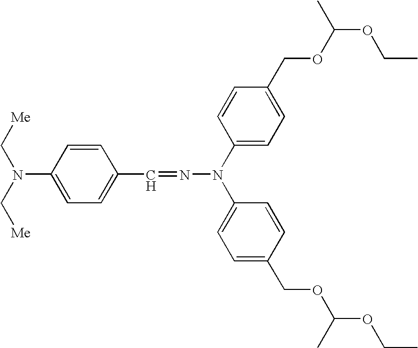 | IV-37 |
| 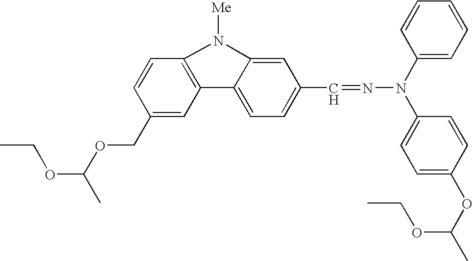 | IV-38 |
| 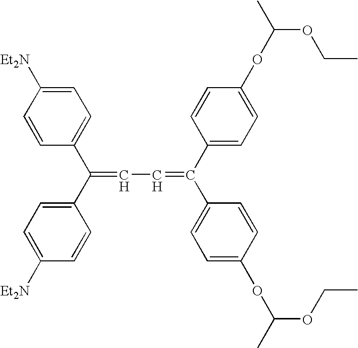 | IV-39 |
| 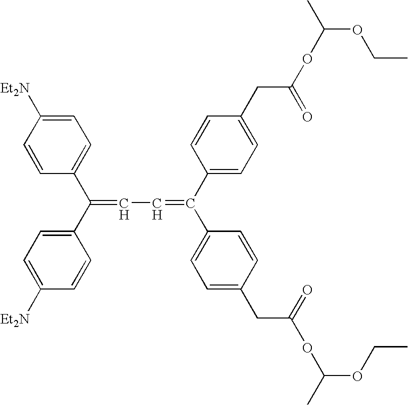 | IV-40 |

More specifically, examples of the compound represented by the above-described general formula (V) include compounds (V-1) to (V-55) below. Note that in the following tables, a terminal in which any substituted groups are not described has a methyl group.

| | | | |
|---|---|---|---|
| | (V-1) | | (V-2) |
| 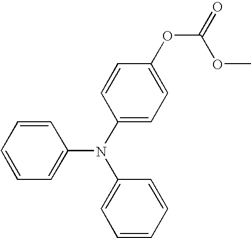 | | 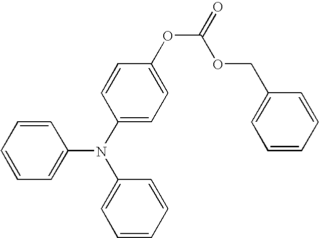 | |

| | | | |
|---|---|---|---|
| | (V-3) | | (V-4) |
| 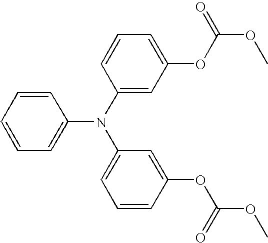 | | 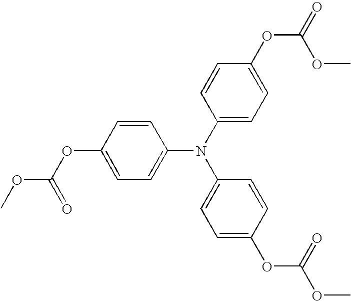 | |

| | | | |
|---|---|---|---|
| | (V-5) | | (V-6) |
| 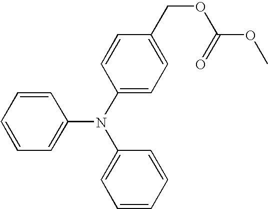 | | 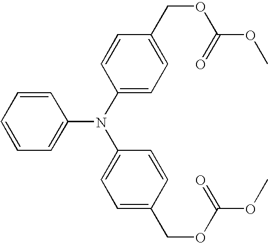 | |

| | | | |
|---|---|---|---|
| | (V-7) | | (V-8) |
| 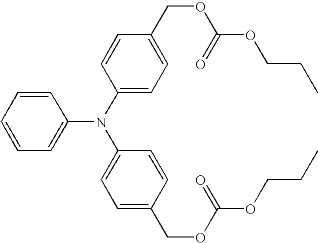 | | 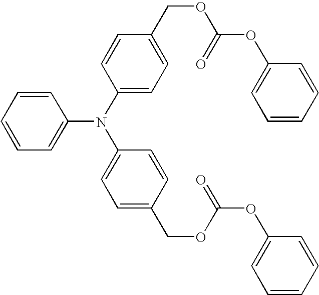 | |

| | |
|---|---|
| | (V-9) |
| 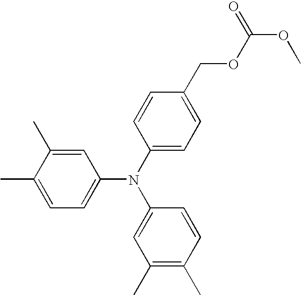 | |

| | |
|---|---|
| | (V-10) |
| 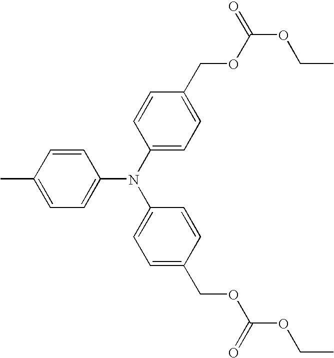 | |
| 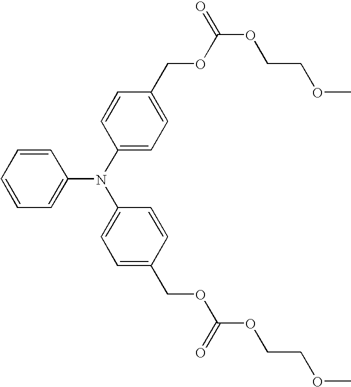 | (V-11) |
| 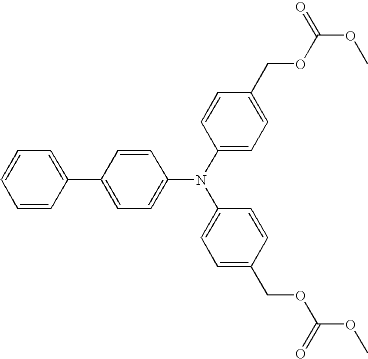 | (V-12) |
| 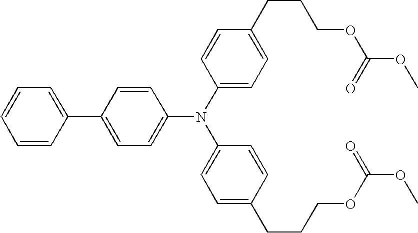 | (V-13) |
| 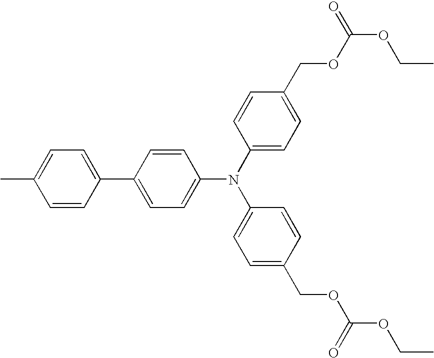 | (V-14) |
| 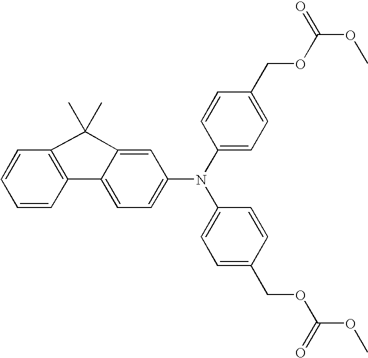 | (V-15) |
| 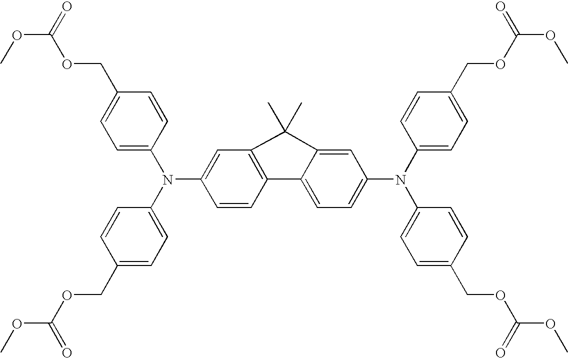 | (V-16) |
| 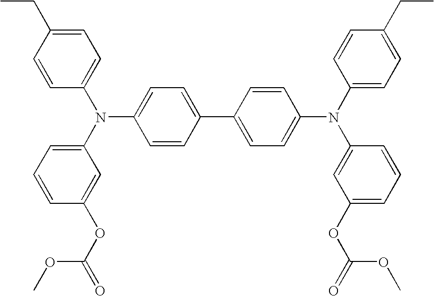 | (V-17) |
| 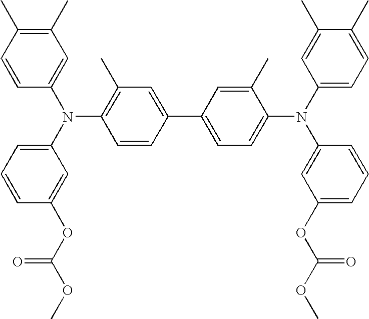 | (V-18) |
| 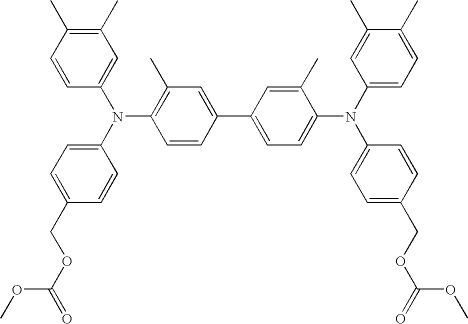 | (V-19) |
| 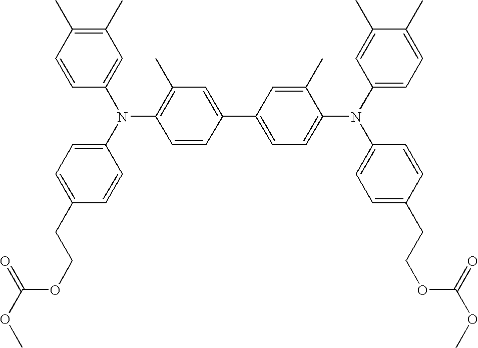 | (V-20) |
| 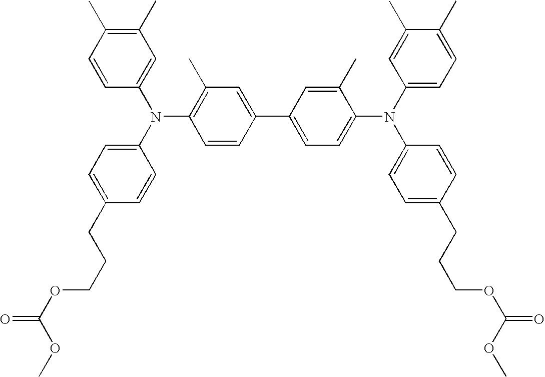 | (V-21) |
| 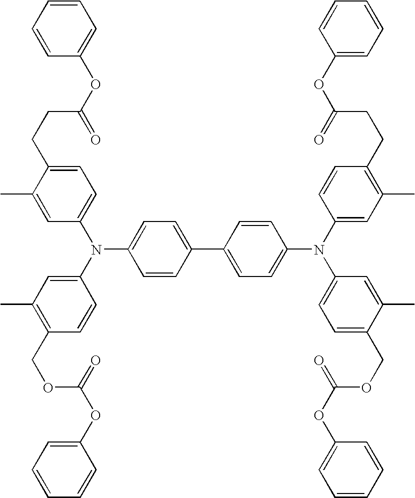 | (V-22) |
| 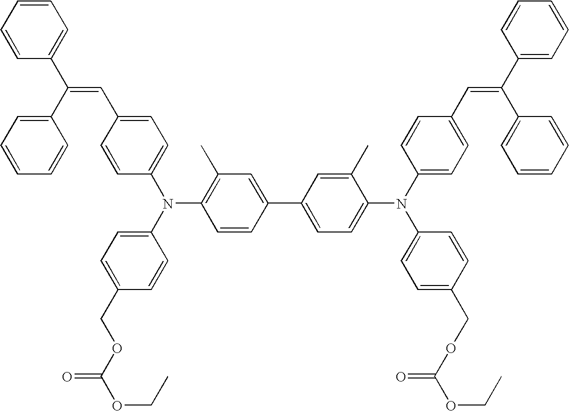 | (V-23) |
| 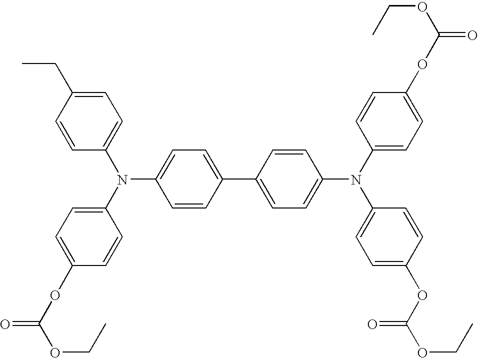 | (V-24) |
| 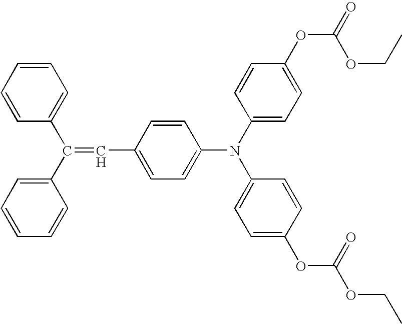 | (V-25) |
| 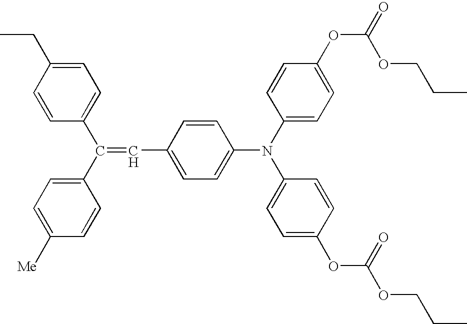 | (V-26) |
| 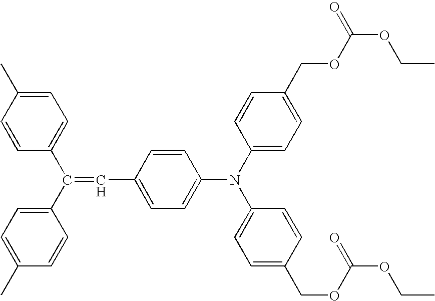 | (V-27) |
| 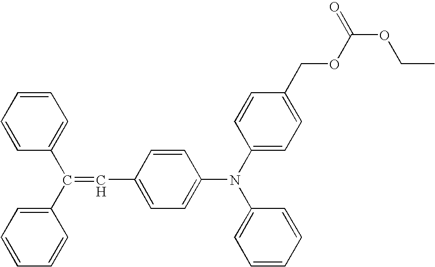 | (V-28) |
| 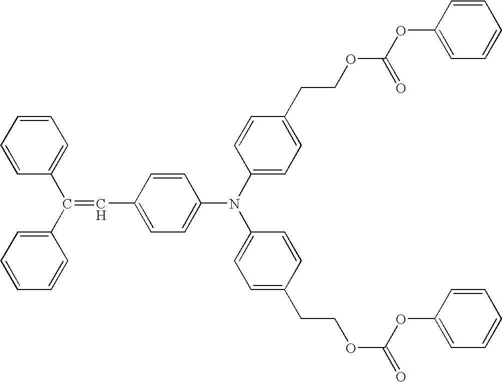 | (V-29) |
| 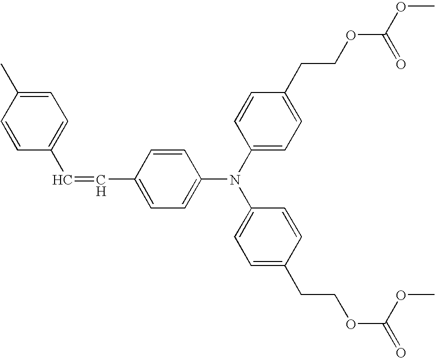 | (V-30) |
| 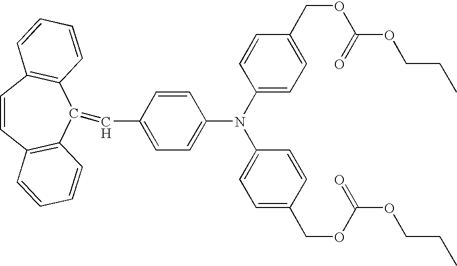 | (V-31) |
| 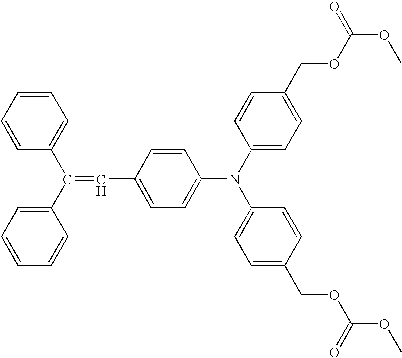 | (V-32) |
| 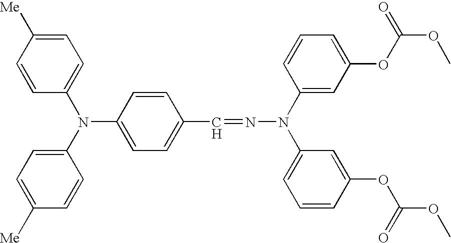 | (V-33) |
| 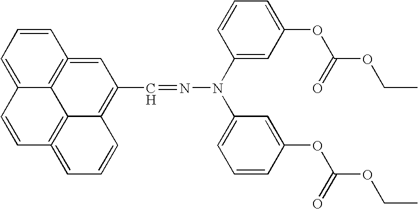 | (V-34) |
| 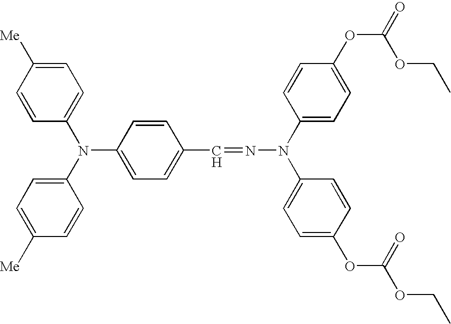 | (V-35) |
| 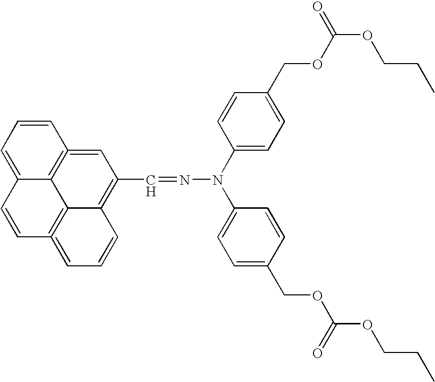 | (V-36) |
| 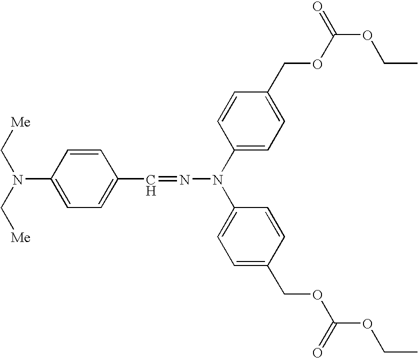 | (V-37) |
| 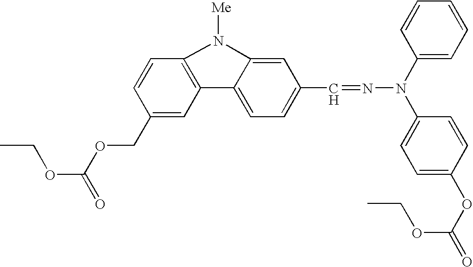 | (V-38) |
| 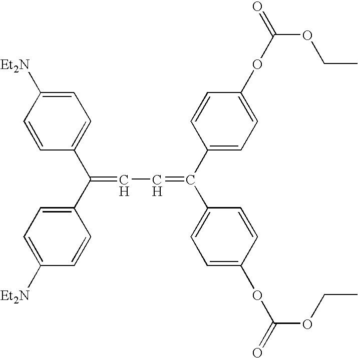 | (V-39) |
| 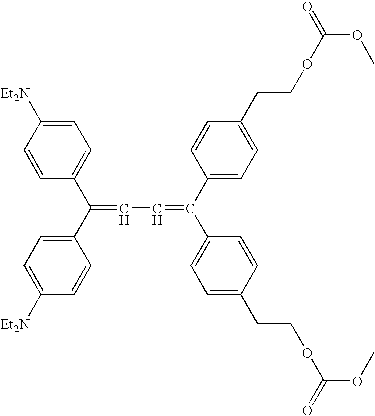 | (V-40) |
| 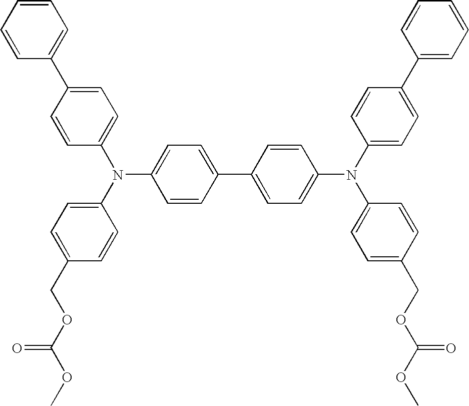 | (V-41) |
| 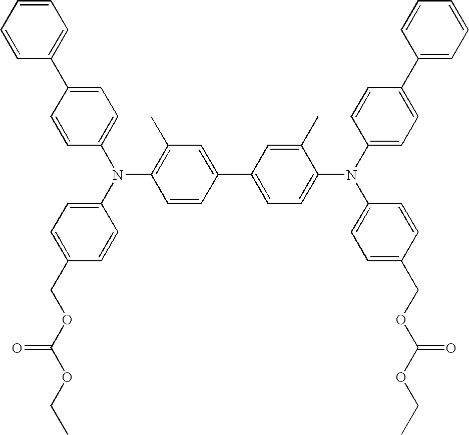 | (V-42) |
| 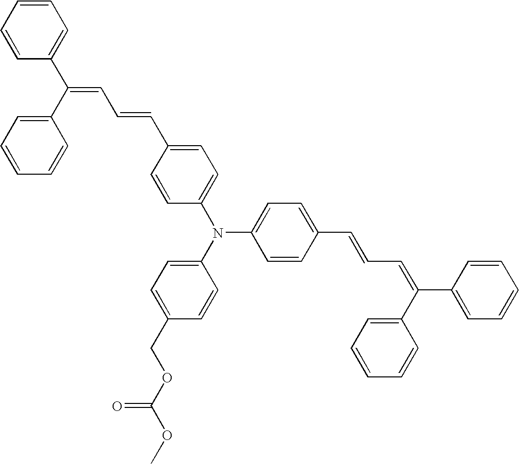 | (V-43) |
| 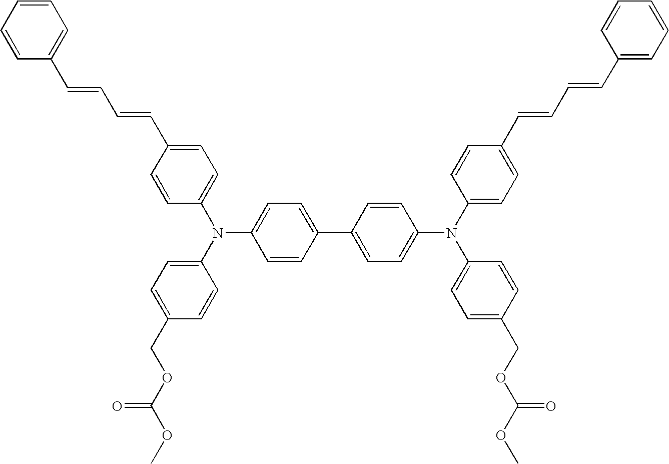 | (V-44) |
| 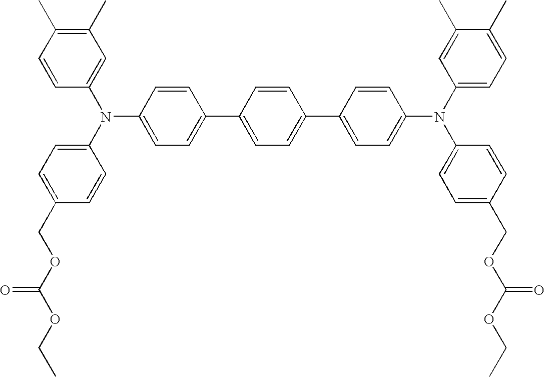 | (V-45) |
| 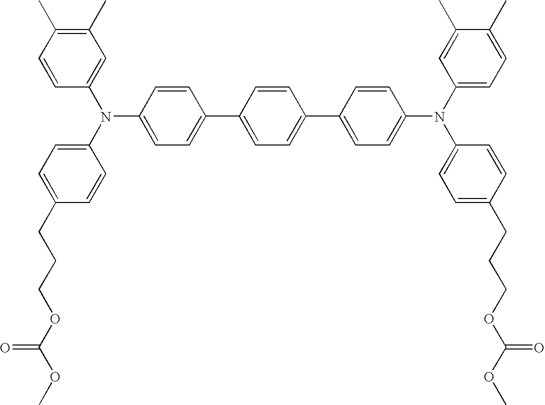 | (V-46) |
| 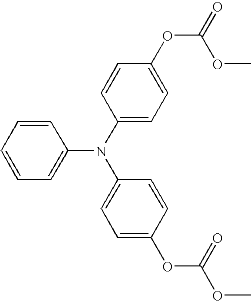 | (V-47) |
| 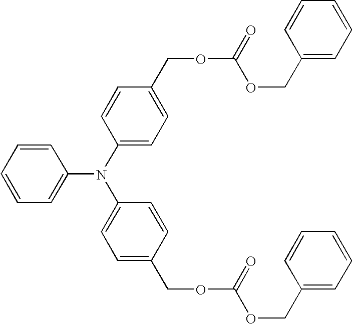 | (V-48) |
| 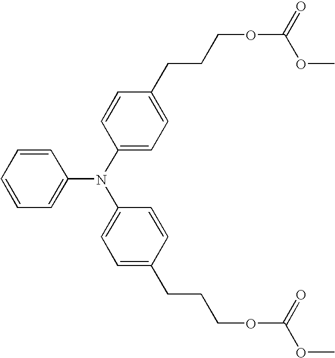 | (V-49) |
| 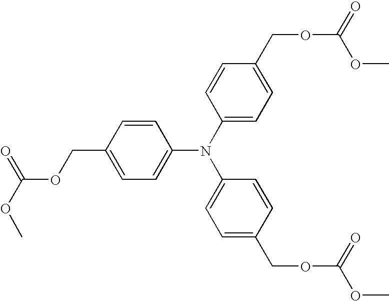 | (V-50) |
| 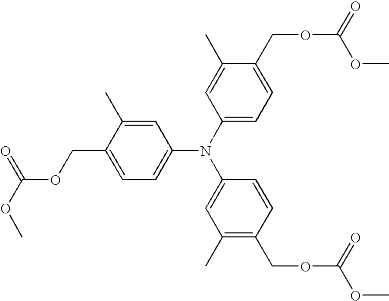 | (V-51) |

| | | | |
|---|---|---|---|
| | (V-52) | | (V-53) |
| 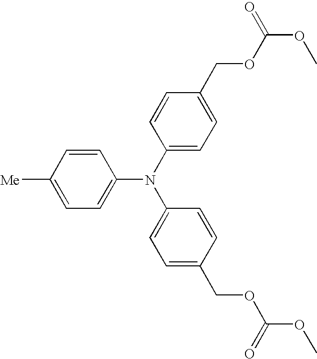 | | 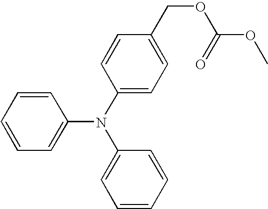 | |

| | |
|---|---|
| | (V-54) |
| 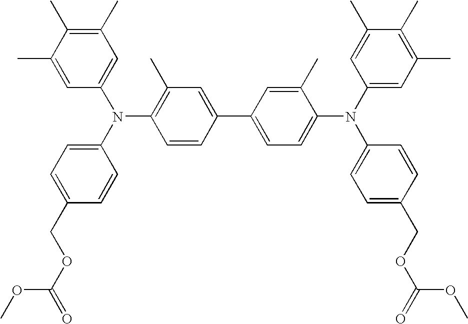 | |
| 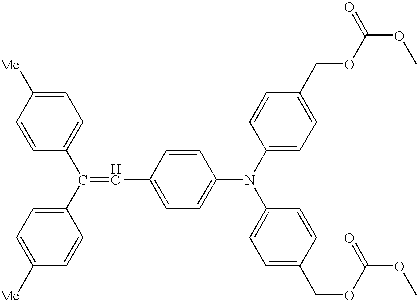 | (V-55) |

Also, in order to control various physical properties of the protection layer 7 (e.g., strength, film resistance, etc.), the curable resin composition for forming the protection layer 7 may be added with a compound represented by the following general formula (XII).
Si(R⁵⁰)_{(4-c)}Q_{c} (XII)
(In the above-described formula (XII), R⁵⁰ denotes a hydrogen atom, an alkyl group, or a substituted or unsubstituted aryl group, Q denotes a hydrolyzable group, and c denotes an integer from 1 to 4.)

Specific examples of the compound represented by the above-described general formula (XII) include the following silane coupling agents. Examples of the silane coupling agent include tetrafunctional alkoxysilane (c=4), such as tetramethoxysilane, tetraethoxysilane, and the like; trifunctional alkoxysilane (c=3), such as methyltrimethoxysilane, methyltriethoxysilane, ethyltrimethoxysilane, methyltrimethoxyethoxysilane, vinyltrimethoxysilane, vinyltriethoxysilane, phenyltrimethoxysilane, γ-glycidoxypropylmethyldiethoxysilane, γ-glycidoxypropyltrimethoxysilane, γ-glycidoxypropyltrimethoxysilane, γ-aminopropyltriethoxysilane, γ-aminopropyltrimethoxysilane, γ-aminopropylmethyldimethoxysilane, N-β(aminoethyl)γ-aminopropyltriethoxysilane, (tridecafluoro-1,1,2,2-tetrahydrooctyl)triethoxysilane, (3,3,3 -trifluoropropyl)trimethoxysilane, 3-(heptafluoroisopropoxy)propyltriethoxysilane, 1H, 1H,2H,2H-perfluoroalkyltriethoxysilane, 1H, 1H,2H,2H-perfluorodecyltriethoxysilane, 1H, 1H,2H,2H-perfluorooctylethoxysilane, and the like; bifunctional alkoxysilane (c=2), such as dimethyldimethoxysilane, diphenyldimethoxysilane, methylphenyldimethoxysilane, and the like; monofunctional alkoxy silane (c=1), such as trimethylmethoxysilane, and the like; and the like. The trifunctional and tetrafunctional alkoxysilanes are preferable for enhancing the film strength, and the monofunctional and bifuncitonal alkoxysilanes are preferable for enhancing the flexibility and film formation ability.

Also, silicon-based hard coating agents created mainly from the above-described coupling agents can be used. Examples of commercially available hard coating agents include KP-85, X-40-9740 and X-40-2239 (all of these are manufactured by Shin-Etsu Silicones), and AY42-440, AY42-441 and AY49-208 (all of these are manufactured by Dow Corning Toray Co., Ltd.), and the like.

Also, as the curable resin composition for forming the protection layer 7, compounds having two or more silicon atoms as represented by the following general formula (XIII) are preferably used so as to enhance the strength of the protection layer 7.
B—(Si(R⁵¹)_{(3-d)}Q_{d})₂ (XIII)
(In the above-described formula (XIII), B denotes a bivalent organic group, R⁵¹ denotes a hydrogen atom, an alkyl group, or a substituted or unsubstituted aryl group, Q denotes a hydrolyzable group, and d denotes an integer from 1 to 3.)

More specifically, preferable examples of the compound represented by the above-described general formula (XIII) include the following compounds (XIII-1) to (XIII-16).

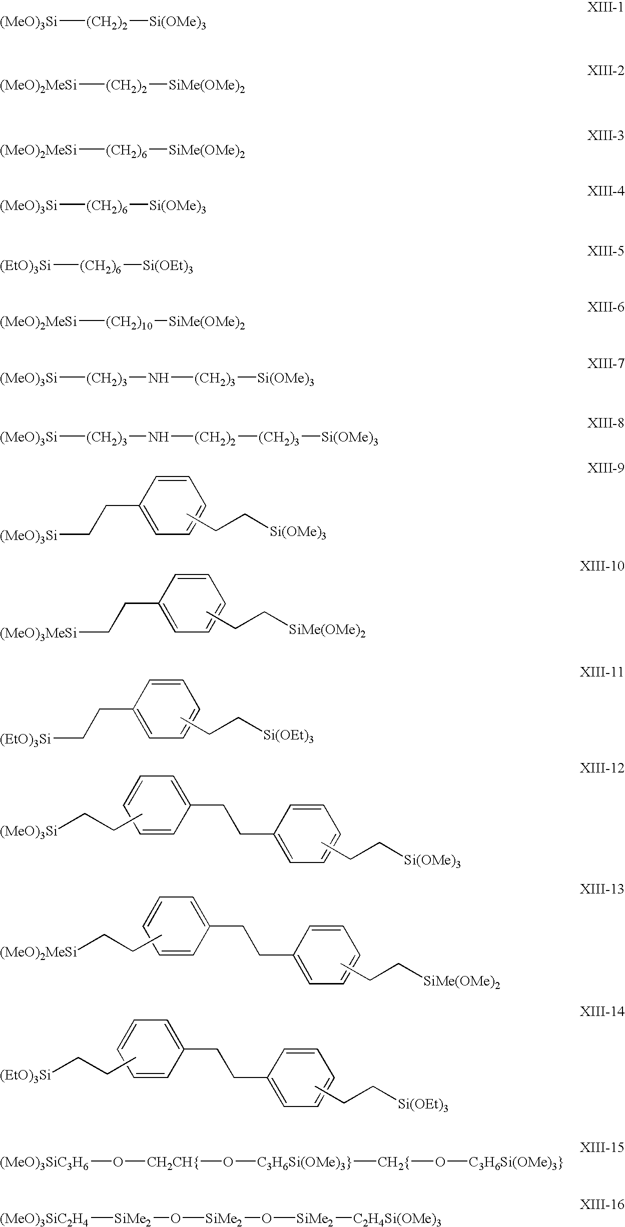

Further, in order to control film characteristics, extending liquid life, and the like, a resin soluble in alcohol or ketone solvents may be added. Examples of such a resin include polyvinyl butyral resin, polyvinyl formal resin, polyvinyl acetal resin (e.g., partially acetalized polyvinyl acetal resin having butyral partially denatured with formal, acetoacetal, or the like (e.g., S-LEC B or K manufactured by Sekisui Chemical Co., Ltd., etc.)), polyamide resin, cellulose resin, phenolic resin, and the like. From the viewpoint of enhancing electrical characteristics, polyvinyl acetal resin is particularly preferable.

Also, various resins can be added for the purposes of attaining discharge gas resistance, mechanical strength, scratch resistance, particle dispersibility, viscosity control, torque reduction, abrasion control, pot life extension, and the like. In the present embodiment, it is preferable to further add a resin soluble in alcohol. Examples of the resin soluble in alcohol solvents include polyvinyl acetal resins, such as polyvinyl butyral resin, polyvinyl formal resin, partially acetalized polyvinyl acetal resin having butyral partially denatured with formal, acetacetal, or the like, and the like (e.g., S-LEC B or K manufactured by Sekisui Chemical Co., Ltd., etc.), polyamide resin, cellulose resin, and the like. From the viewpoint of electrical characteristics, polyvinyl acetal resins are particularly preferred.

The average molecular weight of the above-described resin is preferably 2,000 to 100,000, more preferably 5,000 to 50,000. When the average molecular weight is less than 2,000, a desired effect is likely to be difficult to obtain, and when the average molecular weight exceeds 100,000, solubility is likely to be reduced, leading to limitation on the added amount or a defective film when applied. The added amount is preferably 1 to 40% by weight, more preferably 1 to 30% by weight, and most preferably 5 to 20% by weight. When the added amount is less than 1% by weight, a desired effect is likely to be difficult to obtain, and when the amount of addition exceeds 40% by weight, image blurring can readily occur at high temperature and humidity. Also, the above-described resins may be used singly or in combination of two or more.

Also, a cyclic compound having a repeating structural unit represented by general formula (XIV) below or a derivative thereof is preferably contained so as to extend pot life or control film characteristics. 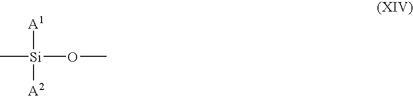
(In the above-described formula (XIV), A¹ and A² each individually denotes a monovalent organic group.)

Examples of the cyclic compound having a repeating structural unit represented by general formula (XIV) include commercially available cyclic siloxanes. Specifically, examples of the commercially available cyclic siloxanes include: cyclic dimethylcyclosiloxanes, such as hexamethylcyclotrisiloxane, octamethylcyclotetrasiloxane, decamethylcyclopentasiloxane, dodecamethylcyclohexasiloxane, and the like; cyclic methylphenylcyclosiloxanes, such as 1,3,5-trimethyl-1,3,5-triphenylcyclotrisiloxane, 1,3,5,7-tetramethyl-1,3,5,7-tetraphenylcyclotetrasiloxane, 1,3,5,7,9-pentamethyl-1,3,5,7,9-pentaphenylcyclopentasiloxane, and the like, cyclic phenylcyclosiloxanes, such as hexaphenylcyclotrisiloxane and the like; fluorine atom-containing cyclosiloxanes, such as 3-(3,3,3-trifluoropropyl)methylcyclotrisiloxane, and the like; hydrosilyl group-containing cyclosiloxanes, such as methylhydrosiloxane mixture, pentamethylcyclopentasiloxane, phenylhydrocyclosiloxane, and the like; vinyl group-containing cyclosiloxanes, such as pentavinylpentamethylcyclopentasiloxane, and the like; and the like. These cyclic siloxane compounds may be used singly or in combination of two or more.

Further, in order to control contaminant adhesion resistance, lubricity, hardness, or the like of the electrophotographic photoreceptor surface, various types of fine particles can be added to the curable resin composition for forming the protection layer 7.

One example of the fine particles is a silicon atom-containing fine particle. The silicon atom-containing fine particle contains silicon as a constituent element, and specific examples thereof include colloidal silica, silicone fine particle, and the like. Colloidal silica which is used as a silicon atom-containing fine particle is commercially available silica having a volume average particle diameter of preferably 1 to 100 nm, more preferably 10 to 30 nm, and is selected from those dispersed in an acidic or alkaline aqueous dispersion or an organic solvent, such as alcohol, ketone, ester, or the like. The solid colloidal silica content of the curable resin composition is not particularly limited, but from the viewpoint of film formation ability, electrical characteristics, and strength, the solid colloidal silica content is preferably in the range from 0.1 to 50% by weight, more preferably in the range from 0.1 to 30% by weight, with reference to the total solid content of the curable resin composition.

As the silicone fine particle which is used as the silicon atom-containing fine particle, a commercially available spherical silicone fine particle can be used which has a volume average particle diameter of preferably 1 to 500 nm, more preferably 10 to 100 nm, and is selected from a silicone resin particle, a silicone rubber particle, and a silicone surface-treated silica particle.

The silicone fine particle is a chemically inactive small-diameter fine particle having superior dispersibility in resin, and needs to be contained in a small amount to obtain sufficient characteristics, and therefore, a state of the electrophotographic photoreceptor surface can be improved without inhibiting a crosslinking reaction. In other words, while the silicone fine particle is uniformly taken in a firmly crosslinked structure, lubricity, and water repellency of the electrophotographic photoreceptor surface can be enhanced, thereby making it possible to maintain satisfactory abrasion resistance and contaminant adhesion resistance over a long period of time. The silicone fine particle content of the curable resin composition is preferably in the range from 0.1 to 30% by weight, and more preferably from 0.5 to 10% by weight, based on the total solid content of the curable resin composition.

Examples of other particles include: fluorine-based fine particles, such as ethylene tetrafluoride, ethylene trifluoride, propylene hexafluoride, vinyl fluoride, vinylidene fluoride, and the like; a fine particle composed of a resin obtained by copolymerizing a fluorine resin and a monomer having a hydroxyl group as disclosed in “Proceedings of the 8th Polymer Material Forum”, p. 89; and semiconductor metal oxides, such as ZnO—Al₂O₃, SnO₂—Sb₂O₃, In₂O₃—SnO₂, ZnO—TiO₂, MgO—Al₂O₃, FeO—TiO₂, TiO₂, SnO₂, In₂O₃, ZnO, MgO, and the like.

Note that, as the fine particle, a conductive fine particle, such as metal, metal oxide, carbon black, or the like is preferably added to the curable resin composition for forming the protection layer 7. Examples of the metal include aluminum, zinc, copper, chromium, nickel, silver, stainless steel, and the like, these metals deposited on the surface of a plastic fine particle, and the like. Examples of the metal oxide include zinc oxide, titanium oxide, tin oxide, antimony oxide, indium oxide, bismuth oxide, indium oxide doped with tin, tin oxide doped with antimony or tantalum, zirconium oxide doped with antimony, and the like. These can be used singly or in combination of two or more. In the case of using them in combination of two or more, they may be simply mixed together or used in the form of solid solution or fusion.

From the viewpoint of translucency of the protection layer 7, the volume average particle diameter of the conductive fine particle is preferably 0.3 μm or less, more preferably 0.1 μm or less. Also, among the above-described conductive fine particles, the metal oxides are particularly preferable in terms of translucency. Also, in order to control dispersibility, it is preferable to surface-treat the fine particle. Examples of a treatment agent include a silane coupling agent, silicone oil, a siloxane compound, a surfactant, and the like. These treatment agents preferably contain a fluorine atom.

By adding the conductive fine particle as described above, it is possible to enhance the charge transporting ability of the protection layer 7, thereby improving electrical characteristics.

Also, in order to control contaminant adhesion resistance, lubricity, hardness, or the like of the electrophotographic photoreceptor surface, oil, such as silicone oil or the like, can be added. Examples of the silicone oil include: silicone oils, such as dimethylpolysiloxane, diphenylpolysiloxane, phenylmethylsiloxane, and the like; reactive silicone oils, such as amino-denatured polysiloxane, epoxy-denatured polysiloxane, carboxyl-denatured polysiloxane, carbinol-denatured polysiloxane, methacryl-denatured polysiloxane, mercapto-denatured polysiloxane, phenol-denatured polysiloxane, and the like; and the like. These may be previously added to the curable resin composition for forming the protection layer 7, or may be subjected to an impregnation treatment under reduced pressure or under pressure after the photoreceptor is produced.

Also, the curable resin composition for forming the protection layer 7 can contain an additive, such as a plasticizer, a surface modifier, an antioxidant, an anti-phtodegradation agent, or the like. Examples of the plasticizer include biphenyl, biphenyl chloride, terphenyl, dibutylphthalate, diethylene glycol phthalate, dioctyl phthalate, triphenylphosphate, methylnaphthalene, benzophenone, chlorinated paraffin, polypropylene, polystyrene, various fluorocarbon hydrogens, and the like.

The curable resin composition for forming the protection layer 7 may be added with an antioxidant having a hindered phenol, hindered amine, thioether or phosphite partial structure, which is effective in enhancing potential stability and image quality when the environment varies.

Examples of the antioxidant include the following compounds: hindered phenols, such as “SUMILIZER BHT-R”, “SUMILIZER MDP-S”, “SUMILIZER BBM-S”, “SUMILIZER WX-R”, “SUMILIZER NW”, “SUMILIZER BP-76”, “SUMILIZER BP-101”, “SUMILIZER GA-80”, “SUMILIZER GM”, and “SUMILIZER GS” (all of these are manufactured by Sumitomo Chemical Co., Ltd.); “IRGANOX 1010”, “IRGANOX 1035”, “IRGANOX 1076”, “IRGANOX 1098”, “IRGANOX 1135”, “IRGANOX 1141”, “IRGANOX 1222”, “IRGANOX 1330”, “IRGANOX 1425 WL”, “IRGANOX 1520 L”, “IRGANOX 245”, “IRGANOX 259”, “IRGANOX 3114”, “IRGANOX 3790”, “IRGANOX 5057”, and “IRGANOX 565” (all of these are manufactured by Ciba Specialty Chemicals), and “ADKSTAB AO-20”, “ADKSTAB AO-30”, “ADKSTAB AO-40”, “ADKSTAB AO-50”, “ADKSTAB AO-60”, “ADKSTAB AO-70”, “ADKSTAB AO-80”, and “ADKSTAB AO-330” (all of these are manufactured by Asahi Denka Co., Ltd.); hindered amines, such as “SANOL LS2626”, “SANOL LS765”, “SANOL LS770”, and “SANOL LS744” (all of these are manufactured by Sankyo Lifetech Co., Ltd.), “TINUVIN 144” and “TINUVIN 622LD” (all of these are manufactured by Ciba Specialty Chemicals), “MARK LA57”, “MARK LA67”, “MARK LA62”, “MARK LA68”, and “MARK LA63” (all of these are manufactured by Asahi Denka Co., Ltd.), and “SUMILIZER TPS” (manufactured by Sumitomo Chemical Co., Ltd.); thioethers, such as “SUMILIZER TP-D” (manufactured by Sumitomo Chemical Co., Ltd.); phosphates, such as “MARK 2112”, “MARK PEP8”, “MARK PEP24G”, “MARK PEP36”, “MARK 329K”, and “MARK HP10” (all of these are manufactured by Asahi Denka Co., Ltd.). Hindered phenols and hindered amine antioxidants are particularly preferable. Further, these may be denatured with a substituted group, such as, for example, an alkoxysilyl group, which is crosslinkable with a material which forms a crosslinked film.

Also, the curable resin composition for forming the protection layer 7 may contain an insulating resin, such as polyvinyl butyral resin, polyarylate resin (e.g., a polycondensate of bisphenol A and phthalic acid, etc.), polycarbonate resin, polyester resin, phenoxy resin, vinyl chloride-vinyl acetate copolymer, polyamide resin, acrylic resin, polyacrylamide resin, polyvinylpyridine resin, cellulose resin, urethane resin, epoxy resin, casein, polyvinyl alcohol resin, polyvinyl pyrrolidone resin, or the like. In this case, the insulating resin may be added at a desired proportion, thereby making it possible to suppress the adhesion ability with the charge transport layer 6, a coating defect due to thermal contraction or a pinhole, and the like.

Also, a catalyst can be added to the curable resin composition for forming the protection layer 7 or during preparation thereof. Examples of the catalyst include: inorganic acids, such as hydrochloric acid, acetic acid, sulfuric acid, and the like; organic acids, such as phosphoric acid, propionic acid, oxalic acid, benzoic acid, phthalic acid, maleic acid, and the like; alkali catalysts, such as potassium hydroxide, sodium hydroxide, calcium hydroxide, ammonia, triethylamine, and the like; and solid catalysts insoluble in a system as described below.

Examples of the solid catalysts insoluble in a system include: cation exchange resins, such as AMBERLITE 15, AMBERLITE 200C, and AMBERLYST 15E (all of these are manufactured by Rohm & Haas Co.), DOWEX MWC-1-H, DOWEX 88, and DOWEX HCR-W2 (all of these are manufactured by Dow Chemical Co.), LEWATIT SPC-108 and LEWATIT SPC-118 (all of these are manufactured by Bayer), DLAION RCP-150H (manufactured by Mitsubishi Chemical Co.), SUMIKA ION KC-470, DOULITE C26-C, DOULITE C-433, and DOULITE-464 (all of these are manufactured by Sumitomo Chemical Co., Ltd.), NAFION-H (manufactured by DuPont), and the like; anion exchange resins, such as AMBERLITE IRA-400 and AMBERLITE IRA-45 (all of these are manufactured by Rohm & Haas Co.), and the like; inorganic solids having their surfaces to which a group containing a protonic acid group is bonded, such as Zr(O₃PCH₂CH₂SO₃H)₂, Th(O₃PCH₂CH₂COOH)₂, and the like; polyorganosiloxanes containing a protonic acid group, such as polyorganosiloxane having a sulfonic acid group and the like; heteropoly acids, such as cobalt tungstic acid, phosphomolybdic acid, and the like; isopoly acids, such as niobic acid, tantalic acid, molybdic acid, and the like; single-unit metal oxides, such as silica gel, alumina, chromia, zirconia, CaO, MgO, and the like; composite metal oxides, such as silica-alumina, silica-magnesia, silica-zirconia, zeolites, and the like; clay minerals, such as acid clay, activated clay, montmorillonite, kaolinite, and the like; metal sulfates, such as LiSO₄, MgSO₄, and the like; metal phosphates, such as zirconia phosphate, lanthanum phosphate, and the like; metal nitrates, such as LiNO₃, Mn(NO₃)₂, and the like; inorganic solids having their surfaces to which a group containing an amino group is bonded, such as a solid obtained by reacting aminopropyltriethoxysilane on silica gel, and the like; polyorganosiloxanes containing an amino group, such as amino-denatured silicone resin, and the like; and the like.

Also, it is preferable to prepare the curable resin composition by using a catalyst insoluble in a photo-functional compound, a reaction product, water, a solvent, or the like, because the stability of the coating liquid is likely to be enhanced. The solid catalyst insoluble in the system is not particularly limited so long as catalyst components are insoluble in compounds represented by the above-described general formulas (I) to (V), other additives, water, solvents, and the like.

The used amount of solid catalyst insoluble in system as described above is not particularly limited and is preferably 0.1 to 100 parts by weight with respect to a total of 100 parts by weight of a compound having a hydrolizable group. As described above, these solid catalysts are insoluble in a raw-material compound, a reaction product, a solvent, and the like, and therefore, can be readily removed by a commonly used technique after a reaction.

The reaction temperature and the reaction time are appropriately selected depending on the type and used amount of the raw-material compound or the solid catalyst. The reaction temperature is typically 0 to 100° C., preferably 10 to 70° C., and more preferably 15 to 50° C., and the reaction time is preferably 10 minutes to 100 hours. When the reaction time exceeds the above-described upper limit, gelation is likely to occur.

Also, in the case of using the catalyst insoluble in a system so as to prepare the curable resin composition, a catalyst soluble in the system is preferably used in combination therewith in order to enhance strength, liquid preservation stability, and the like. Examples of such a catalyst include, in addition to the foregoing, organic aluminum compounds, such as aluminum triethylate, aluminum triisopropylate, aluminum tri(sec-butyrate), mono(sec-butoxy)aluminum diisopropylate, diisopropoxyaluminum(ethylacetoacetate), aluminum tris(ethylacetoacetate), aluminum bis(ethylacetoacetate)monoacetylacetonate, aluminum tris(acetylacetonate), aluminum diisopropoxy(acetylacetonate), aluminum isopropoxy-bis(acetylacetonate), aluminum tris(trifluoro acetylacetonate), aluminum tris(hexafluoroacetylacetonate), and the like.

Also, in addition to the organic aluminum compounds, organic tin compounds, such as dibutyltin dilaurate, dibutyltin dioctylate, dibutyltin diacetate, and the like, organic titanium compounds, such as titanium tetrakis(acetylacetonate), titanium bis(butoxy)bis(acetylacetonate), titanium bis(isopropoxy)bis(acetylacetonate), and the like; zirconium compounds, such as zirconium tetrakis(acetylacetonate), zirconium bis(butoxy)bis(acetylacetonate), zirconium bis(isopropoxy)bis(acetylacetonate), and the like; and the like can be used, but from the viewpoint of safety, low cost and the length of pot life, organic aluminum compounds are preferably used. In particular, aluminum chelate compounds are more preferable.

The used amount of the above-described catalyst soluble in a system is not limited and is preferably 0.1 to 20 parts by weight, more preferably 0.3 to 10 parts by weight, with respect to a total of 100 parts by weight of a compound having a hydrolyzable group.

Also, in the case of using an organic metal compound as a catalyst so as to form the protection layer 7, a multidentate ligand is preferably added from the viewpoint of pot life and curing efficiency. Examples of the multidentate ligand include, but are not limited to, those shown below and derivatives thereof.

Specifically, examples of the ligand include: β-diketones, such as acetylacetone, trifluoroacetylacetone, hexafluoroacetylacetone, dipivaloylmethylacetone, and the like; acetoacetic esters, such as methyl acetoacetate, ethyl acetoacetate, and the like; bipyridine and a derivative thereof; glycine and a derivative thereof; ethylenediamine and a derivative thereof; 8-oxyquinoline and a derivative thereof; salicylaldehyde and a derivative thereof; catechol and a derivative thereof; bidentate ligands, such as a 2-oxyazo compound and the like; diethyltriamine and a derivative thereof; tridentate ligands such as nitrilotriacetic acid and a derivative thereof, and the like; hexadentate ligands, such as ethylenediaminetetraacetic acid (EDTA) and a derivative thereof, and the like; and the like. Further, in addition to the above-described organic ligands, inorganic ligands, such as pyrophosphoric acid, triphosphoric acid, and the like, are included. Particularly, as the multidentate ligand, a bidentate ligand is preferable, and specific examples thereof include, in addition to the foregoing, bidentate ligands represented by the following general formula (XV). 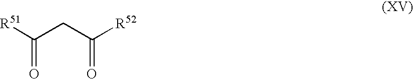
(In the above-described formula (XV), R⁵¹ and R⁵² each individually denotes an alkyl group having one to ten carbon atoms, a fluorinated alkyl group, or an alkoxy group having one to ten carbon atoms.)

As the multidentate ligand, bidentate ligands represented by the above-described general formula (XV) are preferably used, and ligands whose elements denoted by R⁵¹ and R⁵² in the above-described general formula (XV) are identical to each other are particularly preferable. When the elements denoted by R⁵¹ and R⁵² are identical to each other, the coordinative ability of the ligand almost at room temperature is increased, thereby making it possible to further stabilize the curable resin composition.

The mixed amount of multidentate ligand can be arbitrarily determined, and is preferably 0.0 1 mol or more, more preferably 0.1 mol or more, and particularly preferably 1 mol or more with respect to 1 mol of the organic metal compound used.

The protection layer 7 is formed by using, as a coating liquid for forming a protection layer, a curable resin composition containing the above-described constituent materials.

The curable resin composition containing the above-described components can be prepared without using a solvent or by using, as necessary, a solvent including: alcohols, such as methanol, ethanol, propanol, butanol, and the like; ketones, such as acetone, methylethylketone, and the like; ethers, such as tetrahydrofuran, diethylether, dioxane, and the like; and the like. The above solvents can be used singly or in combination of two or more, and the boiling point thereof is preferably 100° C. or less. The used amount of solvent can be arbitrarily determined. In the case of using compounds represented by the above-described general formulas (I) to (V), if the amount of solvent is excessively low, the compounds are likely to deposit, and therefore, the solvent is preferably used in an amount from 0.5 to 30 parts by weight, more preferably in an amount 1 to 20 parts by weight, with respect to 1 part by weight of the compounds represented by the above-described general formulas (I) to (V).

The reaction temperature and the reaction time for curing the curable resin composition are not particularly limited, and from the viewpoint of the mechanical strength and chemical stability of the protection layer 7 to be formed, the reaction temperature is preferably 60° C. or more, more preferably 80 to 200° C., and the reaction time is preferably 10 minutes to 5 hours. Also, in order to stabilize the properties of the protection layer 7 by curing the curable resin composition, it is effective to keep the protection layer 7 under a high humidity condition. Further, hexamethyl disilazane or trimethylchlorosilane is used to perform a surface treatment to cause the protection layer 7 to be hydrophobic, depending on the purpose.

When applying the curable resin composition onto the charge transport layer 6, it is possible to use ordinary coating methods, such as a blade coating method, a wire bar coating method, a spray coating method, a dip coating method, a bead coating method, an air knife coating method, a curtain coating method, and the like.

Note that during application, if a required film thickness is not obtained by a single application operation, application is repeated performed a plurality of times to obtain the required film thickness. When application is repeatedly performed a plurality of times, a heat treatment may be carried out for each application or after performing application a plurality of times.

The thickness of the protection layer 7 is preferably 0.5 to 15 μm, more preferably 1 to 10 μm, and even more preferably 1 to 5 μm.

Also, the protection layer 7 composed of a cured substance of the curable resin composition has sufficient photoelectric characteristics in addition to superior charge transporting ability and superior mechanical strength, and therefore, can be directly used as a charge transfer layer of a layered photoreceptor.

Also, as in the electrophotographic photoreceptors of FIGS. 4 and 5, when the photosensitive layer 3 has the single-layer photosensitive layer 8, the single-layer photosensitive layer 8 contains a charge generation material and a binding resin. The charge generation material can be of the same type as that used for the charge generation layer 5 of a functionally separated photosensitive layer, and the binding resin can be of the same type as that used for the charge generation layer 5 and the charge transport layer 6 of the functionally separated photosensitive layer. The amount of the charge generation material contained in the single-layer photosensitive layer 8 is preferably 10 to 85% by weight, more preferably 20 to 50% by weight, with reference to the total solid content of the single-layer photosensitive layer 8. The single-layer photosensitive layer 8 may be added with a charge transport material or a macromolecular charge transport material for the purpose of, for example, improving photoelectric characteristics. The added amount thereof is preferably 5 to 50% by weight with respect to the total solid content of the single-layer photosensitive layer 8. Also, the solvent used for application and the coating method are the same as those used for each of the above-described layers. The thickness of the single-layer photosensitive layer 8 is preferably about 5 to 50 μm, more preferably 10 to 40 μm.

Also, in the electrophotographic photoreceptors 1 of FIGS. 1 to 5, the protection layer 7, which is an outermost layer, is a functional layer composed of a cured substance of the curable resin composition of the present invention, but the functional layer does not have to be an outermost layer. For example, the undercoat layer 4 may be a functional layer composed of a cured substance of the curable resin composition of the present invention.

(Image Forming Apparatus and Process Cartridge)

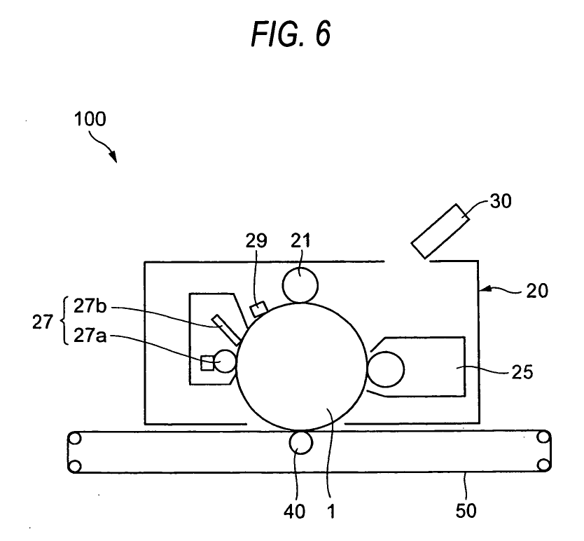

FIG. 6 is a schematic view illustrating a preferred embodiment of an image forming apparatus according to the present invention. An image forming apparatus 100 of FIG. 6 comprises, in the body thereof (not shown), a process cartridge 20 provided with the above-described electrophotographic receptor 1 of the present invention, an exposing device 30, a transfer device 40, and an intermediate transfer unit 50. Note that, in the image forming apparatus 100, the exposing device 30 is disposed in such a position as to expose the electrophotographic photoreceptor 1 to light from an opening of the process cartridge 20, the transfer device 40 is disposed in such a position as to be opposed to the electrophotographic photoreceptor 1 via the intermediate transfer unit 50, and the intermediate transfer unit 50 is disposed so as to be able to press and contact the electrophotographic photoreceptor 1.

The process cartridge 20 is composed of a charging device 21, a developing device 25, a cleaning device 27, and a lubricating agent supplying device 29 in addition to the electrophotographic photoreceptor 1, which are combined and integrated together by an attaching rail within a case. Note that the case is provided with an opening for exposure.

Here, the charging device 21 charges the electrophotographic receptor 1 by contact. The developing device 25 develops an electrostatic latent image on the electrophotographic photoreceptor 1 to form a toner image.

Hereinafter, a toner for use in the developing device 25 will be described. The average shape factor (ML²/A) of the toner is preferably 100 to 150, more preferably 100 to 140. Further, the volume average particle diameter of the toner is preferably 2 to 12 μm, more preferably 3 to 12 μm, and even more preferably 3 to 9 μm. By using the toner which satisfies the above-described average shape factor and volume average particle diameter, it is possible to achieve an image having a high level of development and transfer abilities and image quality.

The toner is not limited by a particular producing method so long as the above-described average shape factor and volume average particle diameter are satisfied. For example, the toner which is to be used is produced by: a kneading-pulverizing method in which a binding resin, a coloring agent, and a releasing agent (and as necessary a charge control agent, etc.) are mixed or kneaded, pulverized, and classified; a method of changing the shape of a particle obtained by the kneading-pulverizing method by using mechanical impact or thermal energy; an emulsion-polymerization-aggregation method in which polymerizable monomers of a binding resin are subjected to emulsion polymerization, and the resultant dispersion liquid is mixed with a coloring agent and a releasing agent (and as necessary a charge control agent, etc.), followed by aggregation and fusion by heat to obtain a toner particle; a suspension-polymerization method in which polymerizable monomers for obtaining a binding resin and a solution containing a coloring agent and a releasing agent (and as necessary a charge control agent, etc.) are suspended in an aqueous solvent for polymerization; a dissolution-suspension method in which a binding resin and a solution containing a coloring agent and a releasing agent (and as necessary a charge control agent, etc.) are suspended in an aqueous solvent for granulation.

Also, a known method, such as a production method in which the toner obtained by the above-described method is used as a core, to which aggregated particles are attached and fused by heat to form a core shell structure, or the like, can be used. Note that, from the viewpoint of shape control and particle size distribution control, the method for producing a toner is preferably a suspension-polymerization method, an emulsion-polymerization-aggregation method, or a dissolution-suspension method, which produces the toner using an aqueous solvent, more preferably the emulsion polymerization and aggregation method.

A toner mother particle is composed of a binding resin, a coloring agent, and a releasing agent, and if necessary, silica or a charge control agent.

Examples of the binding resin used for the toner mother particle include: homopolymers and copolymers of styrenes, such as styrene, chlorostyrene, and the like; monoolefins, such as ethylene, propylene, butylenes, isoprene, and the like; vinyl esters, such as vinyl acetate, vinyl propionate, vinyl benzoate, vinyl butyrate, and the like; α-methylene aliphatic monocarboxylic acid esters, such as methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate, and the like; vinylethers, such as vinylmethylether, vinylethylether, vinylbutylether, and the like; vinylketones, such as vinylmethylketone, vinylhexylketone, vinylisopropenylketone, and the like; and the like, and polyester resin obtained by copolymerization of dicarboxylic acids and diols.

Particularly typical examples of the binding resin include polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene, polyester resin, and the like. Further, examples thereof also include polyurethane, epoxy resin, silicone resin, polyamide, denatured rosin, paraffin wax, and the like.

Also, typical examples of the coloring agent include magnetic powder, such as magnetite, ferrite, and the like, carbon black, aniline blue, chalcoyl blue, chrome yellow, ultramarine blue, DuPont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment yellow 17, C.I. pigment blue 15:1, C.I. pigment blue 15:3, and the like.

Typical examples of the releasing agent include low-molecular polyethylene, low-molecular polypropylene, Fisher-Tropsch wax, montan wax, camauba wax, rice wax, candelilla wax, and the like.

Also, a known agent can be used as the charge control agent, and an azo-based metal complex compound, a metal complex compound of salicylic acid, and a resin type charge control agent containing a polar group can be used. When a toner is produced by a wet process, a material resistant to dissolution in water is preferably used from the viewpoint of control of ionic strength and a reduction in wastewater contamination. Also, the toner may be either a magnetic toner containing a magnetic material or a non-magnetic toner free of magnetic materials.

The toner for use in the developing device 25 can be produced by mixing the above-described toner mother particle and the above-described external additive using a Henschel mixer, a V-blender, or the like. Also, when the toner mother particle is produced by a wet process, external addition may be carried out in a wet process.

The toner for use in the developing device 25 may be added with a lubricant particle. Examples of the lubricant particle include: solid lubricants, such as graphite, molybdenum disulfide, talc, aliphatic acid, metal salt of aliphatic acid, and the like; low-molecular weight polyolefins, such as polypropylene, polyethylene, polybutene, and the like; silicones which exhibit a softening point by heating; aliphatic amides, such as amide oleate, erucamide, amide ricinoleate, amide stearate, and the like; vegetable waxes, such as camauba wax, rice wax, candelilla wax, wood wax, jojoba oil, and the like; animal waxes, such as beeswax and the like; mineral and petroleum waxes, such as montan wax, ozokerite, seresin, paraffin wax, microcrystalline wax, Fischer-Tropsch wax, and the like; and modified products thereof. These can be used singly or in combination of two or more. Note that the volume average particle diameter is preferably 0.1 to 10 μm, and a material having the above-described chemical structure may be pulverized into a uniform particle diameter. The amount thereof to be added to the toner is preferably 0.05 to 2.0% by weight, and more preferably 0.1 to 1.5% by weight.

For the purpose of removing attached matter or deteriorated matter from the surface of the electrophotographic photoreceptor, the toner for use in the developing device 25 can be added with an inorganic fine particle, an organic fine particle, a composite fine particle obtained by attaching the inorganic fine particle to the organic fine particle, or the like.

Preferable examples of the inorganic fine particle include various inorganic oxides, nitrides, borides, and the like, such as silica, alumina, titania, zirconia, barium titanate, aluminum titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, boron nitride, and the like.

Also, the above-described inorganic fine particle may be treated with: a titanium coupling agent, such as tetrabutyl titanate, tetraoctyl titanate, isopropyltriisotearoyl titanate, isopropyltridecylbenzenesulfonyl titanate, bis(dioctylpyrophosphate)oxyacetate titanate), or the like; a silane coupling agent, such as γ-(2-aminoethyl)aminopropyltrimethoxysilane, γ-(2-aminoethyl)aminopropylmethyldimethoxysilane, γ-methacryloxypropyltrimethoxysilane, N-β-(N-vinylbenzylaminoethyl) γ-aminopropyltrimethoxysilane hydrochloride, hexamethyl disilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, p-methylphenyltrimethoxysilane, or the like; or the like. Also, the inorganic fine particle subjected to a hydrophobic treatment with a higher fatty acid metal salt, such as silicone oil, aluminum stearate, zinc stearate, calcium stearate, or the like, is preferably used.

Examples of the organic fine particulate include a styrene resin particle, a styrene acrylic resin particle, a polyester resin particle, a urethane resin particle, and the like.

Regarding the particle diameter, the volume average particle diameter is preferably 5 nm to 1,000 nm, more preferably 5 nm to 800 nm, and even more preferably 5 nm to 700 nm. When the volume average particle diameter is less than the above-described lower limit, grindability is likely to deteriorate. On the other hand, when the above-described upper limit is exceeded, the surface of the electrophotographic photoreceptor is prone to scratch. Also, the sum of added amounts of the above-described particle and lubricant particle is preferably 0.6% by weight or more.

Other preferable inorganic oxides added to the toner preferably have a primary particle diameter of as small as 40 nm or less from the viewpoint of powder flowability, charge control, and the like. Still other preferable inorganic oxides added to the toner preferably have a larger diameter than the above-described size from the viewpoint of a reduction in adhesion force and charge control. As the inorganic oxide fine particles, known materials can be used, and silica and titanium oxide are preferably used in combination for precise charge control. Also, by surface-treating the small-diameter inorganic fine particle, the dispersibility thereof is increased, thereby increasing the effect of enhancing the powder flowability. In addition, it is preferable to add carbonate, such as calcium carbonate, magnesium carbonate, or the like, or an inorganic mineral, such as hydrotalcite or the like, in order to remove discharge products.

Also, color toners for electrophotograph are used in mixture with a carrier. As the carrier, iron powder, glass beads, ferrite powder, nickel powder, or those having a resin coating on their surfaces are used. Also, the mixing ratio with the carrier can be determined as appropriate.

The cleaning device 27 comprises a (roll-type) fibrous member 27a and a cleaning blade (blade member) 27b.

Although the cleaning device 27 is provided with the fibrous member 27a and the cleaning blade 27b, the cleaning device may include only either of them. The fibrous member 27a may be toothbrush-shaped instead of roll-shaped. Also, the fibrous member 27a may be fixed on the body of the cleaning device or may be rotatably supported, or it may be supported in a manner which allows it to oscillate in an axial direction of the photoreceptor. Examples of the fibrous member 27a include polyester, nylon, acrylic, and the like, a fabric-type material made of a microfiber, such as TORAYSEE (manufactured by Toray Industries, Inc.), a brush-shaped material obtained by planting a resin fiber, such as nylon, acrylic, polyolefine, polyester, or the like, in a substrate- or carpet-like form, and the like. Also, the fibrous member 27a may be those obtained by adding to the above-described material electro-conductive powder or an ionic conductant agent to confer conductivity thereto, or by providing a conductive layer inside or outside of each fiber, for example. When the conductivity is conferred, the resistance of a single fiber is preferably 10² to 10⁹ Ω. Also, the thickness of a fiber of the fibrous member 27a is preferably 30 d (denier) or less, more preferably 20 d or less, and the density of the fibers is preferably 20,000/inch² or more, more preferably 30,000/inch² or more.

Regarding the cleaning device 27, it is necessary that attached matter (e.g., discharge products) be removed from the photoreceptor surface using a cleaning blade or a cleaning brush. In order to achieve this purpose over a long period of time and stabilize the function of a cleaning member, the cleaning member is preferably supplied with a lubricating substance (lubricating component), such as metal soap, higher alcohol, wax, silicone oil, or the like.

For example, when a roll-type member is used as the fibrous member 27a, it is preferable to supply the lubricating component by bring the surface of the electrophotographic photoreceptor into contact with a lubricating substance, such as metal soap, wax, or the like. As the cleaning blade 27b, an ordinary rubber blade is used. When a rubber blade is used as the cleaning blade 27b, it is particularly effective to supply a lubricating component to the surface of the electrophotographic photoreceptor in order to prevent chipping or wearing of the blade.

The above-described process cartridge 20 is detachable from the image forming apparatus body, and constitutes the image forming apparatus together with the image forming apparatus body.

As the exposing device 30, any device can be used so long as it exposes the charged electrophotographic photoreceptor 1 to light so as to form an electrostatic latent image. Also, as a light source for the exposing device 30, a multi-beam surface emitting laser is preferably used.

As the transfer device 40, any transfer medium (intermediate transfer unit 50) on which a toner image on the electrophotographic photoreceptor 1 may be used. For example, any commonly used device having a roll shape is used.

As the intermediate transfer unit 50, a belt-shaped unit (intermediate transfer belt) formed of polyimide, polyamidimide, polycarbonate, polyarylate, polyester, rubber, or the like, which is provided with semiconductivity, is used. Also, the intermediate transfer unit 50 may be in the form of a drum instead of a belt. Note that there exist direct transfer image forming apparatuses without the intermediate transfer unit, and the electrophotographic photoreceptor of the present invention is suitable for such image forming apparatuses. This is because, in the direct transfer image forming apparatuses, paper powder or talc generated from printing paper are likely to occur and adhere to the electrophotographic photoreceptor, resulting in an image quality defect due to the adhered matter. The electrophotographic photoreceptor of the present invention has superior cleanability, and therefore, the paper powder or talc can be readily removed therefrom, thereby making it possible even for the direct transfer image forming apparatuses to stably produce images.

Note that the transfer medium as used herein is not particularly limited so long as a toner image formed on the electrophotographic photoreceptor 1 is transferred onto the medium. For example, when the toner image is transferred directly from the electrophotographic photoreceptor 1 onto paper or the like, the paper or the like is the transfer medium. When the intermediate transfer unit 50 is used, the intermediate transfer unit is the transfer medium.

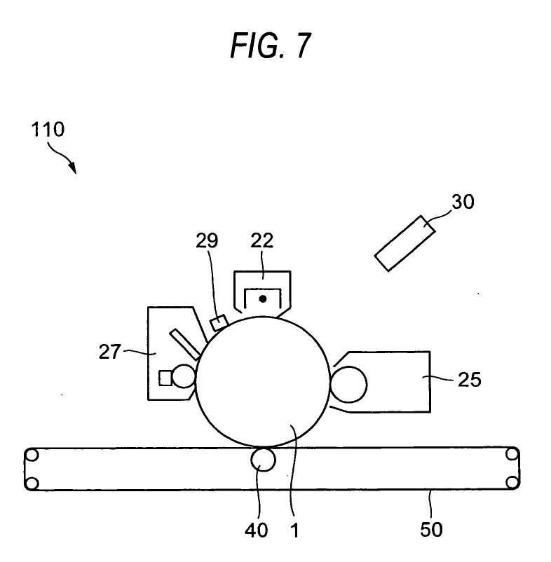

FIG. 7 is a schematic view illustrating another embodiment of the image forming apparatus according to the present invention. In an image forming apparatus 110 of FIG. 7, the electrophotographic photoreceptor 1 is fixed on the body of the image forming apparatus, and a charging device 22, a developing device 25 and a cleaning device 27 are each provided in the form of a cartridge, i.e., a charge cartridge, an exposure cartridge, and a cleaning cartridge, respectively. Note that the charging device 22 comprises a charging unit for charging with a corona discharge method.

In the image forming apparatus 110, the electrophotographic photoreceptor 1 and the other devices are separated from each other. The charging device 22, the developing device 25, and the cleaning device 27 are not fixed on the image forming apparatus body by screws, riveting, bonding, or welding, and can be detached and attached by pulling and pushing operations.

The electrophotographic photoreceptor of the present invention is superior in abrasion resistance, and therefore, in some cases, it may be unnecessary to be provided in the form of a cartridge. Therefore, by configuring the charging device 22, the developing device 25 or the cleaning device 27 without being fixed on the body by screws, riveting, bonding, or welding, so as to be detached and attached by pulling and pushing operations, it is possible to reduce cost of members per print. Also, two or more of these devices can be integrated into a detachable cartridge, thereby making it possible to further reduce the cost of members per print.

Note that the image forming apparatus 110 is configured similar to the image forming apparatus 100, except that the charging device 22, the developing device 25 and the cleaning device 27 are each provided in the form of a cartridge.

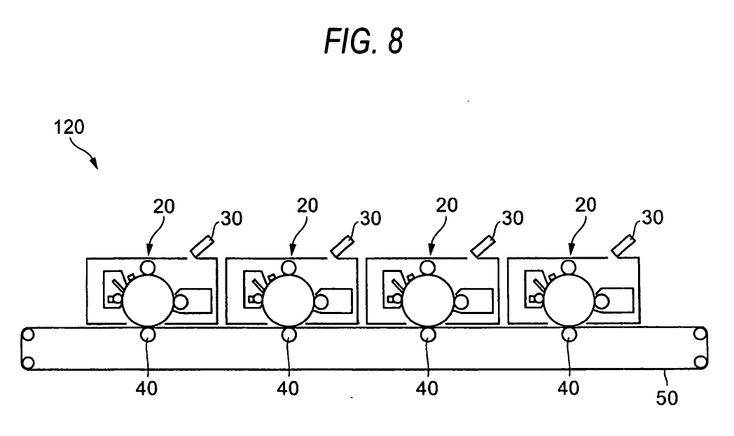

FIG. 8 is a schematic view illustrating another embodiment of the image forming apparatus of the present invention. An image forming apparatus 120 is a tandem full color image forming apparatus provided with four process cartridges 20. In the image forming apparatus 120, the four process cartridges 20 are provided in parallel on the intermediate transfer unit 50 so that one electrophotographic photoreceptor can be used for one color. Note that the image forming apparatus 120 has a structure similar to that of the image forming apparatus 100, except for being of a tandem type.

In the tandem image forming apparatus 120, the degree of abrasion varies among the electrophotographic photoreceptors, depending on the use rates of their respective colors, and therefore, electrical characteristics are likely to vary among the electrophotographic photoreceptors. As a result, the toner development characteristics are likely to gradually change from its initial state, so that the color tone of a printed image changes, thereby making it difficult to obtain a stable image. In particular, in the case of a small-sized image forming apparatus, an electrophotographic photoreceptors having a small diameter is employed, and when one which has a diameter of less than 30 mm is used, the above-described tendency becomes significant. Here, in the case where the electrophotographic photoreceptor of the present invention is adopted, even if it is less than 30 mm in diameter, the surface abrasion is sufficiently suppressed. Therefore, the electrophotographic photoreceptor of the present invention is particularly effective for the tandem image forming apparatus.

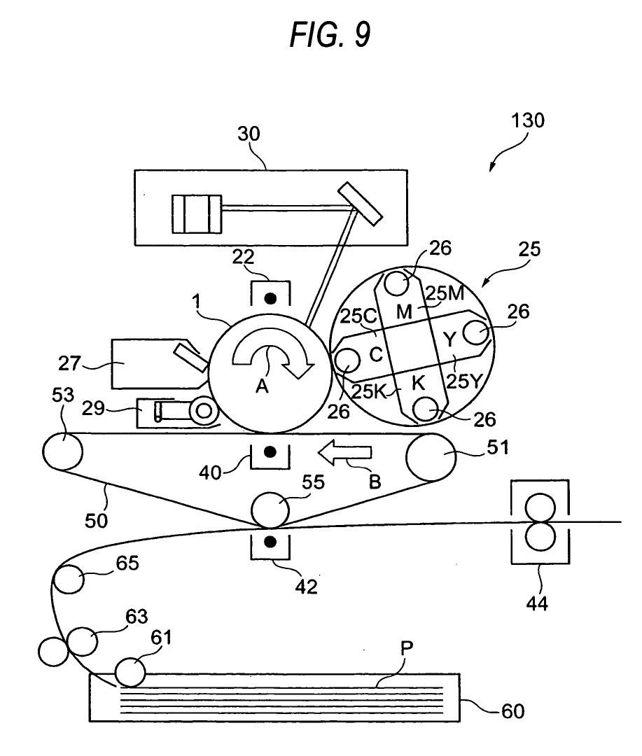

FIG. 9 is a schematic view illustrating another embodiment of the image forming apparatus of the present invention. An image forming apparatus 130 of FIG. 9 is a so-called four-cycle image forming apparatus, which uses one electrophotographic photoreceptor so as to form a multi-color toner image. The image forming apparatus 130 comprises a photoreceptor drum 1 which is rotated by a drive device (not shown) at a predetermined rotating speed in the direction of arrow A in FIG. 9, and a charging device 22 which is provided above the photoreceptor drum 1 and charges a circumference surface of the photoreceptor drum 1.

Also, an exposing device 30 comprising a surface emitting laser array as an exposure light source is provided above the charging device 22. The exposing device 30 modulates a plurality of laser beams emitted from the light source according to an image which is to be formed, and is deflected in a primary scanning direction to scan the circumference surface of the photoreceptor drum 1 in a direction parallel to the axis of the photoreceptor drum 1. Thereby, an electrostatic latent image is formed on the circumference surface of the charged photoreceptor drum 1.

A developing device 25 is provided on a side of the photoreceptor drum 1. The developing device 25 comprises a roller-like housing provided in a rotatable manner. Inside the housing, four housing units including developing units 25Y, 25M, 25C, and 25K, respectively, are formed. The developing units 25Y, 25M, 25C, and 25K comprise their respective developing rollers 26 which retain toners of colors Y, M, C, and K, respectively.

In the image forming apparatus 130, a full color image is formed while the photoreceptor drum 1 is rotated four turns. Specifically, while the photoreceptor drum 1 is rotated four turns, the charging device 22 charges the circumference surface of the photoreceptor drum 1, and the exposing device 20 repeats scanning the circumference surface of the photoreceptor drum 1 with a laser beam modulated according to image data for any one of the colors Y, M, C, and K representing a color image which is to be formed while switching between image data to be used so as to modulate the laser beam every time the photoreceptor drum 1 is rotated one turn. Also, when the developing roller 26 which corresponds to any one of the developing units 25Y, 25M, 25C and 25K faces the circumference surface of the photoreceptor drum 1, the developing device 25 activates the developing unit which is facing the circumference surface to develop an electrostatic latent image, which is formed on the circumference surface of the photoreceptor drum 1, to a specific color, thereby forming a toner image of a specific color on the circumference surface of the photoreceptor drum 1. This operation is repeated while rotating the housing so as to switch between the developing units to be used so as to develop the electrostatic latent image, every time the photoreceptor drum 1 is rotated one turn. Thereby, every time the photoreceptor drum 1 is rotated one turn, a toner image for Y, M, C, or K is formed on the circumference surface of the photoreceptor drum 1, such that one image overlaps another image in sequence. When the photoreceptor drum 1 is rotated four turns, a full color toner image is formed on the circumference surface of the photoreceptor drum 1.

Also, an endless intermediate transfer belt 50 is provided substantially below the photoreceptor drum 1. The intermediate transfer belt 50 is wrapped and hung around rollers 51, 53, and 55, and is positioned so that the circumference surface thereof is brought in contact with the circumference surface of the photoreceptor drum 1. Driving force is transferred from a motor (not shown) to the rollers 51, 53, and 55, which are thereby rotated. As a result, the intermediate transfer belt 50 is rotated in a direction indicated with arrow B of FIG. 9.

A transfer device (transfer unit) 40 is provided opposite to the photoreceptor drum 1 across the intermediate transfer belt 50, and a toner image formed on the circumference surface of the photoreceptor drum 1 is transferred by the transfer device 40 onto an image forming face of the intermediate transfer belt 50.

Also, a lubricating agent supplying device 29 and a cleaning device 27 are provided opposite to the development device 25 across the photoreceptor drum 1, and are provided on the circumference surface of the photoreceptor drum 1. When a toner image formed on the circumference surface of the photoreceptor drum 1 is transferred onto the intermediate transfer belt 50, the lubricating agent supplying device 29 supplies a lubricating agent onto the circumference surface of the photoreceptor drum 1, and the cleaning device 27 cleans up an area of the circumference surface that has held the transferred toner image.

A tray 60 is provided below the intermediate transfer belt 50. The tray 60 holds a number of sheets of paper P as recording materials are stored in stack. A pickup roller 61 is provided on an upper left side of the tray 60, and a roller pair 63 and a roller 65 are sequentially provided downstream in a direction along which the paper P is fed out by the pickup roller 61. When the pickup roller 61 is rotated, a recording sheet on the top of the stack is outputted from the tray 60, and transported by the roller pair 63 and the roller 65.

Also, a transfer device 42 is provided opposite to the roller 55 across the intermediate transfer belt 50. The paper P transported by the roller pair 63 and the roller 65 is fed between the intermediate transfer belt 50 and the transfer device 42, and the toner image formed on the image forming face of the intermediate transfer belt 50 is transferred by the transfer device 42. A fixing device 44 provided with a fixing roller pair is provided downstream of the transfer device 42 in the direction along which the paper P is transported, and the paper P on which the toner image has been transferred is output from the image forming apparatus 130 after the transferred toner image is fixed through fusion by the fixing device 44, and thereafter, is placed onto an output tray (not shown).

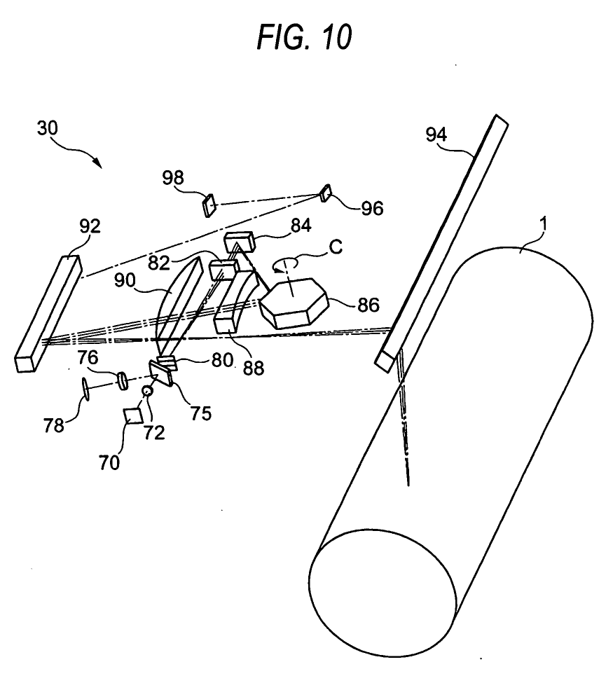

Next, referring to FIG. 10, a preferable example of the exposing device 30 provided with a surface emitting laser array as an exposure light source will be described in detail. The exposing device 30 comprises a surface emitting laser array 70 for emitting m laser beams (where m is at least 3 or more). Although FIG. 10 illustrates only three laser beams for the sake of simplicity, the surface emitting laser array 70 composed of an array of surface emitting lasers can be constructed to emit several tens of laser beams. Also, it is possible not only to arrange the array of the surface emitting lasers (an array of laser beams emitted from the surface emitting laser array 70) in one row, but also to arrange the lasers two-dimensionally (e.g., in a matrix).

A collimating lens 72 and a half mirror 74 are sequentially disposed on a laser beam emission side of the surface emitting laser array 70. A laser beam emitted from the surface emitting laser array 70 is caused to be a roughly parallel flux of light by the collimating lens 72, and thereafter, is incident on the half mirror 74. A part of the light beam is separated/reflected by the half mirror 74. A lens 76 and a light intensity sensor 78 are sequentially disposed on a laser beam reflection side of the half mirror 74. A part of the main laser beam (the laser beam which is used for exposure) which has been separated/reflected by the half mirror 74 is transmitted through the lens 76 to enter the light intensity sensor 78, where the amount of light is detected.

Note that the surface emitting laser emits no laser beam from a side opposite to the side from which the laser beam used for exposure is emitted (note: an end surface emitting laser emits laser beams from opposite sides thereof), and therefore, in order to detect/control the light amount of the laser beam, it is necessary to separate a part of the laser beam used for exposure as described above and use it so as to detect the light amount.

An aperture 80, a cylindrical lens 82 having power only in the sub-scanning direction, and a turn-back mirror 84 are sequentially disposed on a side of the half mirror 74 from which the main laser beam is emitted. The main laser beam emitted from the half mirror 74 is shaped by the aperture 80, and thereafter, is refracted by the cylindrical lens 82 so as to be focused into a linear form elongated in the main scanning direction in the vicinity of a rotary polygon mirror 86 toward which the focused beam is reflected by the turn-back mirror 84. Note that the aperture 80 is preferably positioned in the vicinity of the focal point of the collimating lens 72 in order to uniformly shape a plurality of laser beams.

The rotary polygon mirror 86 receives driving force transferred from a motor (not shown), and is thereby rotated in a direction indicated with arrow C of FIG. 10, thereby deflecting/reflecting the incident laser beam, which has been reflected by the turn-back mirror 84, in the main scanning direction. Fθ lenses 88 and 90 having power only in the main scanning direction are disposed on the laser beam emission side of the rotary polygon mirror 86, and the laser beam deflected/reflected by the rotary polygon mirror 86 travels at a substantially constant speed on the circumference surface of the electrophotographic photoreceptor 1 and is refracted by the Fθ lenses 88 and 90 so that the focal position in the main scanning direction coincides with the circumference surface of the electrophotographic photoreceptor 1.

Cylindrical mirrors 92 and 94 having powder only in the sub-scanning direction are sequentially disposed on a laser beam emission side of the Fθ lenses 88 and 90, and the laser beam transmitted through the Fθ lenses 88 and 90 is reflected by the cylindrical mirrors 92 and 94 so that the focal position in the sub-scanning direction coincides with the circumference surface of the electrophotographic photoreceptor 1, and is cast onto the circumference surface of the electrophotographic photoreceptor 1. Note that the cylindrical mirrors 92 and 94 also have a face tangle error correcting function for placing the rotary polygon mirror 86 in a conjugate relationship with the circumference surface of the electrophotographic photoreceptor 1 in the sub-scanning direction.

Also, a pickup mirror 96 is disposed at a position corresponding to a scan starting end (SOS: start of scan) within a scanning range of the laser beam on a laser beam emission side of the cylindrical mirror 92, and a beam position detecting sensor 98 disposed on a laser beam emission side of the pickup mirror 96. The laser beam emitted from the surface emitting laser array 70 is reflected by the pickup mirror 96 to enter the beam position detecting sensor 98 when one of the reflection faces of the rotary polygon mirror 86 which is reflecting the laser beam is directed so as to reflect the beam to a direction corresponding to the SOS (see imaginary lines in FIG. 10).

When forming an electrostatic latent image by modulating a laser beam with which the circumference surface of the electrophotographic photoreceptor 1 is scanned in accordance with the rotation of the rotary polygon mirror 86, a signal outputted from the beam position detecting sensor 98 is used so as to synchronize timing of starting modulation for each main scanning operation.

Also, in the exposing device 30, the collimating lens 72, the cylindrical lens 82, and the two cylindrical mirrors 92 and 94 are disposed to be afocal in the sub-scanning direction. The reason for this is to suppress a difference in scanning line curvature (BOW) between a plurality of laser beams and a variation in interval between scanning lines formed by the plurality of laser beams.

### EXAMPLES

Hereinafter, the present invention will be more specifically described by way of examples and comparative examples, but is not limited by the following examples.

### Synthesis Example 1

200 g of phenol (manufactured by Wako Pure Chemical Industries, Ltd.), 344.8 g of formalin (manufactured by Wako Pure Chemical Industries, Ltd.) and 4 g of triethylamine (manufactured by Tokyo Kasei Kogyo Co., Ltd.) are put into a three-neck flask provided with a Dimroth condenser, a nitrogen introduction tube, and a stirrer, and are heated and stirred at 80° C. for 5 hours. Thereafter, the solvent is distilled off under reduced pressure. Next, 100 g of methanol is added thereto, followed by dissolution and mixture. Thereafter, the solvent is distilled off under reduced pressure. The series of operations from the addition of methanol to the distillation of the solvent are further repeated twice to obtain a viscous phenolic resin. The molecular weight distribution of the obtained phenolic resin is measured by gel permeation chromatography to find that the (MwH/MwL) value is 0.50 (converted using standard polystyrene). This phenolic resin is referred to as “(Ph-1)”.

### Synthesis Example 2

200 g of phenol (manufactured by Wako Pure Chemical Industries, Ltd.), 344.8 g of formalin (manufactured by Wako Pure Chemical Industries, Ltd.) and 4 g of triethylamine (manufactured by Tokyo Kasei Kogyo Co., Ltd.) are put into a three-neck flask provided with a Dimroth condenser, a nitrogen introduction tube and a stirrer, and are heated and stirred at 90° C. for 4.5 hours. Thereafter, a solvent is distilled off under reduced pressure. Next, 100 g of methanol is added thereto, followed by dissolution and mixture. Thereafter, the solvent is distilled off under reduced pressure. The series of operations from the addition of methanol to the distillation of the solvent are further repeated twice to obtain a viscous phenolic resin. The molecular weight distribution of the obtained phenolic resin is measured by gel permeation chromatography to find that the (MwH/MwL) value is 1.87 (converted using standard polystyrene). This phenolic resin is referred to as “(Ph-2)”.

### Synthesis Example 3

200 g of phenol (manufactured by Wako Pure Chemical Industries, Ltd.), 344.8 g of formalin (manufactured by Wako Pure Chemical Industries, Ltd.) and 4 g of triethylamine (manufactured by Tokyo Kasei Kogyo Co., Ltd.) are put into a three-neck flask provided with a Dimroth condenser, a nitrogen introduction tube and a stirrer, and are heated and stirred at 95° C. for 5 hours. Thereafter, a solvent is distilled off under reduced pressure. Next, 100 g of methanol is added thereto, followed by dissolution and mixture. Thereafter, the solvent is distilled off under reduced pressure. The series of operations from the addition of methanol to the distillation of the solvent are further repeated twice to obtain a viscous phenolic resin. The molecular weight distribution of the obtained phenolic resin is measured by gel permeation chromatography to find that the (MwH/MwL) value is 2.30 (converted using standard polystyrene). This phenolic resin is referred to as “(Ph-3)”.

### Synthesis Example 4

200 g of phenol (manufactured by Wako Pure Chemical Industries, Ltd.), 344.8 g of formalin (manufactured by Wako Pure Chemical Industries, Ltd.) and 4 g of triethylamine (manufactured by Tokyo Kasei Kogyo Co., Ltd.) are put into a three-neck flask provided with a Dimroth condenser, a nitrogen introduction tube and a stirrer, and are heated and stirred at 80° C. for 6 hours. Thereafter, a solvent is distilled off under reduced pressure. Next, 100 g of methanol is added thereto, followed by dissolution and mixture. Thereafter, the solvent is distilled off under reduced pressure. The series of operations from the addition of methanol to the distillation of the solvent are further repeated twice to obtain a viscous phenolic resin. The molecular weight distribution of the obtained phenolic resin is measured by gel permeation chromatography to find that the (MwH/MwL) value is 1.46 (converted using standard polystyrene). This phenolic resin is referred to as “(Ph-4)”.

### Synthesis Example 5

200 g of phenol (manufactured by Wako Pure Chemical Industries, Ltd.), 344.8 g of formalin (manufactured by Wako Pure Chemical Industries, Ltd.) and 4 g of triethylamine (manufactured by Tokyo Kasei Kogyo Co., Ltd.) are put into a three-neck flask provided with a Dimroth condenser, a nitrogen introduction tube and a stirrer, and are heated and stirred at 80° C. for 3 hours. Thereafter, a solvent is distilled off under reduced pressure. Next, 100 g of methanol is added thereto, followed by dissolution and mixture. Thereafter, the solvent is distilled off under reduced pressure. The series of operations from the addition of methanol to the distillation of the solvent are further repeated twice to obtain a viscous phenolic resin. The molecular weight distribution of the obtained phenolic resin is measured by gel permeation chromatography to find that the (MwH/MwL) value is 0.18 (converted using standard polystyrene). This phenolic resin is referred to as “(Ph-5)”.

### Example 1

A cylindrical aluminum substrate is ground by a centerless grinding machine such that a surface roughness R_{z}=0.6 μm. In order to wash the aluminum substrate subjected to a centerless grinding process, degreasing, 1-minute etching with 2% by weight sodium hydroxide solution, neutralization, and washing with pure water are carried out in this order. Next, the aluminum substrate is treated with 10% by weight sulfuric acid solution to form an anodic oxide film (current density: 1.0 A/dm²) on the substrate surface. After washing it in water, the substrate is dipped in 1% by weight nickel acetate solution at 80° C. for 25 minutes to effect sealing. Further, washing in pure water and drying are carried out. In this manner, an aluminum substrate having an anodic oxide film having a thickness of about 7.5 μm which is formed on the surface thereof is obtained.

Next, 1 part by weight of titanyl phthalocyanine having an intense diffraction peak at a Bragg angle (2θ±0.2°) of 27.2° in X-ray diffraction spectra is mixed with 1 part by weight of polyvinylbutyral (S-LEC BM-S, manufactured by Sekisui Chemical Co., Ltd.) and 100 parts by weight of n-butyl acetate, and the resultant mixture is dispersed with glass beads in a paint shaker for 1 hour to obtain a coating liquid for forming a charge generation layer. The obtained coating liquid is applied onto the aluminum substrate by a dip coating method, followed by heating and drying at 100° C. for 10 minutes to form a charge generation layer having a thickness of about 0.15 μm.

Next, 2 parts by weight of benzidine compound represented by general formula (XVI) below and 2.5 parts by weight of macromolecular compound having a structural unit represented by general formula (XVII) below (viscosity-average molecular weight: 39,000) are dissolved in 25 parts by weight of chlorobenzene to obtain a coating liquid for forming a charge transport layer.

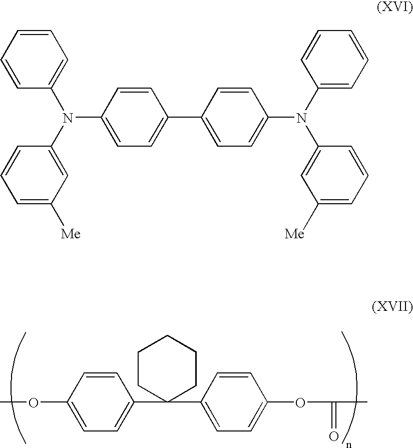

The obtained coating liquid is applied onto the above-described charge generation layer by a dip coating method, followed by heating at 130° C. for 40 minutes to form a charge transport layer having a thickness of 20 μm.

Next, 3 parts by weight of the above-described compound (I-10), 0.5 parts by weight of Me(MeO)₂—Si—(CH₂)₆—Si—Me(OMe)₂, 0.5 parts by weight of hexamethylcyclotrisiloxane, 5 parts by weight of butyl alcohol and 0.3 parts by weight of ion exchange resin (AMBERLYST 15E, manufactured by Rohm & Haas Co.) are mixed and stirred to carry out an exchange reaction of protecting groups for 3 hours. Thereafter, 8 parts by weight of n-butanol and 0.3 parts by weight of distilled water are added, followed by hydrolysis for 15 minutes.

To a liquid obtained by filtering the reaction mixture subjected to hydrolysis to remove the ion exchange resin, 0.1 parts by weight of aluminum trisacetatyl acetonate (Al(aqaq)₃), 0.1 parts by weight of acetylacetone, 0.4 parts by weight of 3,5-di-t-butyl-4-hydroxytoluene (BHT), and 4 parts by weight of the phenolic resin (Ph-1) synthesized in Synthesis example 1 are added to obtain a coating liquid for forming a protection layer. The obtained coating liquid is applied onto the charge transport layer by a ring dip coating method, followed by air drying at room temperature for 5 minutes before curing it by heating at 150° C. for 1 hour, to form a protection layer (outermost layer) having a thickness of about 3 μm. Thereby, the production of the electrophotographic photoreceptor is completed.

### Example 2

First, a cylindrical aluminum substrate subjected to a honing treatment is prepared. Next, 100 parts by weight of a zirconium compound (ORGATIX ZC540, manufactured by Matsumoto Chemical Industry Co., Ltd.), 10 parts by weight of a silane compound (A1100, manufactured by Nippon Unicar Co., Ltd.), 3 parts by weight of polyvinyl butyral (S-LEC BM-S, manufactured by Sekisui Chemical Co., Ltd.), 380 parts by weight of isopropanol, and 200 parts by weight of butanol are mixed to obtain a coating liquid for forming an undercoat layer. The coating liquid is applied onto the aluminum substrate by a dip coating method, followed by heating and drying at 150° C. for 10 minutes to obtain an undercoat layer having a thickness of about 0.17 μm.

Next, 1 part by weight of chlorogallium phthalocyanine having intense diffraction peaks at Bragg angles (2θ±0.20) of 7.4°, 16.6°, 25.5°, and 28.3° in X-ray diffraction spectra, 1 part by weight of polyvinyl butyral (S-LEC BM-S, manufactured by Sekisui Chemical Co., Ltd.), and 100 parts by weight of n-butyl acetate are mixed, and are dispersed with glass beads in a paint shaker for 1 hour to obtain a coating liquid for forming a charge generation layer. The coating liquid is applied onto the above-described undercoat layer by a dip coating method, followed by heating and drying at 100° C. for 10 minutes to form a charge generation layer having a thickness of about 0.15 μm.

Next, 2 parts by weight of a compound represented by general formula (XVIII) below and 3 parts by weight of a macromolecular compound having a structural unit represented by general formula (XIX) below (viscosity-average molecular weight: 50,000) are dissolved in 20 parts by weight of chlorobenzene to obtain a coating liquid for forming a charge transport layer.

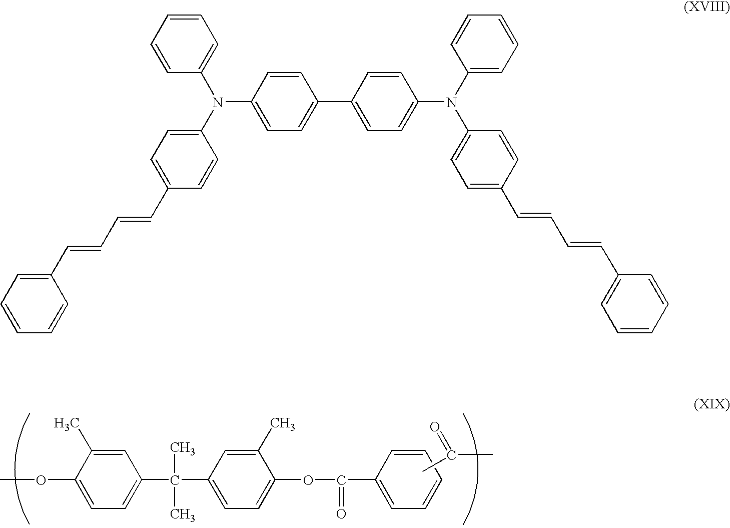

The obtained coating liquid is applied onto the above-described charge generation layer by a dip coating method, followed by heating at 130° C. for 45 minutes to form a charge transport layer having a thickness of 20 μm.

Next, 3 parts by weight of the above-described compound (I-16), 0.7 parts by weight of Me(MeO)₂—Si—(CH₂)₄—Si—Me(OMe)₂, 0.5 parts by weight of hexamethylcyclotrisiloxane, 5 parts by weight of butyl alcohol, and 0.3 parts by weight of ion exchange resin (AMBERLYST 15E, manufactured by Rohm & Haas Co.) are mixed and stirred to carry out an exchange reaction of protecting groups for 5 hours. Thereafter, 8 parts by weight of n-butanol and 0.3 parts by weight of distilled water are added, followed by hydrolysis for 15 minutes.

To a liquid obtained by filtering the reaction mixture subjected to hydrolysis to remove the ion exchange resin, 0.1 parts by weight of aluminum trisacetylacetonate (Al(aqaq)₃), 0.1 parts by weight of acetylacetone, 0.5 parts by weight of NACURE 2500 (block sulfonic acid, manufactured by Kusumoto Chemicals, Ltd.), 0.4 parts by weight of 3,5-di-t-butyl-4-hydroxytoluene (BHT), and 4.5 parts by weight of the phenolic resin (Ph-1) synthesized in Synthesis example 1 are added to obtain a coating liquid for forming a protection layer. The obtained coating liquid is applied onto the charge transport layer by a ring dip coating method, followed by air drying at room temperature for 5 minutes before curing it by heating at 150° C. for 1 hour to form a protection layer (outermost layer) having a thickness of about 3 μm. Thereby, the production of the electrophotographic photoreceptor is completed.

### Example 3

100 parts by weight of zinc oxide (SMZ-017N, manufactured by Tayca Corp.) is mixed and stirred with 500 parts by weight of toluene, followed by addition of 2 parts by weight of a silane coupling agent (A1100, manufactured by Nippon Unicar Co., Ltd.) and stirring for 5 hours. Thereafter, toluene is distilled off under reduced pressure, followed by sintering at 120° C. for 2 hours. The resultant surface-treated zinc oxide is analyzed with a fluorescent X-ray to find that the ratio of the intensity of Si element to the intensity of zinc element is 1.8×10⁻⁴.

35 parts by weight of the above-described surface-treated zinc oxide, 15 parts by weight of block isocyanate as a curing agent (SUMIDUR 3175, manufacture by Sumitomo Bayer Urethane Co., Ltd.), 6 parts by weight of butyral resin (BM-1, manufactured by Sekisui Chemical Co., Ltd.), and 44 parts by weight of methyl ethyl ketone are mixed, and are dispersed with glass beads having a diameter of 1 mm in a sand mill for 2 hours to obtain a dispersion. The obtained dispersion is added with 0.005 parts by weight of dioctyl tin dilaurate as a catalyst and 17 parts by weight of TOSPEARL 130 (manufactured by GE Toshiba Silicones) to obtain a coating liquid for forming an undercoat layer. The coating liquid is applied onto an aluminum substrate by a dip coating method, followed by drying and curing at 160° C. for 100 minutes to form an undercoat layer having a thickness of 20 μm.

Next, 1 part by weight of hydroxygallium phthalocyanine having intense diffraction peaks at Bragg angles (2θ±0.2) of 7.5°, 9.9°, 12.5°, 16.3°, 18.6°, 25.1°, and 28.3° in X-ray diffraction spectra, 1 part by weight of polyvinyl butyral (S-LEC BM-S, manufactured by Sekisui Chemical Co., Ltd.), and 100 parts by weight of n-butyl acetate are mixed, and are dispersed with glass beads in a paint shaker for 2 hours to obtain a coating liquid for forming a charge generation layer. The coating liquid is applied onto the above-described undercoat layer by a dip coating method, followed by heating and drying at 100° C. for 10 minutes to form a charge generation layer having a thickness of about 0.15 μm.

Next, 2 parts by weight of a benzidine compound represented by the above-described general formula (XVI) and 2.5 parts by weight of a macromolecular compound having a structural unit represented by the above-described general formula (XVII) (viscosity-average molecular weight: 80,000) are dissolved in 40 parts by weight of chlorobenzene to obtain a coating liquid for forming a charge transport layer. The obtained coating liquid is applied onto the above-described charge generation layer by a dip coating method, followed by heating at 130° C. for 40 minutes to form a charge transport layer having a thickness of 20 μm.

Next, 3 parts by weight of the above-described compound (II-13), 4.5 parts by weight of the phenolic resin (Ph-1) synthesized in Synthesis example 1, and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 4

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (II-19), 4.5 parts by weight of the phenolic resin (Ph-1) synthesized in Synthesis example 1, and 0.1 parts by weight of NACURE 4116 (block phosphoric acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 5

With a procedure similar to that of Example 3, an undercoat layer having a thickness of 20 μm is formed on an aluminum substrate, a charge generation layer having a thickness of 0.15 μm is formed on the undercoat layer, and a charge transport layer having a thickness of about 20 μm is formed on the charge generation layer.

Next, 3 parts by weight of the above-described compound (III-3), 4.5 parts by weight of the phenolic resin (Ph-1) synthesized in Synthesis example 1, and 0.1 parts by weight of NACURE 4116 (block phosphoric acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 6

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (IV-3), 4.5 parts by weight of the phenolic resin (Ph-1) synthesized in Synthesis example 1, and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 7

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-47), 3 parts by weight of the phenolic resin (Ph-1) synthesized in Synthesis example 2, and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 8

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-11), 3 parts by weight of the phenolic resin (Ph-2) synthesized in Synthesis example 2, and 0.1 parts by weight of NACURE 2500 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 9

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-11) and 3 parts by weight of the phenolic resin (Ph-2) synthesized in Synthesis example 2 are dissolved in 20 parts by weight of butanol to obtain a coating liquid for forming a protection layer. The obtained coating liquid is applied onto the above-described charge transport layer by a dip coating method, and cured by heating at 140° C. for 40 minutes to form a protection layer (outermost layer) having a thickness of about 3 μm. Thereby, the production of the electrophotographic photoreceptor is completed.

### Example 10

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 50 parts by weight of antimony-doped tin fine particle surface-treated with KBM 7103 (manufactured by Shin-Etsu Chemical Co., Ltd., treatment amount: 6% by weight) and 140 parts by weight of ethanol are dispersed in a sand mill for 70 hours, and 20 parts by weight of PTTE fine particle (volume average particle diameter: 0.18 μm) is further added thereto and is dispersed for 2 hours. Thereafter, 20 parts by weight of phenolic resin (Ph-2) and 5 part by weight of the above-described compound (II-13) are added and mixed under thorough stirring to obtain a coating liquid for forming a protection layer. The obtained coating liquid is applied onto the above-described charge transport layer by a ring dip coating method, followed by air drying at room temperature for 5 minutes before curing it by heating at 150° C. for 1 hour to form a protection layer (outermost layer) having a thickness of about 3 μm. Thereby, the production of the electrophotographic photoreceptor is completed.

### Example 11

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-47), 3 parts by weight of the phenolic resin (Ph-4) synthesized in Synthesis example 4, and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 12

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-11), 3 parts by weight of the phenolic resin (Ph-4) synthesized in Synthesis example 4, and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Example 13

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-47), 3 parts by weight of the phenolic resin (Ph-5) synthesized in Synthesis example 5, and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Comparative Example 1

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (V-11), 3 parts by weight of the phenolic resin (Ph-3) synthesized in Synthesis example 3, and 0.1 parts by weight of NACURE 2500 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

### Comparative Example 2

With a procedure similar to that of Example 3, an undercoat layer having a thickness of 20 μm is formed on an aluminum substrate, a charge generation layer having a thickness of about 0.15 μm is formed on the undercoat layer, and a charge transport layer having a thickness of about 20 μm is formed on the charge generation layer.

Next, 3 parts by weight of the above-described compound (II-13), 4.5 parts by weight of phenolic resin (PL-4852, manufactured by Gunei Chemical Industry Co., Ltd., (MwH/MwL)=2.02), and 0.1 parts by weight of NACURE 5225 (block sulfonic acid, manufactured by Kusumoto Chemicals, Ltd.) are dissolved in 20 parts by weight of butanol to obtain a coating liquid for forming a protection layer. The obtained coating liquid is applied onto the above-described charge transport layer by a dip coating method, and is cured by heating at 140° C. for 40 minutes to form a protection layer (outermost layer) having a thickness of about 3 μm. Thereby, the production of the electrophotographic photoreceptor is completed.

(Film Formation Ability Evaluation Test 1)

Surfaces of the electrophotographic photoreceptors (surfaces of protection layers) in Examples 1 to 13 and Comparative examples 1 and 2 are observed with an optical microscope to count the number of projection defects on the surfaces (projections of 50 μm or more in maximum width) for evaluation according to evaluation criteria described below. The results are shown in Table 51.
A: No projection defects are observed on the photoreceptor.
B: 50 or less projection defects are observed on the photoreceptor (not problematic in practical use).
C: From 50 to 100 projection defects are observed on the photoreceptor (problematic in practical use in high-spec color image forming apparatuses or the like).
D: More than 100 projection defects are observed on the photoreceptor (problematic in practical use).

(Traveling Test in Actual Machine)

The electrophotographic photoreceptors in Examples 1 to 13 and Comparative examples 1 and 2 are mounted as photoreceptors for color K in Fuji Xerox printers DOCUCENTRE C6550I to prepare image forming apparatuses. The image forming apparatuses are used in a test of forming 10,000 images (image density: about 10%) under a high temperature and humidity environment (28° C., 80% RH), and also used in a test of forming 10,000 images (image density: about 10%) under a low temperature and humidity environment (10° C., 25% RH). Thereafter, image formation is carried out under a high temperature and humidity environment (28° C., 80% RH), and the image quality (reproducibility of a 1-dot and 45-degree fine diagonal line, and ghost) is evaluated at that time according to evaluation criteria described below. Note that, in the case where the electrophotographic photoreceptors had defects, such as a projection defect, a streak-like coating peel off defect, or the like, the image quality is evaluated for a portion without such defects. The results are shown in Table 51.
A: No problem.
B: Slight thinning of fine lines or very slight image hysteresis is observed (not problematic in practical use).
C: Thinning of fine lines or slight image hysteresis is observed (problematic in practical use in high-spec color image forming apparatuses or the like).
D: Partial disappearance of fine lines or image hysteresis is observed (problematic in practical use).

(Film Formation Ability Evaluation Test 2)

After the above-described traveling test in actual machines, the surfaces of the electrophotographic photoreceptors (surfaces of protection layers) in Examples 1 to 13 and Comparative examples 1 and 2 are observed with an optical microscope to count the number of streak-like coating peel off defects on the surfaces for evaluation according to the evaluation criteria shown below. The results are shown in Table 51.
A: No streak-like coating peel off defects are observed on the photoreceptor.
B: 5 or less streak-like coating peel off defects (1 mm or more in process direction, 0.5 mm or more in width) are observed on the photoreceptor (not problematic in practical use).
C: From 5 to 20 streak-like coating peel off defects (1 mm or more in process direction, 0.5 mm or more in width) are observed on the photoreceptor (problematic in practical use in low-spec color image forming apparatuses).
D: More than 20 streak-like coating peel off defects (1 mm or more in process direction, 0.5 mm or more in width) are observed on the photoreceptor (problematic in practical use).

(Optical Fatigue Test)

The electrophotographic photoreceptors in Examples 1 to 13 and Comparative examples 1 and 2 are partially irradiated with light for 10 minutes using a fluorescent lamp (Lupica FL15EX-N-T HL15W, manufactured by Mitsubishi Osram Ltd, 3-wavelength neutral white fluorescent lamp). In this case, the light intensity of light irradiation portions is set at about 1,000 luxes. After the light irradiation, the electrophotographic photoreceptors are mounted on Fuji Xerox printers Docucentre 500, and 20% halftone images are formed. The image formation is evaluated 3 times after the electrophotographic photoreceptors are allowed to stand in a dark room for 10, 30, and 60 minutes after the irradiation with light, by observing density variations of portions of the obtained images which correspond to the light irradiated portions of the photoreceptors. The evaluation is carried out according to evaluation criteria described below. The results are shown in Table 51.
A: No density variations are observed after 10 minutes.
B: Slight density variations are observed after 10 minutes, but none are observed after 30 minutes (not problematic in practical use).
C: Slight density variations are observed after 30 minutes, but none are observed after 60 minutes (problem may arise in practical use).

D: Density variations are observed after 60 minutes (problematic in practical use).

TABLE 51

| | Film formation | Film formation | | | |
|---|---|---|---|---|---|
| | ability evaluation | ability evaluation | Actual traveling test | | |
| | test 1 (Initial | test 2 (After | Fine line | | Optical |
| | value) | printing) | reproducibility | Ghost | fatigue |
| Example 1 | A | A | A | A | A |
| Example 2 | A | A | A | A | A |
| Example 3 | A | A | A | A | A |
| Example 4 | A | A | A | A | A |
| Example 5 | A | A | A | A | A |
| Example 6 | A | A | A | A | A |
| Example 7 | A | A | A | B | A |
| Example 8 | A | A | A | B | A |
| Example 9 | A | B | B | B | B |
| Example 10 | B | B | B | B | B |
| Example 11 | A | A | A | A | A |
| Example 12 | A | A | A | A | A |
| Example 13 | A | A | B | A | A |
| Comparative example 1 | B | C | B | D | D |
| Comparative example 2 | B | C | B | B | C |

As is apparent from the results shown in Table 51, it is confirmed that, in comparison with the electrophotographic photoreceptors in Comparative examples 1 and 2, the electrophotographic photoreceptors of the present invention (Examples 1 to 13) are satisfactory in terms of the film formation ability of the protection layer containing a phenolic resin, and are superior in terms of the mechanical strength, and therefore, can ensure that the occurrence of projection defects and peeling-off due to repetitive use are sufficiently prevented, so that an image having satisfactory quality can be formed over a long period of time. Also, it is confirmed that, in comparison with the electrophotographic photoreceptors in Comparative examples 1 and 2, the electrophotographic photoreceptors of the present invention (Examples 1 to 13) can ensure that the occurrence of image density abnormality due to optical fatigue and the occurrence of ghost are sufficiently prevented. Also, it is confirmed that the process cartridge and the image forming apparatus of the present invention can ensure that an image having satisfactory quality is formed over a long period of time. Further, from the above-described results, it is confirmed that the curable resin composition of the present invention makes it possible to form a functional layer of an electrophotographic photoreceptor which achieves both high-level mechanical strength and high-level film formation ability.

Also, in the curable resin composition of the present invention, the phenolic resin preferably has an (MwH/MwL) value of 1.50 or less, and the (MwH/MwL) value is preferably 0.20 or more.

In the curable resin composition, when the (MwH/MwL) value of the phenolic resin is in the above-described range, the resultant functional layer can achieve both high-level film formation ability and high-level mechanical strength.

Preferably, the curable resin composition of the present invention further contains a charge transport material.

An electrophotographic photoreceptor having a functional layer formed by a curable resin composition using a conventional phenolic resin and a charge transport material has a problem that image density abnormality, i.e., so-called optical fatigue, may occur in a portion of the photoreceptor where light from a fluorescent light or the like is cast, and a problem that when image formation is repeatedly carried out, image hysteresis in the previous cycle may remain in the next cycle, i.e., a so-called ghost is likely to appear. The above-described optical fatigue is particularly problematic when a photoreceptor unit is exchanged under an ordinary fluorescent lamp, and the above-described ghost is particularly problematic when successively obtaining the same image, e.g., for use in the field of on-demand printing. Also, these problems are particularly significant when the above-described functional layer is an outermost layer.

On the other hand, in the case where a functional layer of a photoreceptor is formed using the above-described curable resin composition of the present invention, even if the functional layer is an outermost layer, it is possible to sufficiently suppress the occurrence of optical fatigue and ghost. Although the reason why the optical fatigue and ghost images are suppressed is not completely clear, the present inventors give a conjecture that by combining a phenolic resin having an (MwH/MwL) value within a specific range and a charge transport material, it is possible to maintain extremely satisfactory dispersion of the charge transport material in the functional layer, thereby stably obtaining satisfactory electrical characteristics.

Here, the charge transport material preferably contains at least one of compounds represented by the following general formulas (I), (II), (III), (IV), and (V):
F[—D—Si(R¹)₍₃₋ₐ₎Qₐ]_{b} (I)
(in formula (I), F denotes an organic group derived from a compound having hole transporting ability, D denotes a bivalent group having flexibility, R¹ denotes a hydrogen atom, a substituted or unsubstituted alkyl group, or a substituted or unsubstituted aryl group, Q denotes a hydrolyzable group, a denotes an integer from 1 to 3, and b denotes an integer from 1 to 4);
F[—(X¹)ₙ₁R²—Z¹H]ₘ₁ (II)
(in formula (II), F denotes an organic group derived from a compound having hole transporting ability, R² denotes an alkylene group, Z¹ denotes an oxygen atom, a sulfur atom, NH or COO, X¹ denotes an oxygen atom or a sulfur atom, m1 denotes an integer from 1 to 4, and n1 denotes 0 or 1);
F[—(X²)ₙ₂—(R³)ₙ₃—(Z²)ₙ₄G]ₙ₅ (III)
(in formula (III), F denotes an organic group derived from a compound having hole transporting ability, X² denotes an oxygen atom or a sulfur atom, R³ denotes an alkylene group, Z² denotes an oxygen atom, a sulfur atom, NH or COO, G denotes an epoxy group, n2, n3 and n4 each individually denotes 0 or 1, and n5 denotes an integer from 1 to 4); 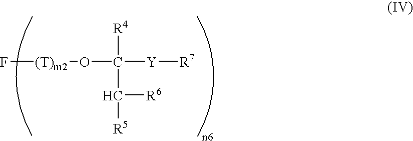
(in formula (IV), F denotes an organic group derived from a compound having hole transporting ability, T denotes a bivalent group, Y denotes an oxygen atom or a sulfur atom, R⁴, R⁵ and R⁶ each individually denotes a hydrogen atom or a monovalent organic group, R⁷ denotes a monovalent organic group, m2 denotes 0 or 1, n6 denotes an integer from 1 to 4; R⁶ and R⁷ may be bonded together to form a heterocyclic ring having Y as a hetero atom); 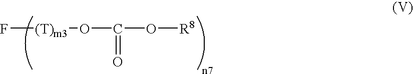
(in formula (V), F denotes an organic group derived from a compound having hole transporting ability, T denotes a bivalent group, R⁸ denotes a monovalent organic group, m3 denotes 0 or 1, and n7 denotes an integer from 1 to 4).

Since the curable resin composition contains, as the charge transport material, at least one of the compounds represented by general formulas (I) to (V), it is possible to, when forming a functional layer of an electrophotographic photoreceptor, achieve both high-level mechanical hardness and high-level electrical characteristics.

Here, the F of the compounds represented by general formulas (I) to (V) is preferably a group represented by the following general formula (VI): 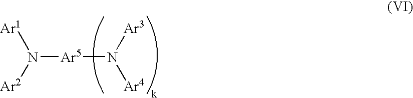
(in formula (VI), Ar¹, Ar², Ar³ and Ar⁴ each individually denotes a substituted or unsubstituted aryl group, Ar⁵ denotes a substituted or unsubstituted aryl or arylene group, and one to four of the groups Ar¹ to Ar⁵ have a bonding hand with which to bond to a site represented by general formula (VII) below of the compound represented by general formula (I), a site represented by general formula (VIII) below of the compound represented by general formula (II), a site represented by general formula (IX) below of the compound represented by general formula (III), a site represented by general formula (X) below of the compound represented by general formula (IV), or a site represented by general formula (XI) below of the compound represented by general formula (V)),

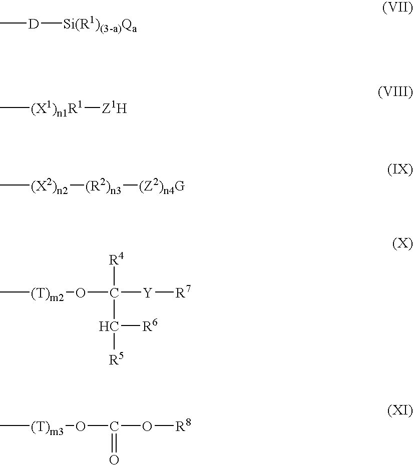

Since the curable resin composition contains the charge transport material, when forming the functional layer of the electrophotographic photoreceptor, it is possible to achieve stable electrical characteristics over a longer period of time.

Preferably, the curable resin composition of the present invention further contains organic sulfonic acid and/or a derivative thereof.

Since the curable resin composition contains organic sulfonic acid and/or a derivative thereof, the organic sulfonic acid and/or the derivative thereof carry out a superior function as a curing catalyst for the phenolic resin, and sufficiently promote a curing reaction of the phenolic resin, thereby further enhancing the mechanical strength of the resultant functional layer. Moreover, in the case where the curable resin composition contains any of the compounds represented by general formulas (I) to (V), the organic sulfonic acid and/or the derivative thereof can also carry out a superior function as a dopant for these charge transporting materials, thereby further enhancing the electrical characteristics of the resultant the functional layer. As a result, when used so as to form a functional layer of an electrophotographic photoreceptor, the curable resin composition of the present invention can ensure high-level achievement of all of the mechanical strength, the film formation ability, and the electrical characteristics.

Also, the curable resin composition of the present invention preferably contains a conductive fine particle. As a result, when forming the functional layer of the electrophotographic photoreceptor, it is possible to stabilize the electrical characteristics, thereby solving problems, such as ghost due to charge accumulation.

Also, in the electrophotographic photoreceptor according to the present invention, the functional layer is preferably an outermost layer disposed on a farthest side from the conductive support.

Since the functional layer as an outermost layer has superior mechanical strength and superior film formation ability, when used in an image forming apparatus, the electrophotographic photoreceptor can prevent the functional layer from being peeled off due to, for example, sliding movement between the photoreceptor and a cleaning means, and prevent the occurrence of damage, abrasion, and chipping on the photoreceptor surface, thereby making it possible to form an image having satisfactory quality over a long period of time.

According to the present invention, when forming a phenolic resin-containing functional layer constituting an electrophotographic photoreceptor, it is possible to provide a curable resin composition which achieves both high-level mechanical strength and high-level film formation ability.

Also, according to the present invention, the functional layer is formed using the curable resin composition of the present invention, and therefore, when used in an image forming apparatus, it is possible to provide an electrophotographic photoreceptor capable of forming an image having satisfactory quality over a long period of time.

Further, the present invention provides a process cartridge and an image forming apparatus which include the electrophotographic photoreceptor of the present invention, and therefore, can form an image having satisfactory quality to be formed over a long period of time.

The entire disclosure of Japanese Patent Application No. 2005-184008 filed on Jun. 23, 2005 including specification, claims and abstract is incorporated herein by reference in its entirety.

What is claimed is:

1. A curable resin composition for use as a constituent material of an electrophotographic photoreceptor, the curable resin composition comprising:
a phenolic resin having an (MwH/MwL) value of approximately 1.90 or less in a molecular weight distribution measured by gel permeation chromatography,
wherein MwH is a peak area for a weight average molecular weight of approximately 200 or more; and
MwL is a peak area for a weight average molecular weight of less than approximately 200.

2. The curable resin composition according to claim 1,
wherein the (MwH/MwL) value of the phenolic resin is approximately 1.50 or less.

3. The curable resin composition according to claim 1,
wherein the (MwH/MwL) value of the phenolic resin is approximately 0.20 or more.

4. The curable resin composition according to claim 1, further comprising a charge transport material.

5. The curable resin composition according to claim 4,
wherein the charge transport material comprises at least one compound represented by formula (I), (II), (III), (IV) or (V):
F[—D—Si(R¹)₍₃₋ₐ₎Qₐ]_{b} (I)
in formula (I), F denotes an organic group derived from a compound having hole transporting ability; D denotes a bivalent group having flexibility; R¹ denotes a hydrogen atom, a substituted or unsubstituted alkyl group or a substituted or unsubstituted aryl group; Q denotes a hydrolyzable group; a denotes an integer from 1 to 3; and b denotes an integer from 1 to 4;
F[—(X¹)ₙ₁R²—Z¹H]ₘ₁ (II)
in formula (II), F denotes an organic group derived from a compound having hole transporting ability; R² denotes an alkylene group; Z¹ denotes an oxygen atom, a sulfur atom, NH or COO; X¹ denotes an oxygen atom or a sulfur atom; m1 denotes an integer from 1 to 4; and n1 denotes 0 or 1;
F[—(X²)ₙ₂—(R³)ₙ₃—(Z²)ₙ₄G]ₙ₅ (III)
in formula (III), F denotes an organic group derived from a compound having hole transporting ability; X² denotes an oxygen atom or a sulfur atom; R³ denotes an alkylene group; Z² denotes an oxygen atom, a sulfur atom, NH or COO; G denotes an epoxy group; n2, n3 and n4 each independently denotes 0 or 1; and n5 denotes an integer from 1 to 4; 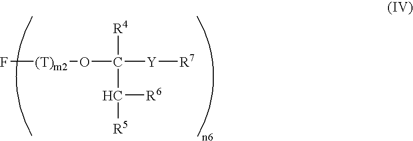
in formula (IV), F denotes an organic group derived from a compound having hole transporting ability; T denotes a bivalent group; Y denotes an oxygen atom or a sulfur atom; R⁴, R⁵ and R⁶ each independently denotes a hydrogen atom or a monovalent organic group; R⁷ denotes a monovalent organic group; m2 denotes 0 or 1; and n6 denotes an integer from 1 to 4; provided that R⁶ and R⁷ may be bonded together to form a heterocyclic ring having Y as a hetero atom; 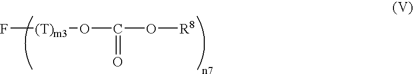
in formula (V), F denotes an organic group derived from a compound having hole transporting ability; T denotes a bivalent group; R⁸ denotes a monovalent organic group; m3 denotes 0 or 1; and n7 denotes an integer from 1 to 4.

6. An electrophotographic photoreceptor comprising:
a conductive support; and
a photosensitive layer provided on the conductive support,
wherein the photosensitive layer comprises a functional layer comprising a cured substance of a curable resin composition, and the curable resin composition comprising:
a phenolic resin having an (MwH/MwL) value of approximately 1.90 or less in a molecular weight distribution measured by gel permeation chromatography,
wherein MwH is a peak area for a weight average molecular weight of approximately 200 or more; and
MwL is a peak area for a weight average molecular weight of less than approximately 200.

7. The electrophotographic photoreceptor according to claim 6,
wherein the (MwH/MwL) value of the phenolic resin is approximately 1.50 or less.

8. The electrophotographic photoreceptor according to claim 6,
wherein the (MwH/MwL) value of the phenolic resin is approximately 0.20 or more.

9. The electrophotographic photoreceptor according to claim 6,
the curable resin composition further comprises a charge transport material.

10. The electrophotographic photoreceptor according to claim 9,
wherein the charge transport material comprises at least one compound represented by formula (I), (II), (III), (IV) or (V):
F[—D—Si(R¹)₍₃₋ₐ₎Qₐ]_{b} (I)
in formula (I), F denotes an organic group derived from a compound having hole transporting ability; D denotes a bivalent group having flexibility; R¹ denotes a hydrogen atom, a substituted or unsubstituted alkyl group or a substituted or unsubstituted aryl group; Q denotes a hydrolyzable group; a denotes an integer from 1 to 3; and b denotes an integer from 1 to 4;
F[—(X¹)ₙ₁R²—Z¹H]ₘ₁ (II)
in formula (II), F denotes an organic group derived from a compound having hole transporting ability; R² denotes an alkylene group; Z¹ denotes an oxygen atom, a sulfur atom, NH or COO; X¹ denotes an oxygen atom or a sulfur atom; m1 denotes an integer from 1 to 4; and n1 denotes 0 or 1;
F[—(X²)ₙ₂—(R³)ₙ₃—(Z²)ₙ₄G]ₙ₅ (III)
in formula (III), F denotes an organic group derived from a compound having hole transporting ability; X² denotes an oxygen atom or a sulfur atom; R³ denotes an alkylene group; Z² denotes an oxygen atom, a sulfur atom, NH or COO; G denotes an epoxy group; n2, n3 and n4 each independently denotes 0 or 1; and n5 denotes an integer from 1 to 4; 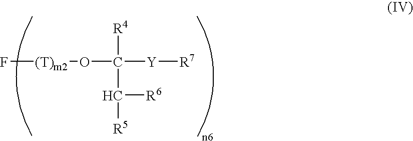
in formula (IV), F denotes an organic group derived from a compound having hole transporting ability; T denotes a bivalent group; Y denotes an oxygen atom or a sulfur atom; R⁴, R⁵ and R⁶ each independently denotes a hydrogen atom or a monovalent organic group; R⁷ denotes a monovalent organic group; m2 denotes 0 or 1; and n6 denotes an integer from 1 to 4; provided that R⁶ and R⁷ may be bonded together to form a heterocyclic ring having Y as a hetero atom; 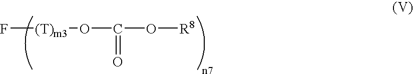
in formula (V), F denotes an organic group derived from a compound having hole transporting ability; T denotes a bivalent group; R⁸ denotes a monovalent organic group; m3 denotes 0 or 1; and n7 denotes an integer from 1 to 4.

11. A process cartridge comprising:
an electrophotographic photoreceptor; and
at least one selected from the group consisting of a charging device that charges the electrophotographic photoreceptor, developing device that developes an electrostatic latent image, which is formed on the electrophotographic photoreceptor, with a toner to form a toner image and cleaning device that removes a toner remaining on a surface of the electrophotographic photoreceptor,
wherein the electrophotographic photoreceptor comprising:
a conductive support; and
a photosensitive layer provided on the conductive support,
wherein the photosensitive layer comprises a functional layer comprising a cured substance of a curable resin composition, and the curable resin composition comprising:
a phenolic resin having an (MwH/MwL) value of approximately 1.90 or less in a molecular weight distribution measured by gel permeation chromatography,
wherein MwH is a peak area for a weight average molecular weight of approximately 200 or more; and
MwL is a peak area for a weight average molecular weight of less than approximately 200.

12. The process cartridge according to claim 11,
wherein the (MwH/MwL) value of the phenolic resin is approximately 1.50 or less.

13. The process cartridge according to claim 11,
wherein the (MwH/MwL) value of the phenolic resin is approximately 0.20 or more.

14. The process cartridge according to claim 11,
the curable resin composition further comprises a charge transport material.

15. The process cartridge according to claim 14,
wherein the charge transport material comprises at least one compound represented by formula (I), (II), (III), (IV) or (V):
F[—D—Si(R¹)₍₃₋ₐ₎Qₐ]_{b} (I)
in formula (I), F denotes an organic group derived from a compound having hole transporting ability; D denotes a bivalent group having flexibility; R¹ denotes a hydrogen atom, a substituted or unsubstituted alkyl group or a substituted or unsubstituted aryl group; Q denotes a hydrolyzable group; a denotes an integer from 1 to 3; and b denotes an integer from 1 to 4;
F[—(X¹)ₙ₁R²—Z¹H]ₘ₁ (II)
in formula (II), F denotes an organic group derived from a compound having hole transporting ability; R² denotes an alkylene group; Z¹ denotes an oxygen atom, a sulfur atom, NH or COO; X¹ denotes an oxygen atom or a sulfur atom; m1 denotes an integer from 1 to 4; and n1 denotes 0 or 1;
F[—(X²)ₙ₂—(R³)ₙ₃—(Z²)ₙ₄G]ₙ₅ (III)
in formula (III), F denotes an organic group derived from a compound having hole transporting ability; X² denotes an oxygen atom or a sulfur atom; R³ denotes an alkylene group; Z² denotes an oxygen atom, a sulfur atom, NH or COO; G denotes an epoxy group; n2, n3 and n4 each independently denotes 0 or 1; and n5 denotes an integer from 1 to 4; 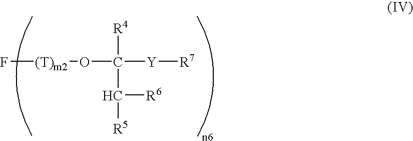
in formula (IV), F denotes an organic group derived from a compound having hole transporting ability; T denotes a bivalent group; Y denotes an oxygen atom or a sulfur atom; R⁴, R⁵ and R⁶ each independently denotes a hydrogen atom or a monovalent organic group; R⁷ denotes a monovalent organic group; m2 denotes 0 or 1; and n6 denotes an integer from 1 to 4; provided that R⁶ and R⁷ may be bonded together to form a heterocyclic ring having Y as a hetero atom; 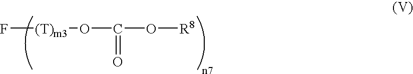
in formula (V), F denotes an organic group derived from a compound having hole transporting ability; T denotes a bivalent group; R⁸ denotes a monovalent organic group; m3 denotes 0 or 1; and n7 denotes an integer from 1 to 4.

16. An image forming apparatus comprising:
an electrophotographic photoreceptor;
charging device that charges the electrophotographic photoreceptor;
exposing device that formes an electrostatic latent image on the charged electrophotographic photoreceptor;
developing device that developes the electrostatic latent image with a toner to form a toner image; and
transfer device that transfers the toner image from the electrophotographic photoreceptor onto a transfer medium,
wherein the electrophotographic photoreceptor comprising:
a conductive support; and
a photosensitive layer provided on the conductive support,
wherein the photosensitive layer comprises a functional layer comprising a cured substance of a curable resin composition, and the curable resin composition comprising:
a phenolic resin having an (MwH/MwL) value of approximately 1.90 or less in a molecular weight distribution measured by gel permeation chromatography,
wherein MwH is a peak area for a weight average molecular weight of approximately 200 or more; and
MwL is a peak area for a weight average molecular weight of less than approximately 200.

17. The image forming apparatus according to claim 16,
wherein the (MwH/MwL) value of the phenolic resin is approximately 1.50 or less.

18. The image forming apparatus according to claim 16,
wherein the (MwH/MwL) value of the phenolic resin is approximately 0.20 or more.

19. The image forming apparatus according to claim 16,
the curable resin composition further comprises a charge transport material.

20. The image forming apparatus according to claim 19,
wherein the charge transport material comprises at least one compound represented by formula (I), (II), (III), (IV) or (V):
F[—D—Si(R¹)₍₃₋ₐ₎Qₐ]_{b} (I)
in formula (I), F denotes an organic group derived from a compound having hole transporting ability; D denotes a bivalent group having flexibility; R¹ denotes a hydrogen atom, a substituted or unsubstituted alkyl group or a substituted or unsubstituted aryl group; Q denotes a hydrolyzable group; a denotes an integer from 1 to 3; and b denotes an integer from 1 to 4;
F[—(X¹)ₙ₁R²—Z¹H]ₘ₁ (II)
in formula (II), F denotes an organic group derived from a compound having hole transporting ability; R² denotes an alkylene group; Z¹ denotes an oxygen atom, a sulfur atom, NH or COO; X¹ denotes an oxygen atom or a sulfur atom; m1 denotes an integer from 1 to 4; and n1 denotes 0 or 1;
F[—(X²)ₙ₂—(R³)ₙ₃—(Z²)ₙ₄G]ₙ₅ (III)
in formula (III), F denotes an organic group derived from a compound having hole transporting ability; X² denotes an oxygen atom or a sulfur atom; R³ denotes an alkylene group; Z² denotes an oxygen atom, a sulfur atom, NH or COO; G denotes an epoxy group; n2, n3 and n4 each independently denotes 0 or 1; and n5 denotes an integer from 1 to 4; 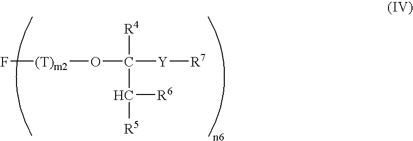
in formula (IV), F denotes an organic group derived from a compound having hole transporting ability; T denotes a bivalent group; Y denotes an oxygen atom or a sulfur atom; R⁴, R⁵ and R⁶ each independently denotes a hydrogen atom or a monovalent organic group; R⁷ denotes a monovalent organic group; m2 denotes 0 or 1; and n6 denotes an integer from 1 to 4; provided that R⁶ and R⁷ may be bonded together to form a heterocyclic ring having Y as a hetero atom; 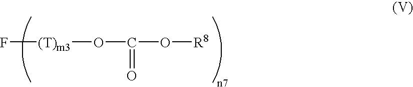
in formula (V), F denotes an organic group derived from a compound having hole transporting ability; T denotes a bivalent group; R⁸ denotes a monovalent organic group; m3 denotes 0 or 1; and n7 denotes an integer from 1 to 4.
